(19) United States
(12) Patent Application Publication
(10) Pub. No.: US 2009/0055744 A1
(43) Pub. Date: Feb. 26, 2009

(54) RECORDING MEDIUM, REPRODUCING DEVICE, RECORDING DEVICE, SYSTEM LSI, METHOD, AND PROGRAM

(76) Inventors: Taiji Sawada, Osaka (JP); Hiroshi Yahata, Osaka (JP); Tomoki Ogawa, Osaka (JP); Yasushi Uesaka, Hyogo (JP)

Correspondence Address: WENDEROTH, LIND & PONACK L.L.P., 2033 K. STREET, NW, SUITE 800, WASHINGTON, DC, 20006, US

(21) Appl. No.: 12/296,469

(22) PCT Filed: Apr. 12, 2007
(86) PCT No.: PCT/JP2007/058032

§ 371 Date: Oct. 8, 2008

(30) Foreign Application Priority Data
Apr. 13, 2006 (JP) 2006-110827

(51) Int. Cl. G06F 3/00; H04N 5/91

(52) U.S. Cl. 715/719; 386/68

(57) ABSTRACT

A BD-ROM 100 for causing a playback device to display a menu while displaying a moving image as a background of the menu. The BD-ROM 100 includes one or more AVClips constituting the moving image; a BD-J Object that causes the playback device to perform an operation wait control to wait for an operation to be conducted via the displayed menu; and PlayList information. The PlayList information includes a sequence composed of 999 pieces of PlayItem information each of which corresponds to one of the one or more AVClips and instructs the playback device to repeat a playback of the corresponding AVClip 999 times.

### TECHNICAL FIELD

The present invention relates to a technical field of interactive control technology.

### BACKGROUND ART

The interactive control technology provides a menu combined with a moving image, and controls a playback in accordance with user operations made onto the menu. The interactive control technology is indispensable in achieving interactive functions performed in response to user operations, such as selecting a title of a chapter to be played back, and answering a question. The interactive control technology has been applied to developments of industrial products such as recording mediums like DVD and BD-ROM, playback devices and recording devices for such recording mediums, and system LSIs.

In the case of DVD, as one example, the DVD video format has functions called “still image menu” and “moving image menu”. The still image menu is a menu where a still image is used as a background image of the menu. The playback device displays buttons by superimposing them on the background image and waits for a user operation to be performed onto the menu, where the buttons are highlighted images or still images.

The moving image menu is a menu where a moving image is used as a background image of the menu. The playback device plays back the moving background image and displays buttons by superimposing them on the background image being played back, and waits for a user operation to be performed onto the menu, where the buttons are highlighted images or still images. In general, the playback length of the moving background image is as short as one minute. The moving background image and a program corresponding thereto are stored in a recording medium. The program includes two types of commands. One of them is a playback command for instructing the playback device to play back the moving background image. The other is a jump command for instructing the playback device to jump to the playback command to repeat the execution of the playback command. It is possible to create a moving image menu by describing these commands so that a loop playback of a short-time-length image is repeated. Patent Document 1, identified below, discloses a disc arrangement that was invented so that the playback device can read in such a moving image menu at a high speed.

Patent Document 1: Japanese Patent Application Publication No. H9-63251

### DISCLOSURE OF THE INVENTION

The Problems the Invention is Going to Solve

However, according to the above-described structure of the moving image menu, the moving image stops and the menu disappears during a time period between the completion of a playback of a moving image by the playback command and the start of a resumption of the playback of the moving image by the execution of the jump command. That is to say, the playback of the moving image is interrupted. Here, to prevent the playback of the moving image from being interrupted, one may consider that a long-time-length stream, such as a one-hour stream, could be recorded preliminarily so that a user operation can be waited for in such a long time period while the moving image is played back. The steam may be composed of a repetition of a same image. However, preliminarily recording, in addition to the movie work itself, a stream having a long playback period such as one hour merely for the purpose of waiting for an input while playing back a moving image is a waste of the recording capacity, and thus is not acceptable.

From the viewpoint of the recording efficiency, preliminarily recording a stream having a long playback period such as one hour for waiting for an input while playing back a moving image is thus unrealistic.

It is therefore an object of the present invention to provide a recording medium that enables a device, such as a playback device, to wait for an input while playing back a moving image, with the recording efficiency of the recording medium not decreased uselessly.

Means to Solve the Problems

The above-described object is fulfilled by a recording medium for causing a playback device to display a menu while displaying a moving image as a background of the menu, the recording medium storing: one or more AV streams constituting the moving image; a program that causes the playback device to perform an operation wait control to wait for an operation to be conducted via the displayed menu; and PlayList information, wherein the PlayList information includes a PlayItem sequence composed of a plurality of pieces of PlayItem information each of which corresponds to one of the one or more AV streams and instructs the playback device to repeat a playback of the corresponding AV stream while performing the operation wait control.

### EFFECTS OF THE INVENTION

With the above-stated structure of the recording medium in which one piece of PlayList information includes a plurality of pieces of PlayItem information, the playback of the stream is not interrupted. More specifically, when a time length of the stream is represented by “T” and the number of pieces of PlayItem information in the PlayList information is represented by “N”, a playback of the moving image menu without interruption is secured for a time period of “N×T”.

For example, when the number of pieces of PlayItem information is set to “999” and one-minute-long digital stream is prepared, a playback of the moving image menu without interruption is secured for 999 minutes=16.5 hours. With this structure, even if a stop of the moving image and disappearing of buttons and subtitle occur between executions of the command instructing the playback of the digital stream and the jump command for repeating the execution of the command, these do not occur while the 999 pieces of PlayItem information are played back. Accordingly, a playback of the moving image menu without interruption is secured for 999 minutes=16.5 hours. A playback stop occurs once in 16.5 hours when the jump command is executed to repeat the playback command. As understood from this, even when a digital stream having as short a playback time as one minute is used, it is possible to continue an input wait for quite a long time without playback interruption.

Furthermore, since the continuation does not require much increase in the capacity of the recording medium, the present invention meets the realistic demand of achieving a moving image menu without playback interruption, while ensuring a large capacity of the recording medium.

### BRIEF DESCRIPTION OF THE DRAWING

FIG. 1 shows the use form of the recording medium of the present invention.

FIG. 2 shows the internal structure of the BD-ROM.

FIG. 3 shows the internal structure of the Index.bdmv.

FIG. 4 shows the internal structure of the Movie Object.bdmv.

FIG. 5 shows the structure of the AVClip.

FIG. 6 illustrates how the elementary streams shown in FIG. 5 are multiplexed in the AVClip.

FIG. 7 shows, in further details, how a video stream and an audio stream is stored into a PES packet sequence.

FIG. 8 shows the processes to which the TS packets constituting the AVClip are subjected before they are written onto the BD-ROM.

FIG. 9 illustrates a hierarchical structure constituted by the AVClip, source packets, and ATS.

FIG. 10 shows the internal structure of Clip information.

FIG. 11 shows EP_map settings on a video stream of a motion picture.

FIGS. 12A and 12B show data structures of the PlayList information and Multi_Clip_entries.

FIG. 13 shows the internal structure of the PlayListMark information of the PlayList information.

FIG. 14 shows relationships between AVClip and PlayList information.

FIG. 15 shows an example of settings in the STN_table.

FIG. 16 shows a typical hierarchical structure of the moving image menu.

FIG. 17 shows the data structure that is characteristic to the PlayList information.

FIG. 18 shows a hierarchical structure of the moving image menu structured by the PlayList information shown in FIG. 17.

FIGS. 19A and 19B show relationships between ATC Sequences and STC Sequences.

FIGS. 20A and 20B show two AVClips (AVClip#1 referred to by Previous PlayItem, and AVClip#1 referred to by Current PlayItem) that are connected seamlessly.

FIG. 21 illustrates details of Clean Break.

FIG. 22 shows the internal structure of the playback device.

FIG. 23 shows the internal structure of the demultiplexer 3, the video decoder 4, the audio decoder 5, the IG decoder 6, and the PG decoder 7.

FIG. 24 shows ATC_diff and STC_diff.

FIG. 25 shows the state of the read buffer.

FIG. 26 shows the state of the elementary buffer in the video decoder.

FIG. 27 shows the temporal transition of free capacity and amount of storage in the elementary buffer.

FIG. 28 shows the input-limiting straight line.

FIG. 29 shows the temporal transition of storage in the elementary buffer when t_in_end in playback according to Previous PlayItem and t_in_start in playback according to Current PlayItem are set to match each other on the same time axis.

FIG. 30 shows the temporal transition of storage in the video and audio buffers, with relationships therebetween.

FIG. 31 shows the temporal transition of storage in the buffer before and after the change to the amount of code assignment for comparison therebetween.

FIG. 32 shows a specific example of a moving image menu.

FIG. 33 shows the structure of a moving image menu in Embodiment 2.

FIG. 34 shows three AVClips (AVClip#1, AVClip#2, AVClip#3) that constitute the multi-angle section.

FIG. 35 shows the structure of the PlayList information for a moving image menu with a multi-angle section.

FIG. 36 shows the internal structure of the recording device of the present invention.

FIG. 37 shows an example of the data structure of the title structure information generated by the title structure generating unit 10.

FIG. 38 shows an example of the GUI screen when the menu screen structure is set.

FIG. 39 shows how the AVClip connection information is described when the three AVClips shown in FIG. 32 are generated.

FIGS. 40A and 40B show examples of a source code of a header file for accessing the PlayList of the ID class source code.

FIG. 41 shows the file correlation information.

FIG. 42 shows an allocation on the BD-ROM based on the file correlation information shown in FIG. 41.

FIG. 43 shows one example of the interleave arrangement.

FIG. 44 is a flowchart showing the authoring procedures performed in the recording device.

FIG. 45 shows procedures for generating scenario data having a structure of a seamless moving image menu.

FIG. 46 shows the internal structure of the playback device in Embodiment 5.

FIGS. 47A and 47B show the structures of the IG stream and a PES packet that is obtained by converting a functional segment.

FIG. 48 shows a logical structure composed of a variety of types of functional segments.

FIG. 49 shows an AVClip playback time axis on which DSn is assigned.

FIGS. 50A and 50B shows relationships between ICS and Interactive_composition.

FIG. 51 shows the internal structure of ICS.

FIG. 52 shows the internal structure of page information of a given page (page “y”) among a plurality of pages belonging to the x^{th} Display Set in an Epoch.

FIG. 53 shows the internal structure of button information (i) in page information (y).

FIG. 54 shows how the IG stream is processed by the structural elements of the IG decoder 6.

FIGS. 55A and 55B show an Epoch that is continuous through two AVClips, and how a Display Set of the “Epoch Continue” type is handled.

FIG. 56 shows the three conditions to be satisfied when two AVClips are played back seamlessly.

FIG. 57 shows a specific structure of the PG stream.

FIG. 58 shows the relationships between display positions of subtitles and Epochs.

FIG. 59A and show data structures of WDS and PCS.

FIG. 60 shows an AVClip playback time axis to which the DSn is assigned.

FIG. 61 shows the three conditions to be satisfied when two AVClips are played back seamlessly.

### DESCRIPTION OF CHARACTERS

1 BD-ROM drive
2 read buffer
3 demultiplexer
4 video decoder
5 audio decoder
6 IG decoder
7 PG decoder
8a, 8b, 8c, 8d plane memories
9a user event processing unit
9b data analysis executing unit
10 title structure generating unit
11 BD scenario generating unit
16 reel set editing unit
20 Java™ programming unit
30 material generating/importing unit
40 disc generating unit
50 verification unit

### BEST MODE FOR CARRYING OUT THE INVENTION

### Embodiment 1

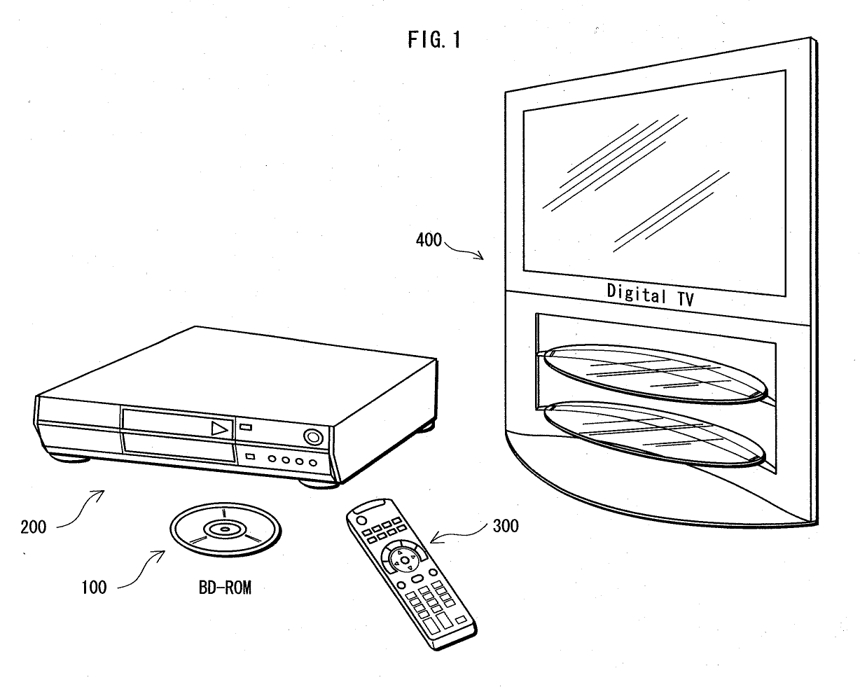

The following describes embodiments of the recording medium of the present invention. First, the use form of the recording medium of the present invention will be described. In FIG. 1, the recording medium of the present invention is a BD-ROM 100. The BD-ROM 100 is used for providing movie works to a home theater system that is composed of a playback device 200 and a television 400.

Described in the following are the BD-ROM 100, the playback device 200, and a remote control 300.

The BD-ROM 100 is a recording medium on which a movie work has been recorded.

The playback device 200 is a network-ready digital home electrical appliance, having a function to play back the BD-ROM 100.

The remote control 300 receives operations onto the playback device 200 from the user. Specific examples of movie works stored in the BD-ROM 100 are as follows. The BD-ROM 100 stores a menu title being a menu, as well as Title#1 and Title#2 being movie works. The menu title causes the playback device 200 to display a menu whose background image is a moving image. On this menu, the user should select either Title#1 or Title#2. In this way, the BD-ROM 100 provides the user with two movie works (Title#1 and Title#2) and a moving-image menu. It is supposed herein after that the description of the present application is based on the specific examples of movie works, when there is no indication otherwise.

Up to now, the use form of the recording medium of the present invention has been described.

### <General Description of BD-ROM>

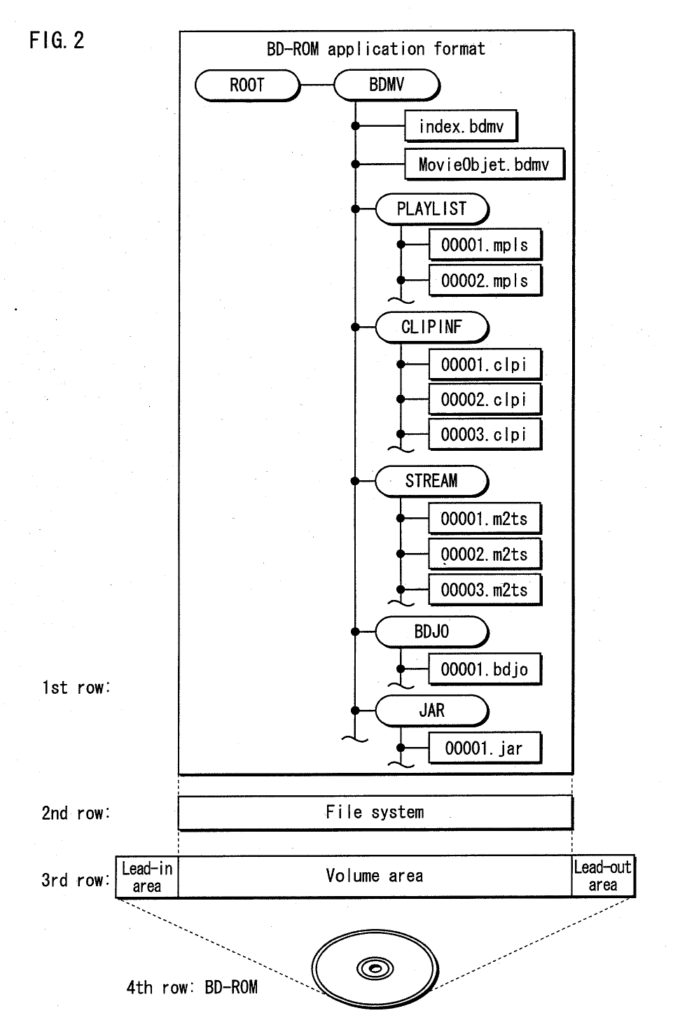

First, the data structure of the recording medium presumed in the present invention will be described. The recording medium of the present invention is based on the premise of the BD-ROM application layer standard format. FIG. 2 shows the internal structure of the BD-ROM. The fourth row from top of FIG. 2 indicates the BD-ROM, and the third row indicates the tracks of the BD-ROM in the state where they are horizontally extended although they are in reality formed spirally in order from the inner circumference to the outer circumference. The tracks include a lead-in area, a volume area, and a lead-out area. The volume area of FIG. 2 has a layer type that includes a physical layer, a file system layer shown in the second row, and an application layer shown in the first row. The first row of FIG. 2 shows the application layer format (application format) of the BD-ROM represented by a directory structure.

The BDMV directory has files to which extension “bdmv” has been attached (“index.bdmv”, “Movie Object.bdmv”). Under the BDMV directory, there are six sub-directories: PLAYLIST, CLIPINF, STREAM, BDJO, and JAR directories.

The PLAYLIST directory has files to which extension “mpls” has been attached (“00001.mpls”, “00002.mpls”, “00003.mpls”). In the specific examples of movie works described earlier, 00001.mpls is the moving image menu. This moving image menu receives from the user a selection of either of the two titles (Title#1 and Title#2). It is also assumed that 00002.mpls is the movie works.

The STREAM directory has files to which extension “m2ts” has been attached (“00001.m2ts”, “00002.m2ts”, “00003.m2ts”). Of these files, 00001.m2ts is an AVClip for the moving image menu. Also, 00002.m2ts and 00003.m2ts are movie works.

The CLIPINF directory has files to which extension “clpi” has been attached (“00001.clpi”, “00002.clpi”, “00003.clpi”).

The BDJO directory has files to which extension “bdjo” has been attached (“00001.bdjo”).

The JAR directory has files to which extension “jar” has been attached (“00001.jar”). In the specific examples of movie works described earlier, 00001.bdjo and 00001.jar performs a playback control when Title#1 is played back.

It is understood from the above-described directory structure that a plurality of different types of files are stored in the BD-ROM.

<BD-ROM Structure 1: Index.bdmv>

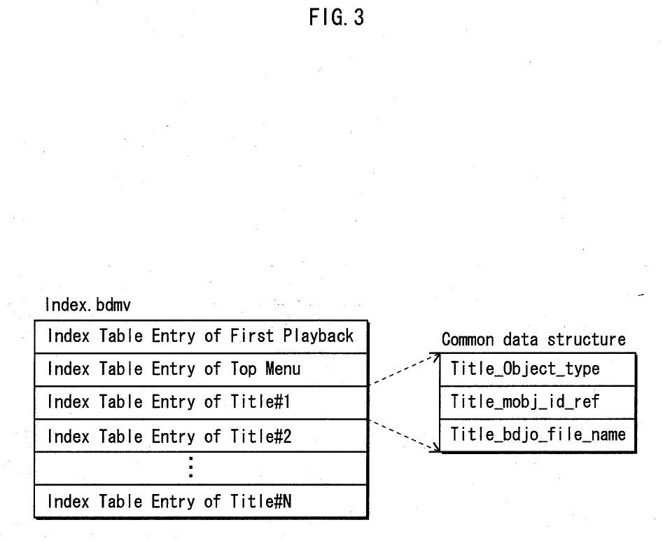

First, the Index.bdmv will be described. FIG. 3 shows the internal structure of the Index.bdmv. The Index.bdmv is a table that is placed in the highest layer and defines the structure of titles stored in the BD-ROM. The Index.bdmv shown on the left-hand side of FIG. 3 includes: Index Table Entry for first playback, Index Table Entry for top menu, Index Table Entry for Title#1, Index Table Entry for Title#2, . . . and Index Table Entry for Title#N. The Index.bdmv specifies all titles, the top menu, a Movie Object or a BD-J Object that is executed first from the First Playback. The playback device of the BD-ROM refers to Index.bdmv each time a title or the menu is called, and executes the specified Movie Object or BD-J. Object. It should be noted here that the First Playback is set by the provider, and in which set is a Movie Object or a BD-J Object that is automatically executed immediately after the disc is inserted. Also, the Top Menu specifies a Movie Object or a BD-J Object that is called each time a command, such as “Menu Call”, is executed in accordance with an operation made onto the remote control by the user.

The title structure described above is defined by the common data structure shown on the right-hand side of FIG. 3. As shown in FIG. 3, the common data structure includes “Title_object_type”, “Title_mobj_id_ref”, and “Title_bdjo_file_name”.

When set to “10”, the Title_object_type indicates that the title identified by the title_id corresponds to the BD-J. Object. Also, when set to “01”, the Title_object_type indicates that the title identified by the title_id corresponds to the Movie Object. That is to say, the Title_object_type indicates whether or not title identified by the title_id corresponds to the BD-J. Object.

The Title_mobj_id_ref indicates an identifier of the Movie Object that corresponds to the Title.

The Title_bdjo_file_name indicates a name of the BD-J Object file that corresponds to the Title. The BD-J Object includes “Application Management Table ( )” which indicates the application_id of the application to be executed. That is to say, the file name of the BD-J Object file indicated by Title_bdjo_file_name in Index Table entry indicates a BD-J application to be executed when the own title is a branch destination.

### <BD-ROM Structure 2: Movie Object>

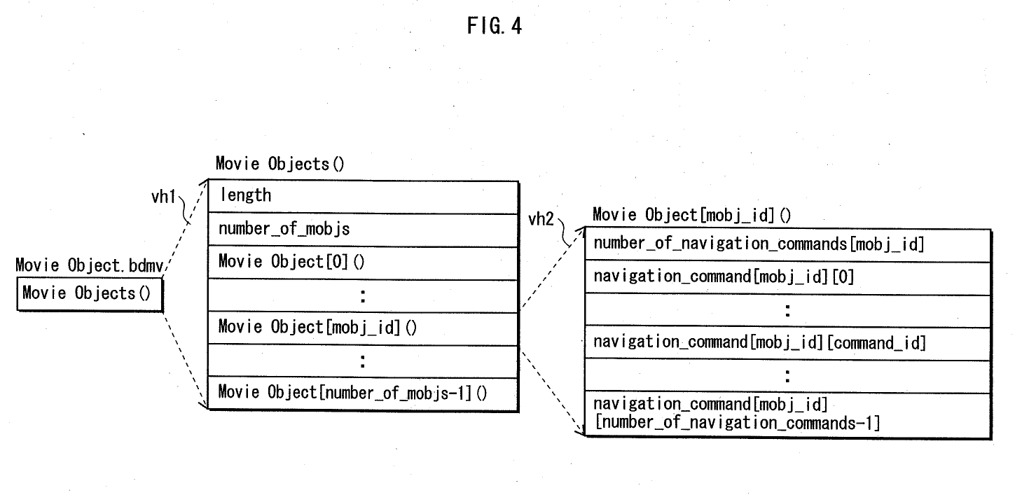

The Movie Object is stored in a file “Movie Object.bdmv”. FIG. 4 shows the internal structure of the Movie Object.bdmv. As shown on the left-hand side of FIG. 4, the Movie Object.bdmv includes one or more “MovieObjects ( )”. The lead line “vh1” in FIG. 4 indicates the close-up of the internal structure of the MovieObjects( ). The MovieObjects( ) includes “length” indicating the data length of its own, “number_ofo_mobjs” indicating the number of Movie Objects included in itself, and as many Movie Objects as indicated by the number_of mobjs. The Movie Objects are each identified by the “mobj_id”. The lead line “vh2” in FIG. 4 indicates the close-up of the internal structure of a Movie Object [mobj_id] ( ) identified by an identifier mobj_id.

As shown in FIG. 4, the Movie Object [mobj_id]( ) includes “number_of_navigation_command” indicating the number of navigation commands, and as many navigation commands as indicated by the number_of_navigation_command. The navigation command sequence is composed of commands that achieve: a conditional branch; setting the status register in the playback device; acquiring a value set in the status register, and so on. The following are the commands that can be written in the Movie Objects.

### PlayPL Command

Format: PlayPL (First Argument, Second Argument)

As the first-argument, a PlayList number can be used to indicate a PlayList to be played back. As the second argument, a PlayItem contained in the PlayList, a given time in the PlayList, a Chapter, or a Mark can be used to indicate a playback start position.

A PlayPL function that specifies a playback start position on the PL time axis using a PlayItem is called PlayPLatPlayItem( ).

A PlayPL function that specifies a playback start position on the PL time axis using a Chapter is called PlayPLat Chapter( ).

A PlayPL function that specifies a playback start position on the PL time axis using time information is called PlayPLatSpecifiedTime( ).

### JMP Command

Format: JMP Argument

The JMP command is used for a branch that discards a currently executed dynamic scenario and executes a branch destination dynamic scenario that is specified by the argument. The JMP command has two types: a direct reference type that directly specifies the branch destination dynamic scenario; and an indirect reference type that indirectly refers to the branch destination dynamic scenario.

The description format of the navigation command in the Movie Object resembles that in DVD. For this reason, a transplant of a disc content from a DVD onto a BD-ROM can be done efficiently. Up to now, the Movie Object has been described. The following describes the BD-J Object, starting with details of the BD-J application.

### <BD-ROM Structure 3: BD-J Application>

“00001.jar” stores a BD-J application. The BD-J application is a Java™ application that runs on a platform that is fully implemented with the Java™ Micro_Edition (J2ME) Personal Basis Profile (PBP1.0), and the Globally Executable MHP specification (GEM[1.0.2]) for package media targets.

The BD-J application is controlled by the Application Manager via the xlet interface. The xlet interface is in any of four statuses: “loaded”, “paused”, “active”, and “destroyed”.

The above-mentioned Java™ platform includes a standard Java™ library that is used to display image data such as JFIF (JPEG) and PNG. With this construction, the Java™ application can realize a GUI framework that includes the HAVi framework defined in GEM[1.0.2], and includes the remote control navigation mechanism in GEM[1.0.2].

With such a construction, the Java™ application can realize a screen display that includes displaying buttons, texts, an online display (contents of BBS) or the like based on the HAVi framework, simultaneously with the moving image on the same screen. This enables the user to operate on the screen using the remote control.

The series of files that constitute the BD-J application are converted into Java™ archive files which conform to the specifications provided in http://java.sun.com/j2se/1.4.2/docs/guide/jar/jar.html. The Java™ archive files are files whose ZIP file format is specialized in Java™. The contents of Java™ archive files can be confirmed using some ZIP decompression software in the market.

Up to now, the BD-J application has been described. Described in the following is the BD-J. Object.

### <BD-ROM Structure 4: BD-J Object>

“00001.bdjo” stores a BD-J. Object. The BD-J Object is data that includes an Application Management Table ( ) and causes the platform unit to perform an application signaling when titles are changed during a playback of the BD-ROM. More specifically, the Application Management Table ( ) includes: “application_id” indicating a BD-J application to be executed; and “application_control_code” indicating a control to be performed to activate the BD-J application. The application_control_code defines the first execution state of the application after the title is selected. The application_control_code can specify either “AUTOSTART” or “PRESENT”, where with the AUTOSTART, the BD-J application is loaded onto a virtual machine to be automatically started, and with the PRESENT, the BD-J application is loaded onto a virtual machine but is not automatically started.

### <BD-ROM Structure 5: AVClip>

The file attached with the extension “m2ts” (00001.m2ts) stores an AVClip. The AVClip is a digital stream conforming to the MPEG2-Transport Stream format.

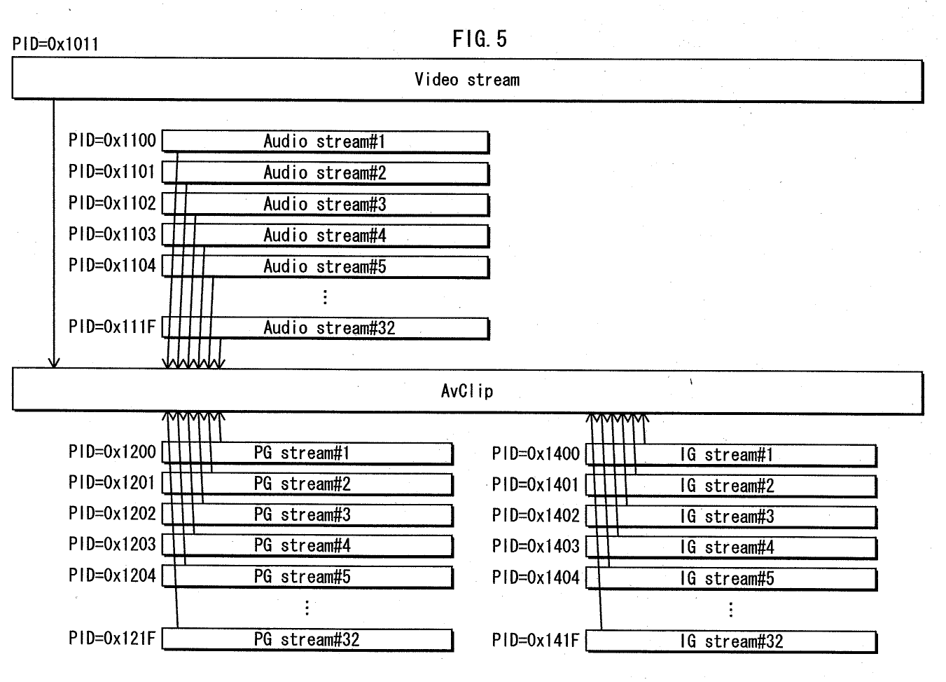

FIG. 5 shows the structure of the AVClip. As shown in FIG. 5, multiplexed in the AVClip are a video stream with PID 0x1011, audio streams with PIDs 0x1100 through 0x1200F, 32 Presentation Graphics (PG) streams with PIDs 0x1200 through 0x121F, and 32 Interactive Graphics (IG) streams with PIDs 0x1400 through 0x141F.

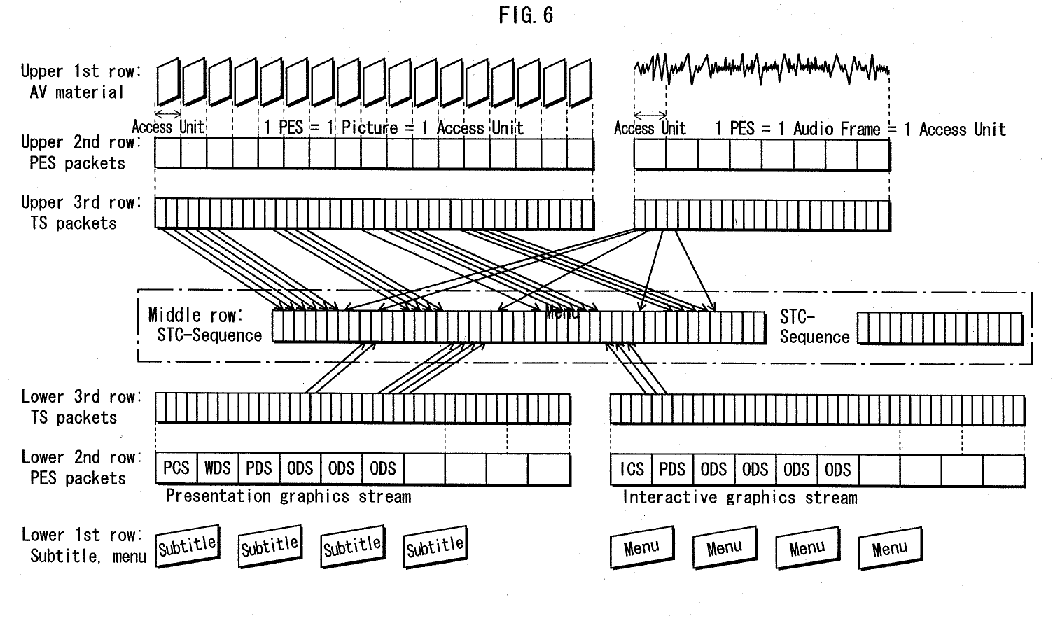

FIG. 6 illustrates how the elementary streams shown in FIG. 5 are multiplexed in the AVClip. The AVClip is generated by converting the digitized video and audio (upper first row) into an elementary stream composed of PES packets (upper second row), and converting the elementary stream into TS packets (upper third row), and similarly, converting the Presentation Graphics (PG) stream for the subtitles or the like and the Interactive Graphics (IG) stream for the interactive purposes (lower first row, lower second row) into the TS packets (third row), and then finally multiplexing these TS packets.

As shown in the upper first row of FIG. 6, the video stream is composed of a plurality of pictures. The relationships between the pictures and access units are represented as 1 access unit=1 picture. Similarly, the audio stream is composed of a plurality of audio frames. The relationships between the audio frames and access units are represented as 1 audio frame=1 access unit, as shown in the upper first row of FIG. 6. In the BD-ROM, there is a limitation represented as 1 PES packet=1 frame. That is to say, when the video has the frame structure, 1 PES packet=1 picture, and when the video has the field structure, 1 PES packet=2 pictures. These taken into account, the PES packets shown in the upper second row of FIG. 6 store the pictures and audio frames shown in the upper first row on the one-to-one basis.

The AVClip, generated as described above, is composed of one or more “STC sequences”. The STC sequence is a section on the MPEG2-TS time axis based on which the decoding times and display times are indicated, where the section of the STC sequence does not include any system time-base discontinuity in the STC (System Time Clock) that is the system basic time for the AV streams. The system time-base discontinuity in the STC is a point for which ON is a discontinuity indicator of the PCR (Program Clock Reference) packet that carries a PCR that is referred to by the decoder to obtain the STC.

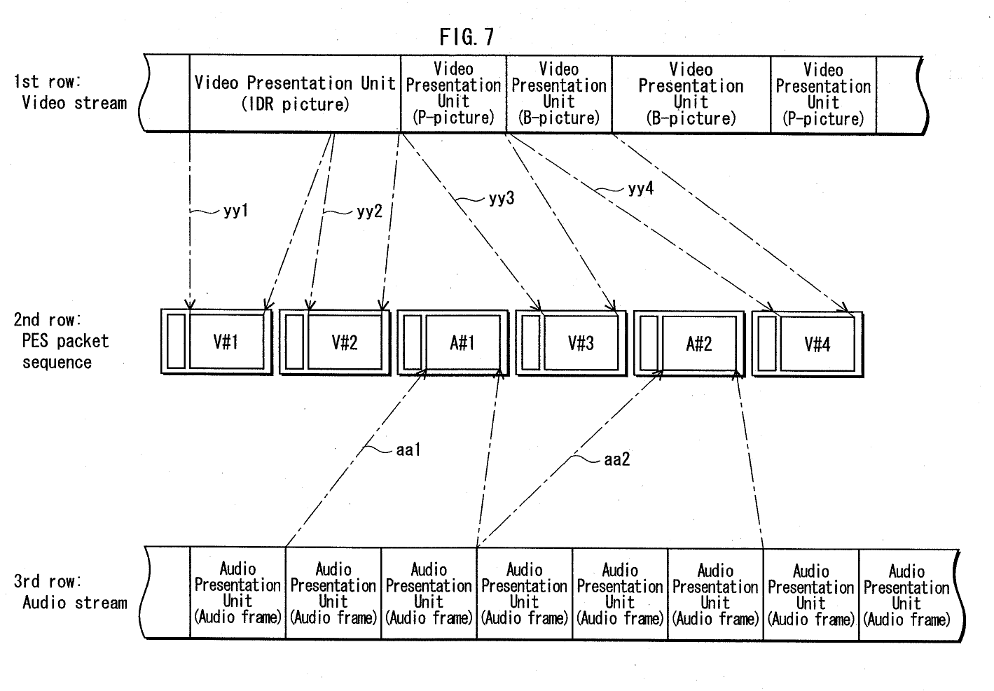

FIG. 7 shows, in further details, how a video stream and an audio stream is stored into a PES packet sequence. The first row of FIG. 7 shows the video stream and the third row shows the audio stream. The second row of FIG. 7 shows the PES packet sequence. As shown in FIG. 7, a plurality of video presentation units, which constitute the video stream and fall into IDR pictures, B-pictures and P-pictures, are segmented into a plurality of segments, and the segments are stored into payloads (represented as V#1, V#2, V#3, and V#4 in FIG. 7) of the PES packet, as indicated by arrows yy1, yy2, yy3, and yy4. Also, a plurality of audio presentation units, which constitute the audio stream and are audio frames, are stored into payloads (represented as A#1 and A#2 in FIG. 7) of the PES packet, as indicated by arrows aa1 and aa2.

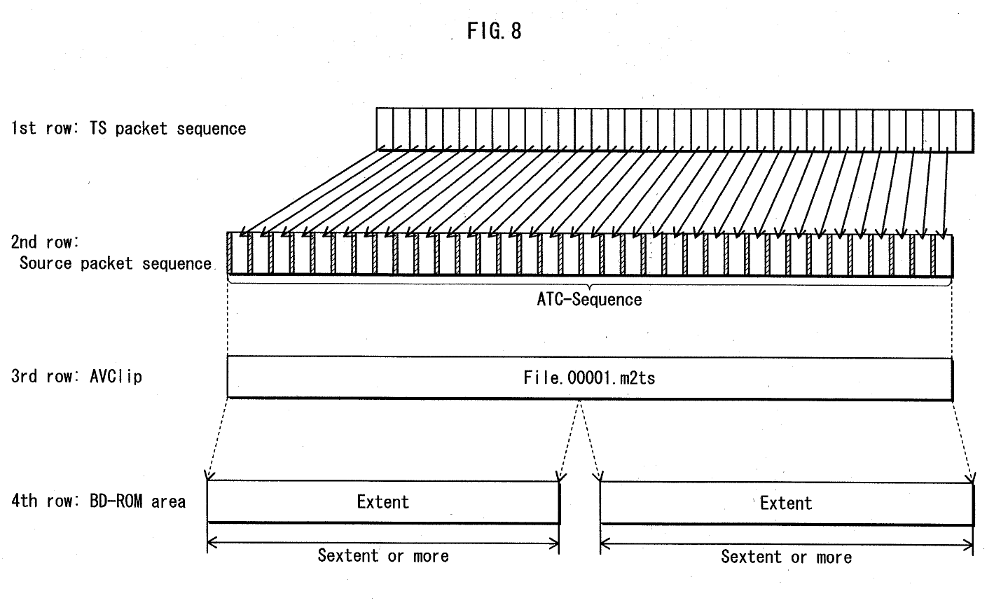

Next described is how the AVClip having the above-stated structure is written onto the BD-ROM. FIG. 8 shows the processes to which the TS packets constituting the AVClip are subjected before they are written onto the BD-ROM. The first row of FIG. 8 shows the TS packets constituting the AVClip.

As shown in the second row of FIG. 8, a 4-byte TS_extra_header (shaded portions in the drawing) is attached to each 188-byte TS packet constituting the AVClip to generate each 192-byte source packet. The TS_extra_header includes Arrival_Time_Stamp that is information indicating the time at which the TS packet is input to the decoder.

The AVClip shown in the third row includes one or more “ATC_Sequences” each of which is a sequence of source packets, where Arrival_Time_Clocks referred to by the Arrival_Time_Stamps included in the ATC_Sequence do not include “arrival time-base discontinuity”. In other words, the “ATC_Sequence” is a sequence of source packets, where Arrival_Time_Clocks referred to by the Arrival_Time_Stamps included in the ATC_Sequence are continuous. The ATS is attached to the start of the TS packet, and indicates a time when a transfer to the decoder occurs.

Such ATC_Sequences constitute the AVClip, and is recorded onto the BD-ROM with a file name “xxxxx.m2ts”.

The AVClip is, as is the case with the normal computer files, divided into one or more file Extents, which are then recorded in areas on the BD-ROM. The third row shows the AVClip, and the fourth row shows how the AVClip is recorded onto the BD-ROM. In the fourth row, each file Extent constituting the file has a data length that is equal to or larger than a predetermined length called Sextent.

The source packets constituting the file Extent are divided into groups each of which is composed of 32 source packets. Each group of source packets is then written into a set of three continuous sectors. The group of 32 source packets is 6144 bytes (=32×192), which is equivalent to the size of three sectors (=2048×3). The 32 source packets stored in the three sectors is called an “Aligned Unit”. Writing to the BD-ROM is performed in units of Aligned Units.

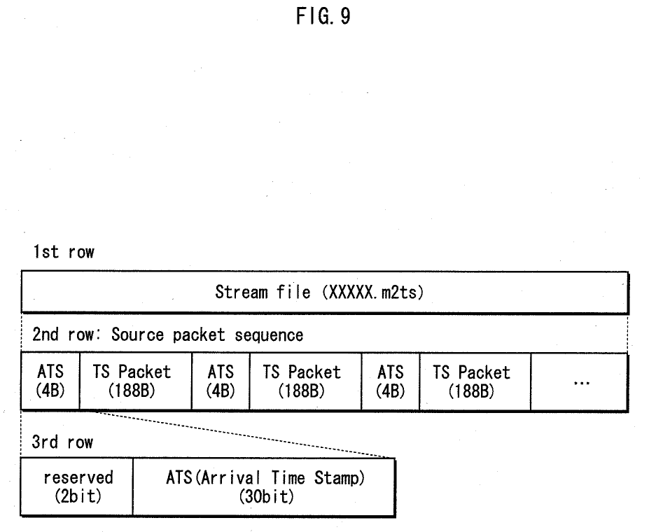

FIG. 9 illustrates a hierarchical structure constituted by the AVClip, source packets, and ATS. The first row of FIG. 9 shows the AVClip, and the second row shows a source packet sequence. Also, the third row shows the ATS in a source packet. As shown in the third row, a two-bit reserved area precedes a 30-bit ATS, in the source packet.

### <BD-ROM Structure 6: Clip Information>

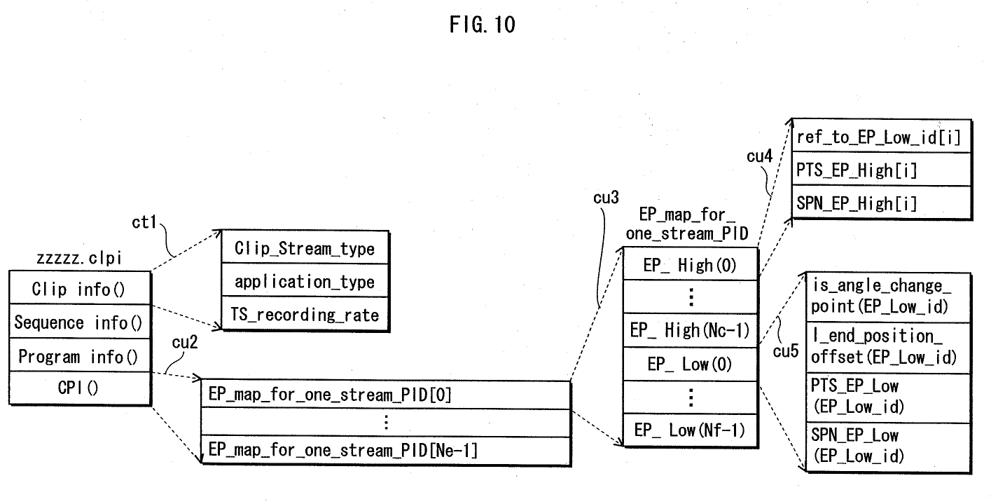

Next, files to which an extension “clpi” is attached will be described. A file (00001. clip, 00002. clip, 00003. clip, . . . ) to which an extension “clpi” is attached, stores Clip information. The Clip information is management information on each AVClip. FIG. 10 shows the internal structure of Clip information. As shown on the left-hand side of the drawing, the Clip information includes:

i) “Clip Info( )” storing information regarding the AVClip;
ii) “Sequence Info( )” storing information regarding the ATC Sequence and the STC Sequence;
iii) “Program Info ( )” storing information regarding the Program Sequence; and

### iv) “Characteristic Point Info (CPI( ))”.

The Clip Info includes an application_type indicating the application type of the AVClip referred to by the Clip Info itself. By referring to such Clip Info, it is possible to determine whether it is the AVClip or SubClip, or which of a video and a still image (a slideshow) is included.

The Sequence Info is information regarding one or more STC-Sequences and ATC-Sequences contained in the AVClip. The reason that these information are provided is to preliminarily notify the playback device of the system time-base discontinuity and the arrival time-base discontinuity. That is to say, if such discontinuity is present, there is a possibility that a PTS and an ATS that have the same value appear in the AVClip. This might be a cause of a defective playback. The Sequence Info is provided to indicate from where to where in the transport stream the STCs or the ATCs are sequential.

The Program Info is information that indicates a section (called “Program Sequence”) of the program where the contents are constant. Here, “Program” is a group of elementary streams that have in common a time axis for synchronized playback. The reason that the Program Sequence information is provided is to preliminarily notify the playback device of a point at which the Program contents change. It should be noted here that the point at which the Program contents change is, for example, a point at which the PID of the video stream changes, or a point at which the type of the video stream changes from SDTV to HDTV.

From now on, the Characteristic Point Info will be described. The lead line cu2 in the drawing indicates the close-up of the structure of CPI. As indicated by the lead line cu2, the CPI is composed of the Ne pieces of EP_map_for_one_stream_PIDs: EP_map_for_one_stream_PID [0] . . . EP_map_for_one_stream_PID [Ne−1]. These EP_map_for_one_stream_PIDs are EP maps of the elementary streams that belong to the AVClip. The EP_map is information that indicates, in association with an entry time (PTS_EP_start), a packet number (SPN_EP_start) at an entry position where the Access Unit is present in one elementary stream. The lead line cu3 in the drawing indicates the close-up of the internal structure of EP_map_for_one_stream_PID.

It is understood from this that the EP_map_for_one_stream_PID is composed of the Ne number of EP_Highs (EP_High(0) . . . EP_High(Nc−1)) and the Nf number of EP_Lows (EP_Low(0) . . . EP_Low (Nf−1)). Here, the EP_High plays a role of indicating upper bits of the SPN_EP_start and the PTS_EP_start of the Access Unit, the EP_Low plays a role of indicating lower bits of the SPN_EP_start and the PTS_EP_start of the Access Unit.

The lead line cu4 in the drawing indicates the close-up of the internal structure of EP_High. As indicated by the lead line cu4, the EP_High(i) is composed of: “ref_to_EP_Low_id[i]” that is a reference value to EP_Low; “PTS_EP_High[i]” that indicates upper bits of the PTS of the Non-IDR I-Picture and the IDR-Picture that are at the start of the Access Unit; and “SPN_EP_High [i] ” that indicates upper bits of the SPN of the Non-IDR I-Picture and the IDR-Picture that are at the start of the Access Unit. Here, “i” is an identifier of a given EP_High.

The lead line cu5 in the drawing indicates the close-up of the structure of EP_Low. As indicated by the lead line cu5, the EP_Low(i) is composed of: “is_angle_change_point(EP_Low_id)” that indicates whether or not the corresponding Access Unit is an IDR picture; “I_end_position_offset(EP_Low id)” that indicates the size of the corresponding Access Unit; “PTS_EP_Low(EP_Low_id)” that indicates lower bits of the PTS of the Access Unit (Non-IDR I-Picture, IDR-Picture); and “SPN_EP_Low(EP_Low_id)” that indicates lower bits of the SPN of the Access Unit (Non-IDR I-Picture, IDR-Picture). Here, “EP_Low_id” is an identifier for identifying a given EP_Low.

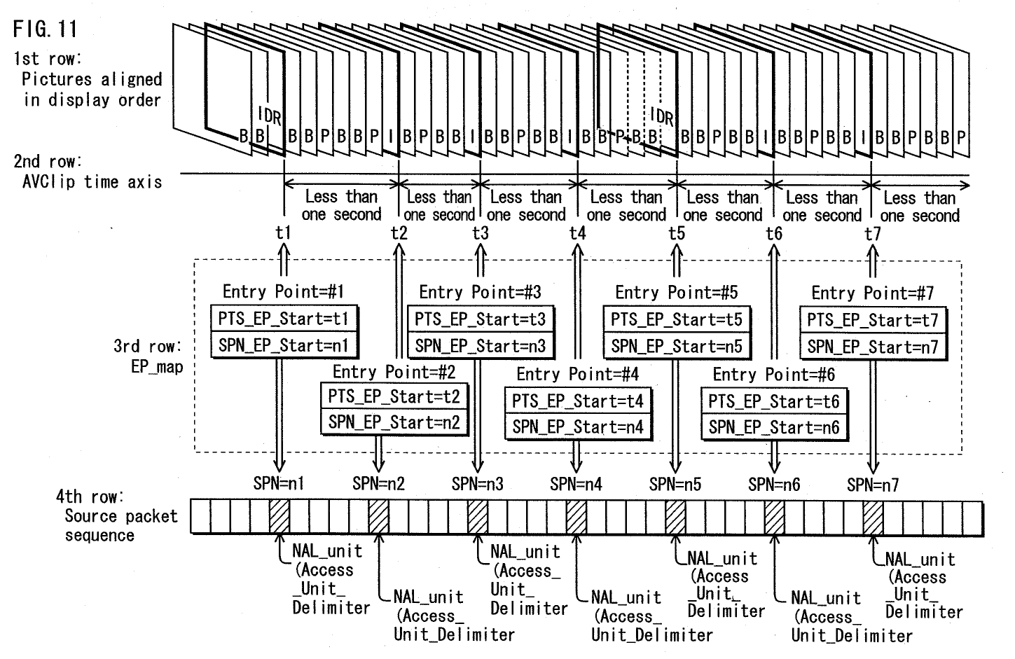

Here, the EP_map will be explained in a specific example. FIG. 11 shows EP_map settings on a video stream of a motion picture. The first row shows a plurality of pictures (IDR picture, I-Picture, B-Picture, and P-Picture defined in MPEG4-AVC). The second row shows the time axis for the pictures. The fourth row indicates a packet sequence, and the third row indicates settings of the EP_map.

It is presumed here that in the time axis of the second row, an IDR picture or an I-Picture is present at each time point t1 . . . t7. The interval between adjacent ones of the time point t1 . . . t7 is approximately one second. The EP_map used for the motion picture is set to indicate t1 to t7 as the entry times (PTS_EP_start), and indicate entry positions (SPN_EP_start) in association with the entry times.

### <BD-ROM Structure 7: PlayList Information>

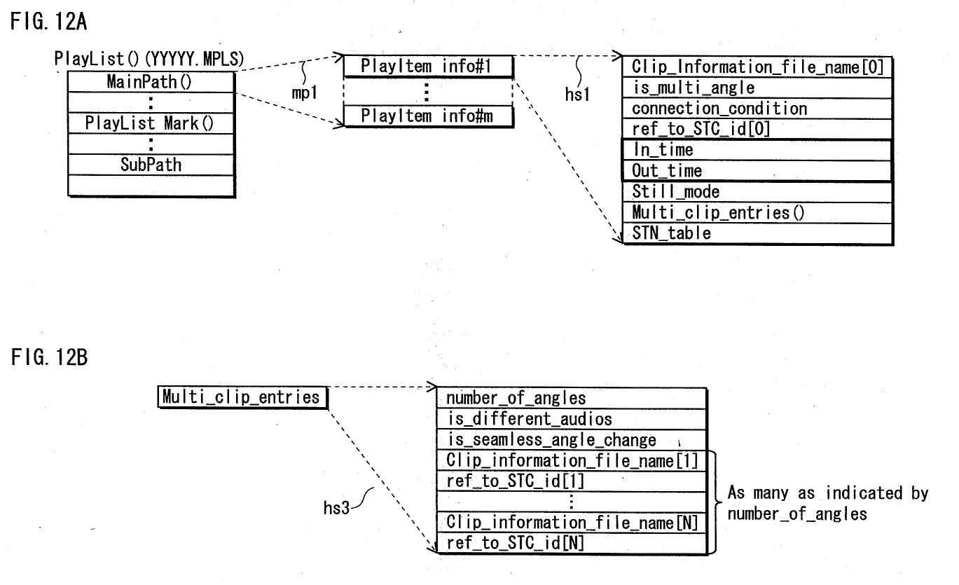

A file (00002.mpls) to which extension “mpls” is attached will be described. This file is information that defines, as a PlayList (PL), a combination of two types of playback paths called MainPath and SubPath. FIG. 12A shows the data structure of the PlayList information. As shown in the drawing, the PlayList information includes: MainPath information (MainPath( )) that defines MainPath; PlayListMark information (PlayListMark ( )) that defines chapter; and SubPath information (SubPath ( )) that defines SubPath.

### <PlayList Information Explanation 1: MainPath Information>

First, the MainPath will be described. The MainPath is a presentation path that is defined in terms of the video stream as the main image and the audio stream. As indicated by the arrow mp1, the MainPath is defined by a plurality of pieces of PlayItem information: PlayItem information #1 . . . . PlayItem information #m. The PlayItem information defines one or more logical playback sections that constitute the MainPath. The lead line hs1 in the drawing indicates the close-up of the structure of the PlayItem information.

As indicated by the lead line hs1, the PlayItem information is composed of: “Clip_Information_file_name[0]” that indicates the file name of the playback section information of the AVClip to which the IN point and the OUT point of the playback section belong; “is_multi_angle” that indicates whether or not the PlayItem is multi angle; “connection_-condition” that indicates whether or not to seamlessly connect the current PlayItem and the previous PlayItem; “ref_to_STC_id[0]” that indicates uniquely the STC_Sequence targeted by the PlayItem; “In_time” that is time information indicating the start point of the playback section; “Out_time” that is time information indicating the end point of the playback section; “Still_mode” that indicates whether or not to continue a still display of the last picture after the playback of the PlayItem ends; “Multi_Clip_entries” that indicates a plurality of AVClips constituting the multi angle when the PlayItem is multi angle; and “STN_table”.

FIG. 12B shows the internal structure of the Multi_Clip_entries. As shown in the drawing, the Multi_Clip entries includes: “number_of_angles”; “is different_audios”; “is_seamless_angle change”; “Clip_information_file_name[1]”; “ref_to_STC_id[1]”; . . . “Clip_information_file_name[N]”; and “ref_to_STC_id[N]”.

The “Clip_codec_identifier”, “Clip_information_file_name”, and “ref_to_STC_id[0]” respectively correspond to AVClips constituting angle images in the multi-angle section.

### <PlayList Information Explanation 2: PlayListMark Information>

Next, the PlayListMark Information will be described.

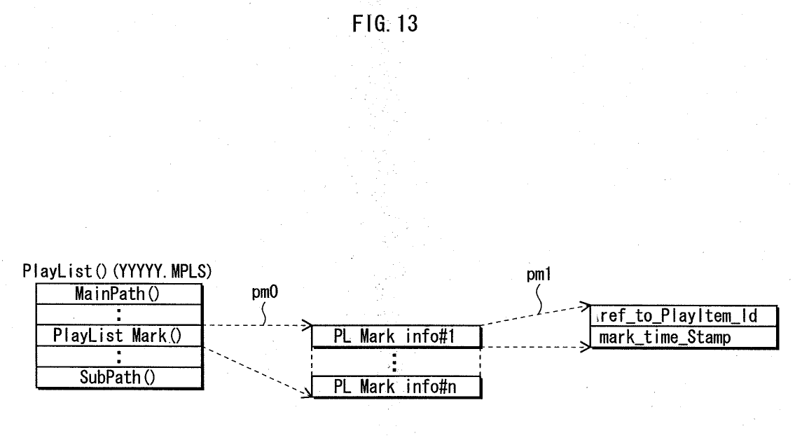

FIG. 13 shows the internal structure of the PlayListMark information of the PlayList information. As the lead line “pm0” in this figure indicates, the PlayListMark information includes a plurality of pieces of PLMark information (#1 . . . #n). The PLMark information (PLMark ( )) specifies a given period in the PlayList time axis as a chapter. As the lead line “pm1” in this figure indicates, the PLMark information contains: “ref_to_PlayItem_Id” which indicates a PlayItem as the target chapter; and “Mark_time_stamp” which indicates the chapter position using the time notation.

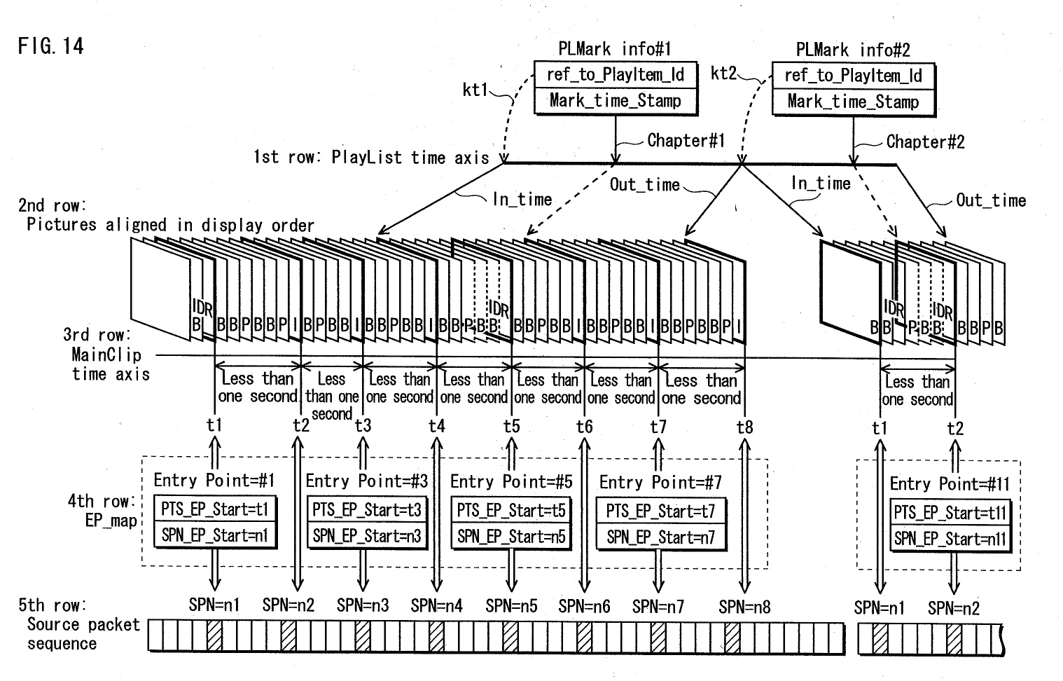

FIG. 14 shows how chapter positions are specified by the PLMark information of the PlayList information. The second to fifth rows in FIG. 14 are the same as the first to fourth rows in FIG. 10, and indicate the video stream referred to by the EP_map.

The first row shows the PL Mark information and the PlayList time axis. Two pieces of PL Mark information #1 and #2 are shown in the first row. The arrows kt1 and kt2 indicate specifications of PlayItems by ref_to PlayItem_Id in the PL Mark information. As understood from these arrows, ref_to_PlayItem_Id in the PL Mark information specifies PlayItems to be referred to. Also, the Mark_time_stamp indicates the times of Chapters #1 and #2 on the PL time axis. In this way, the PL Mark information defines chapter points on the PlayItem time axis.

### <PlayList Information Explanation 3: STN_table>

The following describes the STN_table. The STN (STream Number)_table indicates whether a playback of an elementary stream is valid or invalid in the PlayItem information, for each elementary stream multiplexed in the AVClip referred to by the Clip information.

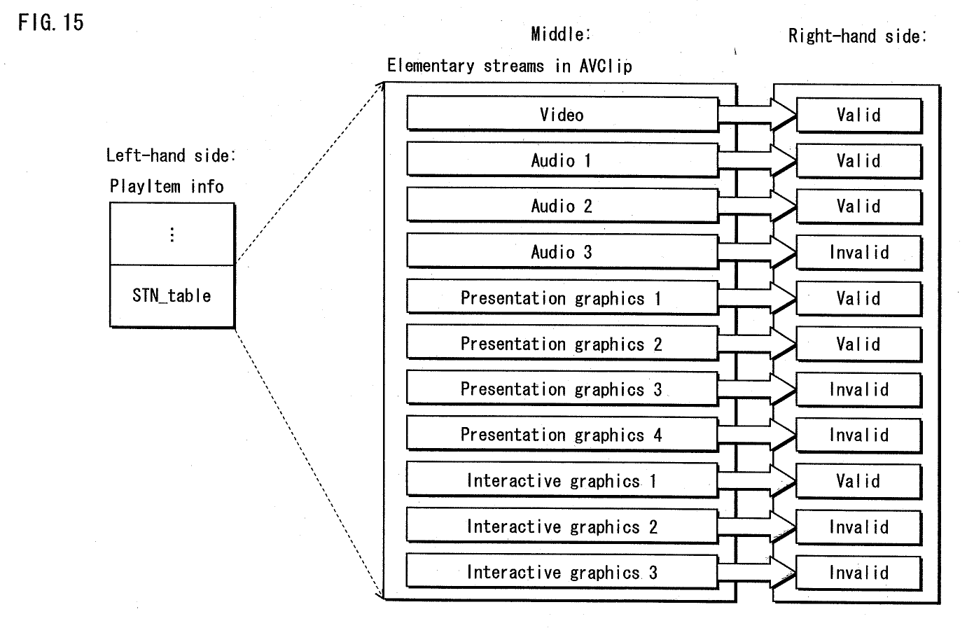

FIG. 15 shows an example of settings in the STN_table. The left-hand side of the drawing indicates the PlayItem information, and the middle part of the drawing indicates the types of elementary streams contained in the AVClip. The right-hand side of the drawing indicates specific settings in the STN_table.

In the example shown in FIG. 15, the AVClip in the middle part includes one video stream, three audio streams 1, 2 and 3, four PG streams 1, 2, 3 and 4, and three IG streams 1, 2 and 3.

The specific settings on the right-hand side indicate that the valid streams are: video, audio 1 and 2, Presentation Graphics 1 and 2, and Interactive Graphics 1. Therefore, in the PlayItem information, the elementary streams that are set as valid in the STN_table can be played back. The other elementary steams are prohibited from being played back. The STN_table also records therein attribute information for each elementary stream. It should be noted here that the attribute information is information that indicates the characteristics of each elementary stream. For example, the attribute information indicates the language attribute in the cases of the audio, presentation graphics, and interactive graphics.

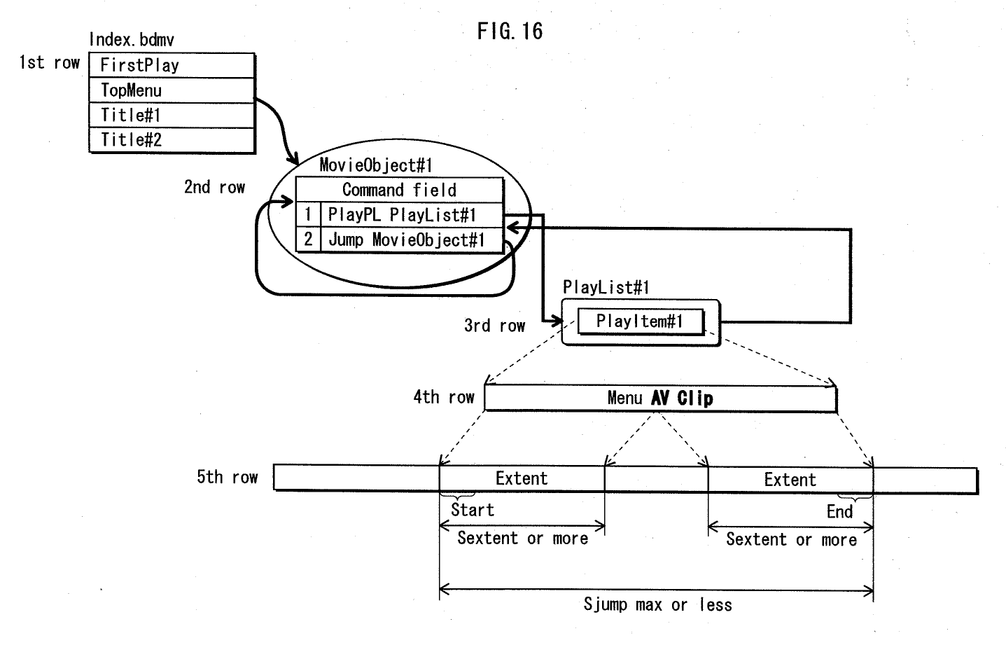

Up to now, the data structure of the BD-ROM has been described. The recording medium of the present invention provides the moving image menu based on the above-described data structure. FIG. 16 shows a typical hierarchical structure of an AVClip for the moving image menu. The first row of FIG. 16 shows index.bdmv. The second row indicates the Movie Object. The index.bdmv in the first row includes index of each title. As shown in FIG. 16, “MovieObject#1” is set in “TopMenu” of the index.bdmv. With this structure, when TopMenu is called, the commands set for the MovieObject#1 in the second row are executed in sequence. The first command of the Movieobject#1 is “PlayPL PlayList#1”. The PlayPL command is a command for playing back a PlayList being the argument starting from the head thereof. As the PlayPL PlayList#1 command is executed, the playback device analyzes the PlayItem information #1 that is the PlayItem information positioned at the head of the PlayList information #1, and starts playing back the AVClip specified by the Clip_Information_file_name in the PlayItem information.

In the AVClip, multiplexed with a background moving image is an IG stream that enables the user to perform the menu operation. The length of the AVClip depends on the content, but in general, a short-period image of, for example, one minute is used as the AVClip. This is because a long-period image consumes the disc capacity as much. After completion of playback of the AVClip, the control moves to the next command. In the example shown in FIG. 16, the second command is “Jump MovieObject#1”. After the playback of the PlayList information #1, this jump command instructs jumping to MovieObject#1 to call the PlayPL command again.

The “In_Time” in the PlayItem information #1 is set to indicate the Presentation TiMe (PTM) of the picture data that exists at the start of the AVClip for moving image menu; and the “Out_Time” in the PlayItem information #1 is set to indicate the Presentation TiMe (PTM) of the picture data that exists at the end of the AVClip for moving image menu. The playback of the PlayList is executed many times when such a PlayPL command and the Jump command are executed by the command processor.

However, according to this data structure, the AV playback screen stops and the buttons disappear during the time period between the playbacks of the PlayList information #1.

More specifically, after an end of playback of the AVClip based on the PlayList information specified by the PlayPL command, the PlayPL command is to be executed to load the PlayList information again. During this time period, the AV playback screen stops, keeping on displaying the picture that was referred to last by the PlayItem information.

When the PlayList information is to be re-loaded, the playback device performs flushing of the memory area storing the PlayList information and flushing of the buffer memory of the decoder. These flushing once eliminate the buttons represented by the IG streams and the subtitles represented by the PG streams. When this happens, the buttons and subtitles disappear from the screen. The present embodiment proposes a solution to these problems of the stop of the AV playback screen and disappearing of the buttons and subtitles.

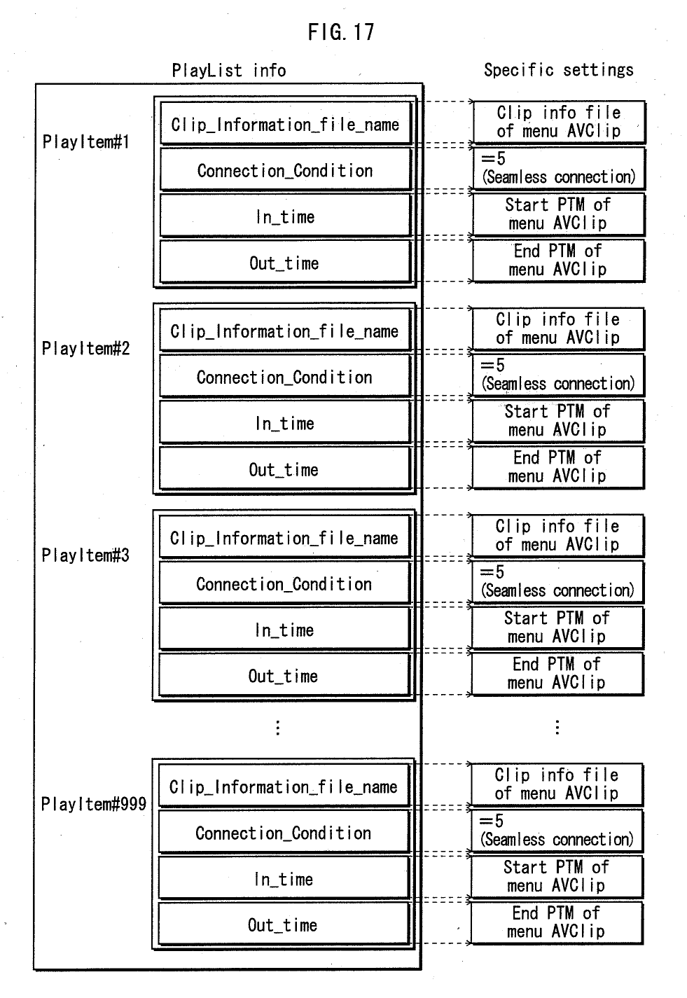

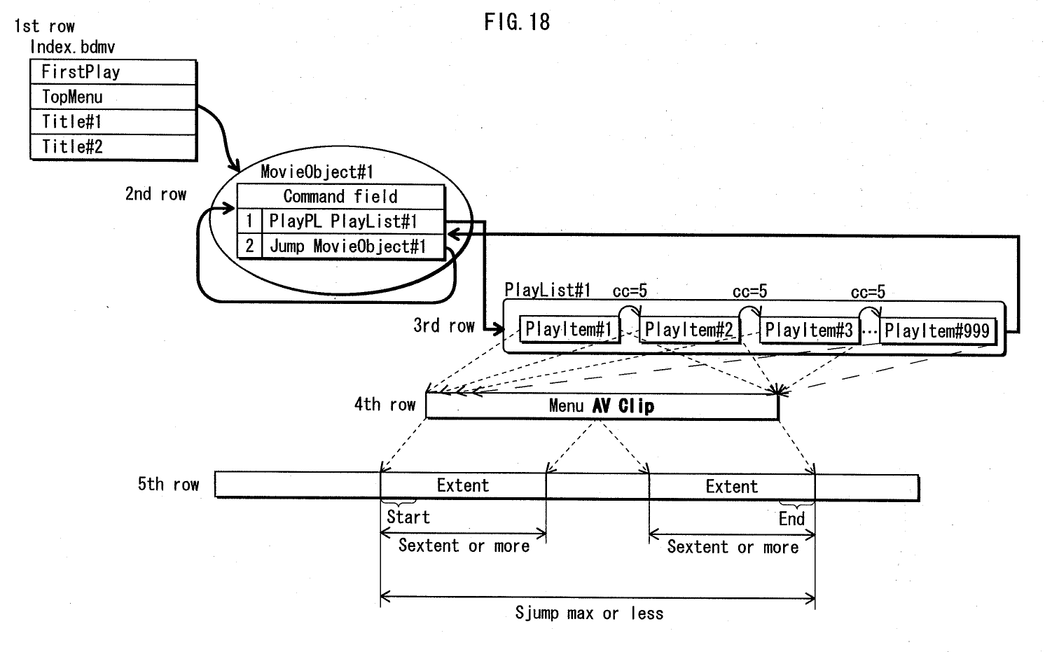

FIG. 17 shows the data structure that is characteristic to the BD-ROM 100. The left-hand side of the drawing shows the data structure of the PlayList information, and the right-hand side of the drawing shows specific settings of the PlayItem information. The left-hand side of the drawing indicates that the PlayList information can include 1 through 999 pieces of PlayItem information. The identification number of the PlayList information has three digits, and thus 999 pieces of PlayItem information existing in the PlayList information is the largest number that can be represented by three digits. On the other hand, according to the specific description on the right-hand side of the drawing, the 999 pieces of PlayItem information are commonly set. Namely,: Clip_Information file_name Indicates Clip information of AVClip#1 that is an AVClip for the moving image menu; In_Time indicates the start PTM (Presentation TiMe) of the AVClip for the moving image menu; Out_Time indicates the end PTM of the AVClip for the moving image menu; and Connection_Condition indicates CC=5 (seamless connection). FIG. 18 shows the data structure of the PlayList information in the same notation as in FIG. 16.

The BD-ROM standard limits the number of pieces of PlayItem information to 999 at most. This is because there is a limit to the number of digits to be assigned to the identification number, and because there is a demand that the PlayList information be used on-memory. That is to say, the PlayList information is read onto the memory prior to a playback of an AVClip, and the playback of the AVClip based on the PlayList information is performed while the PlayList information is stored in the memory. As understood from this, the number of pieces of PlayItem information cannot be increased limitlessly because it is presumed that the PlayList information is used on-memory. Therefore, the BD-ROM application layer standard limits the number of pieces of PlayItem information to 999 at most.

FIG. 18 shows a hierarchical structure of the moving image menu in Embodiment 1. FIG. 18 differs from FIG. 16 in the structure of PlayList information #1 shown in the second row. Namely, while PlayList informational of FIG. 16 is composed of one piece of PlayItem information, PlayList information #1 of FIG. 18 is composed of 999 pieces of PlayItem information, and In_Time and Out_Time of each of the 999 pieces of PlayItem information indicate the start and end points of the same AVClip. Also, all pieces of PlayItem information except for PlayItem #1 (namely, the first piece among the 999 pieces of PlayItem information) are set as connection_condition=5. This makes it possible to notify the playback device of the seamless connection between each piece of PlayItem information.

Also, in the menu AVClip commonly referred to by a plurality of pieces of PlayItem information, it is set that the distance from the end Extent of the menu AVClip to the start Extent of the menu AVClip does not exceed Sjump_max being the maximum jump size, and that the end Extent of the menu AVClip has a size that is equal to or more than the minimum Extent size calculated from the time required for jumping the distance.

Further, in the menu AVClip commonly referred to by a plurality of pieces of PlayItem information, the data is created such that the decode model does not break down even if the decoding is performed to the end of the menu AVClip, and then the playback is kept to continue from the start of the menu AVClip without clearing the decode buffer. The starting portion of the AVClip is assigned with an amount of code on the presumption of a predetermined initial state. The predetermined initial state is a state of the buffer immediately after an AVClip has been read into the buffer to play back the AVClip by the immediately preceding PlayItem.

By assigning an amount of code to the starting portion of the menu AVClip as described above, the menu AVClip can be played back seamlessly and repeatedly.

With the above-described data structure, when PlayList#1 shown in FIG. 17 is played back, the same AVClip is repeatedly played back seamlessly in correspondence with PlayItem information #1 through #999. When the number of pieces of PlayItem information is set to, for example, “999” that is the largest number permitted by the standard, PlayList information #1 loops pseudo permanently with use of a short-period AVClip. This prevents the screen from stopping each time an AvClip is played back, and prevents the subtitle, buttons constituting the menu and the like from disappearing. For example, when the number of pieces of PlayItem information is set to “999” and one-minute-long AVClip is prepared, a playback of 999 minutes=16.5 hours is available. This makes it possible to play back the AVClip seamlessly, keeps the screen from stopping, and keeps the subtitle and buttons from disappearing for a far longer time period than a time period generally required for performing operations on the menu. That is to say, a playback stop occurs once in 999 times of playbacks when the Jump command is executed to repeat the PlayPL command.

With this structure, even if a stop of the AV screen and disappearing of buttons and subtitle occur between executions of the PlayPL command and the Jump command, these do not occur while the 999 pieces of PlayItem information are played back. For example, in the case where one-minute-long AVClip is used, a stop of the AV screen does not occur for 999 minutes=16.5 hours. As understood from this, even when an AVClip having a short playback time is used for the menu, it is possible to wait a menu operation without a playback interruption.

Next will be described how connection of the plurality of pieces of PlayItem information in the PlayList information is achieved.

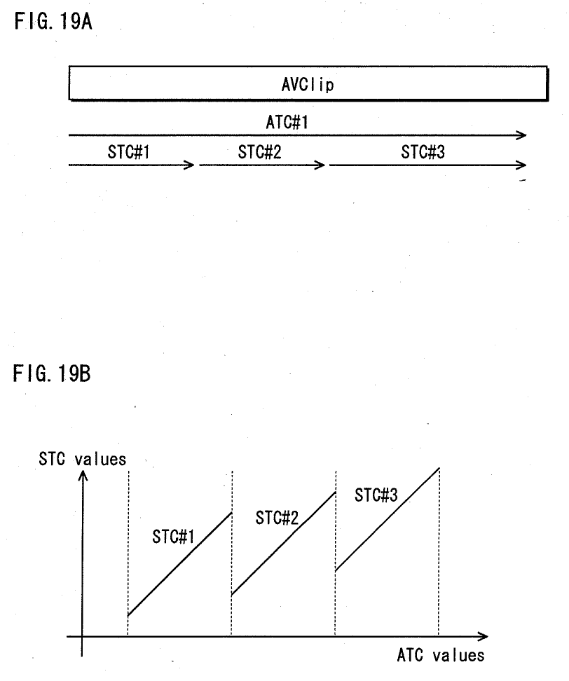

FIG. 19A shows relationships between ATC Sequences and STC Sequences. As shown in FIG. 19A, only one ATC Sequence can be included in one AVClip in the BD-ROM. On the other hand, the one ATC Sequence can include a plurality of STC Sequences.

FIG. 19B is a graph where STC values in STC Sequences are plotted along the vertical axis, and ATC values in ATC Sequences are plotted along the horizontal axis. The ATC values and the STC values are in the monotonic increase relationship, and the STC value increases as the STC value increases. However, as understood from the drawing, a discontinuity occurs at a switch to the STC Sequence.

An arbitrary piece among a plurality of pieces of PlayItem information included in the PlayList information is called “Current PlayItem”, and apiece of PlayItem information positioned immediately the Current PlayItem is called “Previous PlayItem”.

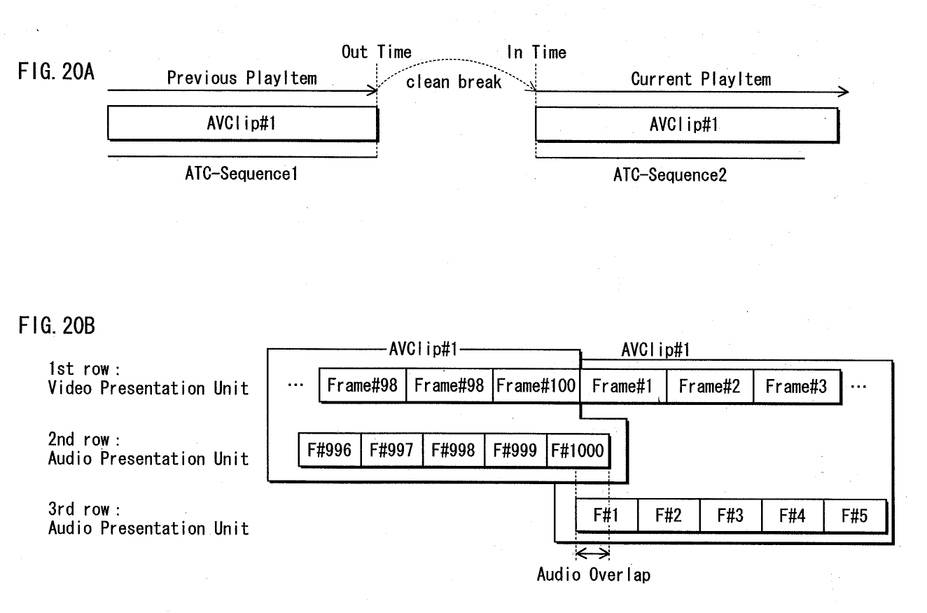

FIG. 20A shows two AVClips (AVClip#1 referred to by Previous PlayItem, and AVClip#1 referred to by Current PlayItem) that are connected seamlessly.

FIG. 20B shows the relationships between (a) Video Presentation Unit and Audio Presentation Unit in AVClip#1 referred to by Previous PlayItem and (b) Video Presentation Unit and Audio Presentation Unit in AVClip#1 referred to by Current PlayItem. The first row of the drawing indicates Video Presentation Unit (video frame) that constitutes AVClip#1 referred to by Previous PlayItem, and indicates Video Presentation Unit (video frame) that constitutes AVClip#1 referred to by Current PlayItem.

The second row of the drawing indicates Audio Presentation Unit (audio frame) that constitutes AVClip#1 referred to by Previous PlayItem. The third row of the drawing indicates Audio Presentation Unit (audio frame) that constitutes AVClip#1 referred to by Current PlayItem. It is supposed here that the playback time of the last Video Presentation Unit in AVClip#1 referred to by Previous PlayItem is 200000, and the playback time of the first Audio Presentation Unit in AVClip#1 referred to by Current PlayItem is 500000. The seamless playback can be performed even if there is a discontinuity between (i) the playback time of the last Video Presentation Unit in AVClip#1 referred to by Previous PlayItem and (ii) the playback time of the starting portion of AVClip#1 referred to by Current PlayItem.

These two AVClips should satisfy the Clean Break conditions. More specifically, the following restrictions are imposed.

(1) The audio frames are made to overlap at the seamless boundary.

(2) The last audio frame of Clip#1 overlaps with the end time of the video.

(3) The first audio frame of Clip#2 overlaps with the start time of the video.

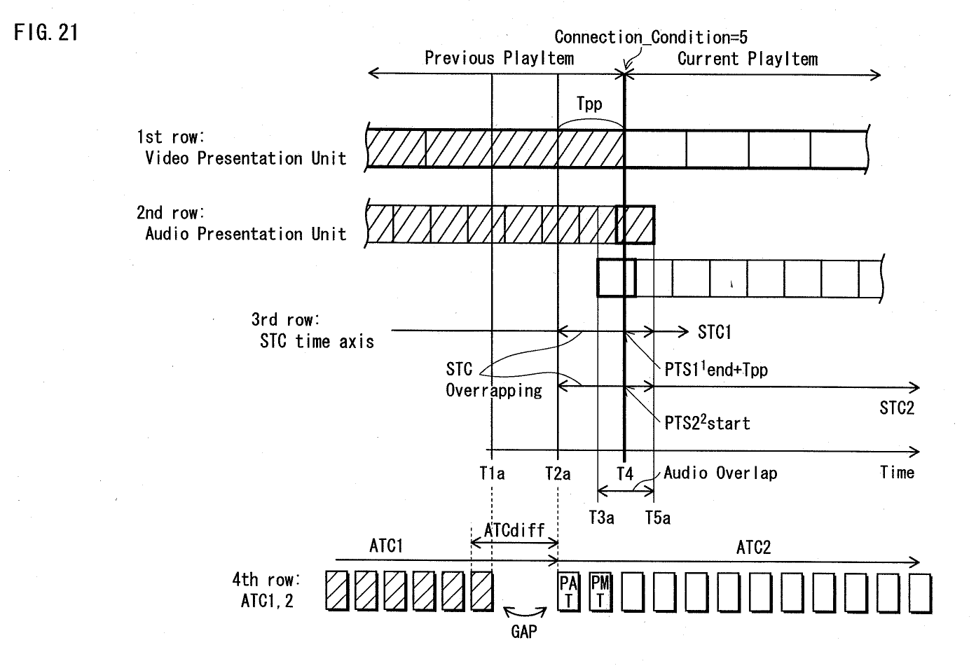

The transport stream packet sequence supplied to the playback device by Previous PlayItem is called “TS1”, and the transport stream packet sequence supplied to the playback device by Current PlayItem is called “TS2”. Clean Break is a state in which TS1 fed into the decoder by Previous PlayItem and TS2 fed into the decoder by Current PlayItem satisfy the relationships shown in FIG. 21. FIG. 21 illustrates details of Clean Break.

The first row of FIG. 21 indicates a plurality of Video Presentation Units in TS1 and TS2, the second row indicates Audio Presentation Units in TS1 and TS2, the third row indicates STC values in AVClip, and the fourth row indicates a source packet sequence in AVClip.

In FIG. 21, the boxes with shading represent Video Presentation Units, Audio Presentation Units and source packets on the TS1 side, and the boxes without shading represent Video Presentation Units, Audio Presentation Units and source packets on the TS2 side.

In the Clean Break shown in FIG. 21, although the two Video Presentation Units have a common boundary therebetween (the first row), there is a gap between ATCs in the AVClip (the fourth row), and Audio Presentation Units in the AVClip overlaps with each other (the second row).

Viewing from the TS1 side, the boundary between the Video Presentation Units is PTS1¹End+Tpp representing the end point of the last Video Presentation Unit in the first row, and viewing from the TS2 side, the boundary between the Video Presentation Units is PTS2²Start representing the start point of the last Video Presentation Unit in the first row.

The overlapping section between Audio Presentation Units in the AVClip is a section extending from T3a to T5a, where “T5a” represents the end point of Audio Presentation Unit of TS1 that matches “T4” representing the boundary time point, and “T3a” represents the start point of Audio Presentation Unit of TS2 that matches “T4”.

The drawing suggests that, to realize CC=5, the following four conditions should be satisfied in the levels of Video Presentation Unit, Audio Presentation Unit, and packet.

(1) The last Audio Presentation Unit in the audio stream of TS1 includes a sample having a playback time that is equal to the end of the display period of the last video picture in TS1 specified by Previous PlayItem.

(2) The first Audio Presentation Unit in the audio stream of TS2 includes a sample having a playback time that is equal to the start of the display period of the first picture in TS2 specified by Current PlayItem.

(3) There is no gap between the Audio Presentation Unit sequences at the connection point. This means that an overlap may occur between the Audio Presentation Unit sequences. However, such an overlap should be shorter than the playback period of the two audio frames.

(4) The first packet in TS2 should include the PAT (Program Allocation Table) that is immediately followed by one or more PMTs (Program Map Tables). When the PMT is larger than the payload of the TS packet, there may be two or more packets. The TS packet storing the PMT should also include PCR or SIT. This ends the description of an embodiment regarding the recording medium of the present invention.

From now on, the playback device of the present invention will be described.

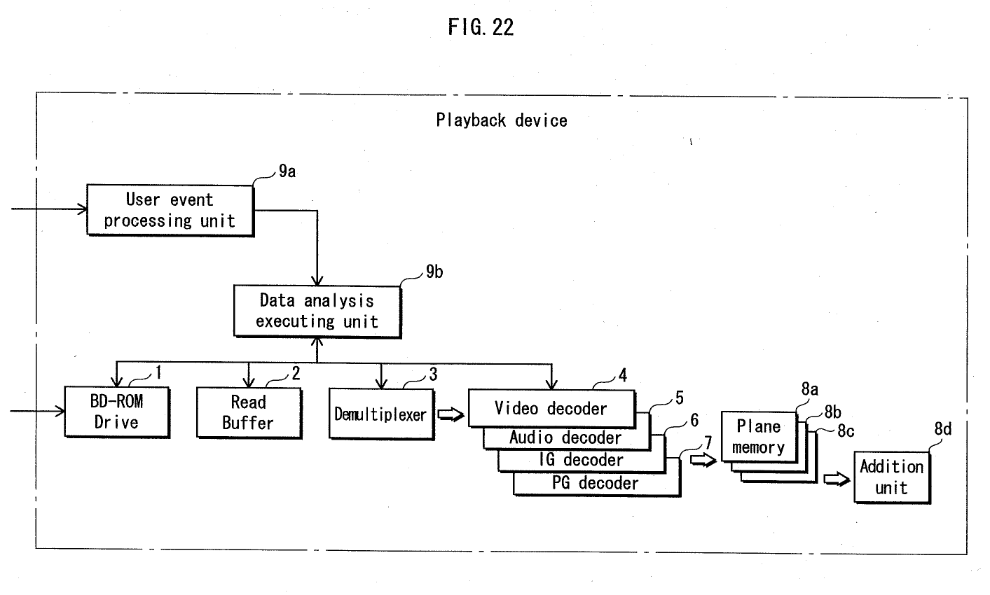

FIG. 22 shows the structure of the playback device 200 as a typical playback device. The playback device 200 includes a BD-ROM drive 1, a read buffer 2, a demultiplexer 3, decoders 4, 5, 6, 7, plane memories 8a, 8b, 8c, an addition unit 8d, a user event processing unit 9a, and a data analysis executing unit 9b.

The BD-ROM drive 1 reads data from a BD-ROM disc in accordance with an instruction from the data analysis executing unit 9b, and stores the data into the read buffer 2. The data to be read from the BD-ROM disc may be index.bdmv, MovieObject.bdmv, PlayList information or the like, as well as AVClip.

The read buffer 2 is a buffer, achieved by a memory or the like, for temporarily storing a Source packet sequence that was read with use of the BD-ROM drive 1.

The demultiplexer 3 demultiplexes the Source packet that was read into the read buffer 2.

The decoders 4, 5, 6, 7 decode the AVClip and displays the decoded AVClip onto the screen of the display or the like.

The plane memories 8a, 8b, 8c store one screen of pixel data that is the decoding result output from the video decoder 4, the Interactive Graphics (IG) decoder 6, and the Presentation Graphics (PG) decoder 7.

The addition unit 8d combines the one screen of pixel data stored in the plane memories 8a, 8b and 8c, and outputs the combined data. This output provides a composite image where a menu is superimposed on a moving image.

The user event processing unit 9a requests the data analysis executing unit 9b to perform a process in accordance with a user operation input via the remote control. For example, a button on the remote control is pressed down by the user, the user event processing unit 9a requests the data analysis executing unit 9b to execute a command corresponding to the pressed button.

The data analysis executing unit 9b performs the operation wait control based on the Movie Object or BD-J application recorded on the BD-ROM. The data analysis executing unit 9b includes a command processor for executing navigation commands that constitute the Movie Object, a Java™ platform for executing the BD-J application, and a playback control engine. The playback control engine plays back the AVClip via the PlayList information, based on the results of executing PlayPL commands by the command processor, or based on the API call by the platform unit. In the operation wait control, the command processor repeatedly executes the PlayPL command included in the Movie Object to repeatedly read the AVClip corresponding to each piece of PlayItem information and repeatedly feeding the AVClip into the video decoder 4 through the PG decoder 7, so that the playback of the background moving image is continued. The above-mentioned navigation command and the BD-J application are executed in accordance with an operation on the remote control received by the user event processing unit 9a. With these executions, the playback of the AVClip, display switch between IG stream buttons, and the like are controlled. The video decoder 4, the audio decoder 5, the IG decoder 6, and the PG decoder 7 are also controlled. For example, when AVClip#1 and AVClip#2 should be played back seamlessly, the reset request for the decoders is not issued after AVClip#1 is played back, but instead, AVClip#2 is transferred to the decoders immediately after the playback of AVClip#1.

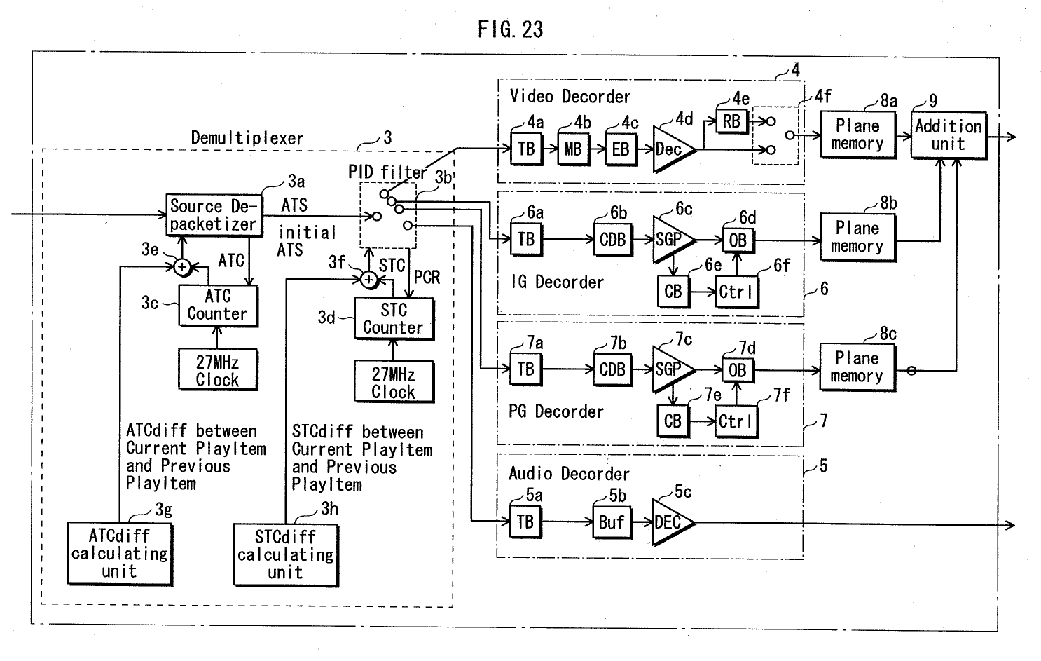

FIG. 23 shows the internal structure of the demultiplexer 3, the video decoder 4, the audio decoder 5, the IG decoder 6, and the PG decoder 7.

### <Demultiplexer 3>

As shown in FIG. 23, the demultiplexer 3 includes a source depacketizer 3a, a PID filter 3b, ATC counters 3c, 3d, addition units 3e, 3f, an ATC_diff calculating unit 3g, and an STC_diff calculating unit 3h.

The source depacketizer 3a extracts TS packets from Source packets constituting TS1 and TS2, and sends out the extracted TS packets. When sending out a TS packet, the source depacketizer 3a adjusts the time at which the TS packet is input into the decoder, in accordance with the ATS in the TS packet, where the source depacketizer 3a performs this adjustment for each TS packet to send out. More specifically, the source depacketizer 3a transfers a TS packet to the PID filter 3b at the TS_Recording_Rate only when a value of ATC generated by the ATC counter 3c is identical with a value of ATS in the Source packet.

The PID filter 3b outputs, among the Source packets output from the Source depacketizer 3a, Source packets having PID reference values written in the STN_table in the PlayItem information, to the video decoder 4, the audio decoder 5, the IG decoder 6, and the PG decoder 7. Each of the decoders receives elementary streams via the PID filter 3b, and performs the process of decoding and playing back in accordance with the PCRs in TS1 and TS2. In this way, the elementary streams input into each decoder via the PID filter 3b are decoded and played back in accordance with the PCRs in TS1 and TS2.

The ATC counter 3c is reset with use of an ATC of a Source packet which, among the Source packets constituting TS1 and TS2, is the initial one in the playback section, and then outputs ATCs to the source depacketizer 3a.

The ATC counter 3d is reset by PCRs of TS1 and TS2, and then outputs STCs.

The addition unit 3e adds a predetermined offset to an ATC (ATC value 1) generated by the ATC counter 3c, and outputs the result value to the source depacketizer 3a.

The addition unit 3f adds a predetermined offset to an ATC (ATC value 2) generated by the ATC counter 3d, and outputs the result value to the PID filter 3b.

The ATC_diff calculating unit 3g calculates and outputs an ATC_diff to the addition unit 3e when ATC sequences change. The addition unit 3e obtains an ATC value (ATC 2) of a new ATC Sequence by adding the ATC_diff to the ATC value (ATC 1) generated by the ATC counter 3c.

The STC_diff calculating unit 3h calculates and outputs an STC_diff to the addition unit 3f when STC sequences change. The addition unit 3f obtains an STC value (STC 2) of a new STC Sequence by adding the STC_diff to the current STC value (STC 1).

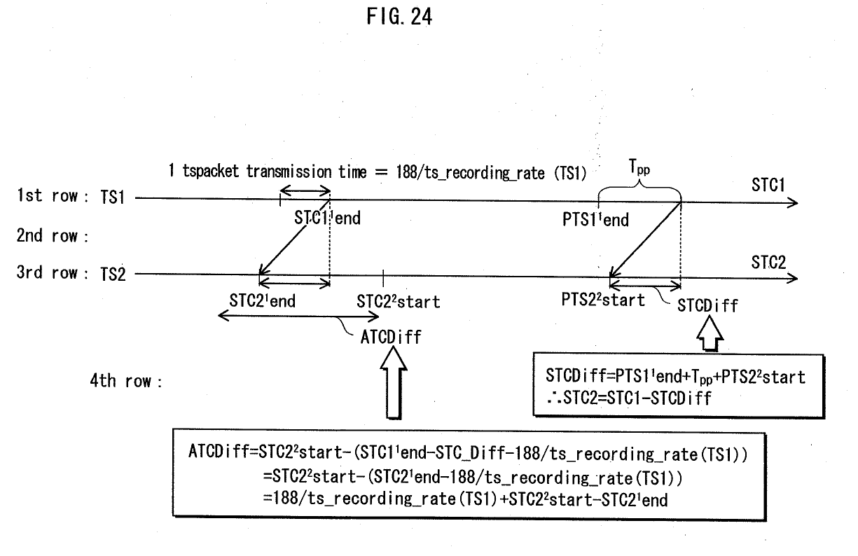

FIG. 24 shows the ATC_diff (ATCDiff) and STC_diff (STCDiff). The first row indicates the time axis of TS1. The third row indicates the time axis of TS2. TS1 includes STC1₁end and PTS1₁end shown in FIG. 21. On the other hand, TS2 includes STC2¹end and PTS2¹start. The arrows in the second row indicate copies from TS1 to TS2. More specifically, the arrow on the left-hand side of the drawing indicates that STC2¹end in TS2 is a copy point at which STC1¹end of TS1 is copied into TS2. On the other hand, the arrow on the right-hand side of the drawing indicates that PTS2¹start in TS2 is a copy point at which a time point (PTS1¹end+Tpp), at which the time has advanced by Tpp since PTS1¹end, is copied into TS2, where “Tpp” represents a gap between video frames.

The fourth row indicates an equation for calculating the ATCDiff and STCDiff.

The STCDiff is calculated based on the following equation.

STCDiff=PTS1¹end+Tpp+PTS2¹start∴STC2=STC1−STCDiff

The ATCDiff is calculated based on the following equation.

$$\begin{matrix}ATCDiff = STC {2}^{1} start - ( STC {1}^{1} end - STCDiff - \\ 188 / ts\_recording \_rate ( TSl ) ) \\ = STC {2}^{1} start - ( STC {2}^{1} end - 188 / ts\_recording \_rate ( TSL ) ) \\ = 188 / ts\_recording \_rate ( TSl ) + STC {2}^{2} start - STC {2}^{1} end\end{matrix}$$

The ATCDiff calculated in the above-described manner is added to the ATC in the playback device when TS1 and TS2 should be connected seamlessly, so that the buffer model does not break down on the time axis with the corrected ATC.

When a piece of Play Item information includes connection_condition information with CC=5 which indicates a seamless connection, the ATC_diff calculating unit 3g and the STC_diff calculating unit 3h add ATC_diff to the ATC, and add STC_diff to the STC. With this structure, when an AVClip is read by a piece of PlayItem information and when an AVClip is read by the preceding piece of PlayItem information, the count value indicated by the ATC and the count value indicated by the STC can be made continuous to each other. This makes it possible for the demultiplexer 3 and the video decoder 4 through PG decoder 7 to perform the demultiplexing process and the decoding processes seamlessly.

### <Video Decoder 4>

The video decoder 4 includes a Transport Buffer (TB) 4a, a Multiplexed Buffer (MB) 4b, a Coded Picture Buffer (CPB) 4c, a Decoder (Dec) 4d, a Re-order Buffer (RB) 4e, and a switch 4f.

The Transport Buffer (TB) 4a temporarily stores TS packets of a video stream when they are output from the PID filter 3b.

The Multiplexed Buffer (MB) 4b temporarily stores PES packets when the Transport Buffer (TB) 4a outputs a video stream to the Coded Picture Buffer (CPB) 4c.

The Coded Picture Buffer (CPB) 4c stores encoded pictures (I-pictures, B-pictures, P-pictures).

The Decoder (Dec) 4d obtains a plurality of frame images by decoding the encoded frame images contained in the video elementary stream, one at each predetermined decoding time (DTS) and writes the obtained frame images into a video plane 8a.

The Re-order Buffer (RB) 4e is used to re-order the decoded pictures, from the encoding order to the display order.

The switch 4f is used to re-order the pictures, from the encoding order to the display order.

### <Audio Decoder 5>

The audio decoder 5 includes a Transport Buffer (TB) 5a, a Buffer (Buf) 5b, and a Decoder (Dec) 5c.

The Transport Buffer (TB) 5a stores, in a first-in first-out manner, only TS packets having PIDs of audio streams to be played back, among the TS packets output from the PID filter 3b, and supplies the stored TS packets to the Decoder (Dec) 5c.

The Decoder (Dec) 5c converts the TS packets stored in the Buffer (Buf) 5b into PES packets, decodes the converted PES packets, obtains audio data in the LPCM, non-compression state, and outputs the obtained audio data. This achieves a digital output of an audio stream.

### <IG-Decoder 6>

The IG decoder 6 includes a Transport Buffer (TB) 6a, a Coded Data Buffer (CDB) 6b, a Stream Graphics Processor (SGP) 6c, an Object Buffer (OB) 6d, a Composition Buffer (CB) 6e, and a Graphics Controller (Ctrl) 6f.

The Transport Buffer (TB) 6a temporarily stores TS packets of an IG stream.

The Coded Data Buffer (CDB) 6b stores PES packets of an IG stream.

The Stream Graphics Processor (SGP) 6c decodes PES packets containing graphics data to obtain a bit map that is in a non-compression state and is composed of index colors, and writes the bit map into the Object Buffer (OB) 6d as a graphics object.

The Object Buffer (OB) 6d stores the graphics object that was obtained through decoding by the Stream Graphics Processor (SGP) 6c.

The Composition Buffer (CB) 6e is a memory in which the control information for drawing the graphics data is stored.

The Graphics Controller (Ctrl) 6f analyzes the control information stored in the Composition Buffer (CB) 6e, and performs a control based on the result of the analysis.

### <PG Decoder 7>

The PG decoder 7 includes a Transport Buffer (TB) 7a, a Coded Data Buffer (CDB) 7b, a Stream Graphics Processor (SGP) 7c, an Object Buffer (OB) 7d, a Composition Buffer (CB) 7e, and a Graphics Controller (Ctrl) 7f.

The Transport Buffer (TB) 7a temporarily stores TS packets of a PG stream when they are output from the source depacketizer 3a.

The Coded Data Buffer (CDB) 7b stores PES packets of a PG stream.

The Stream Graphics Processor (SGP) 7c decodes PES packets containing graphics data to obtain a bit map that is in a non-compression state and is composed of index colors, and writes the bit map into the Object Buffer (OB) 7d as a graphics object.

The Object Buffer (OB) 7d stores the graphics object that was obtained through decoding by the Stream Graphics Processor (SGP) 7c.

The Composition Buffer (CB) 7e is a memory in which the control information (PCS) for drawing the graphics data is stored.

The Graphics Controller (Ctrl) 7f analyzes the PCS stored in the Composition Buffer (CB) 7e, and performs a control based on the result of the analysis.

With the structure where the ATCDiff and STCDiff are added to the count values provided by the ATC counters 3c and 3d, values of the ATC Sequence in the Previous PlayItem and the ATC Sequence in the Current PlayItem are made continuous to each other, and values of the STC Sequence in the Previous PlayItem and the STC Sequence in the Current PlayItem are made continuous to each other.

Next will be described how the states of the read buffer and elementary buffer change after values of ATC and STC become continuous to each other.

### <State of Read Buffer>

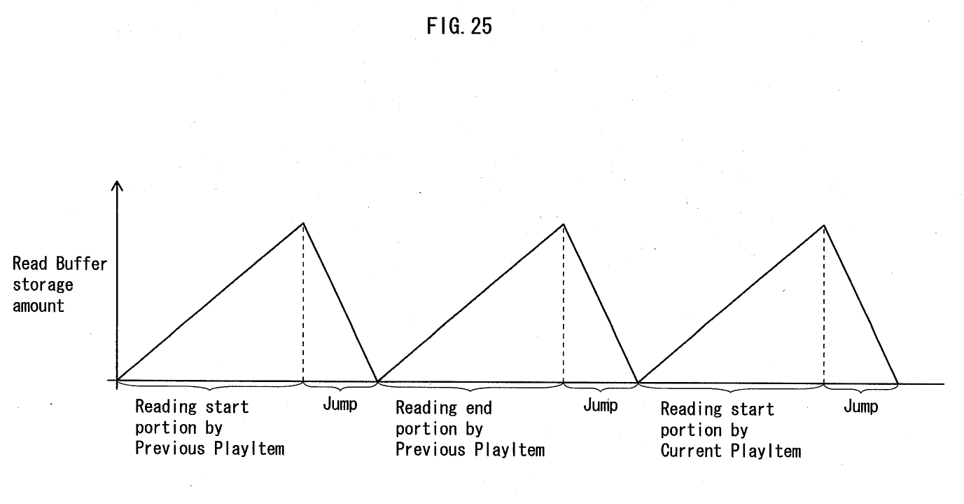

FIG. 25 shows change in the state of the read buffer. In the drawing, the horizontal axis represents a time axis, and the vertical axis represents the amount of storage at each point in time. As shown in the drawing, the amount of storage repeats a monotonic increase and a monotonic decrease, where the monotonic increase occurs while Source packets are stored into the read buffer, and the monotonic decrease occurs while Source packets are output from the read buffer. The slant of line representing the monotonic increase is determined by a difference between (a) the transfer speed (Rud) at which the AVClip is read into the read buffer and (b) the transfer speed (Rmax) at which the AVClip is output from the read buffer, namely, the amount increases by (Rud−Rmax). It should be noted here that the AVClip is read from the drive with necessary pauses so that the data buffer does not overflow.

The monotonic decrease shown in the drawing occurs when the data reading from the optical disc stops. The slant of line representing the monotonic decrease represents the transfer speed Rmax. Such a monotonic decrease occurs when an end Extent starts to be read immediately after a start Extent has been read, namely, when a jump occurs.

If the read buffer 2 does not run out of AVClip#1 data during the jump, the end Extent starts to be read, with the amount of storage increasing at the speed of (Rud−Rmax) again. With this structure, the data transfer to the decoders is not interrupted, making it possible to perform a seamless playback. That is to say, to achieve the seamless playback, a continuous data supply is required. To ensure the continuous data supply, the size of the end Extent before the jump needs to be large enough so that the data stored in the read buffer keeps to be sent to the decoders.

Next will be described the method and conditions for setting the physical disc arrangement to achieve a.seamless connection of AVClips in the BD-ROM. This will be described with reference to FIG. 25.

To connect AVClips seamlessly, the arrangement of Extents constituting each AVClip should be set so that the conditions for the seamless connection are satisfied. The Extents should be arranged so that each AVClip is connected seamlessly. For this purpose, Extents are arranged such that each Extent in each AVClip can be played back seamlessly, as an independent AVClip. At the same time, the start Extent and the end Extent in one AVClip are arranged such that the start Extent and the end Extent each can jump to the other. More specifically, the size of each of the start and end Extents is set to be equal to or larger than a predetermined minimum size. Also, the distance of a jump from one to the other is set not to exceed a maximum jump distance “Sjump_max”. For example, in the case shown in FIG. 18, the size of the first Extent of the AVClip is set to be equal to or larger than a minimum Extent size that is determined by taking into account the jump distance to the end portion. At the same time, the distance of a jump from the end portion of the second Extent to the start portion of the first Extent is set to be equal to or smaller than the maximum jump distance “Sjump_max”.

Similarly, the size of the second Extent of the AVClip is set to be equal to or larger than a minimum Extent size, and the distance of a jump from the end portion of the second Extent to the start portion is set to be equal to or smaller than the maximum jump distance “Sjump_max”.

As understood from the above description, the seamless playback can be ensured by setting the Extent length to be enough to keep the read buffer 2 from running out of data stored therein during the “Tjump”. The size of Extent that ensures the seamless playback is represented by the following equation.

(Sextent×8)/(Sextent×8/Rud+Tjump)>=Rmax (1)

In the Equation (1), “Sextent” represents the size of Extent in bytes, “Tjump” represents, in seconds, the maximum jump time in jumping from one start Extent to the next end Extent, “Rud” represents a speed at which the AVClip is read from the disc, and “Rmax” represents, in a unit of bits/second, the bit rate of the AVClip. It should be noted here that “8” is multiplied with Sextent for the purpose of byte/bit conversion. Hereinafter, the minimum value of the Extent size that ensures the seamless playback, which is calculated with use of Equation (1), is defined as the minimum Extent size.

However, since there is a limitation to the size of the read buffer 2, limited as well is the maximum jump time for the seamless playback in the state where the read buffer 2 stores data to the full. For example, when the read buffer 2 stores AVClip data to the full by reading data from the start Extent, the seamless playback is not performed since the distance to the next Extent is too large to such a extent that the buffer runs out of data before a jump to the end Extent is made and the data starts to be read therefrom. The maximum jump time that ensures the seamless playback is defined as the maximum jump time “Tjump_max”, and the maximum data size that can jump within the maximum jump time is defined as maximum jump size “Sjump_max”. The maximum jump size is determined based on a predetermined standard or the like, from the read buffer 2, bit stream, drive access speed and the like.

### <Temporal Transition of Elementary Buffer>

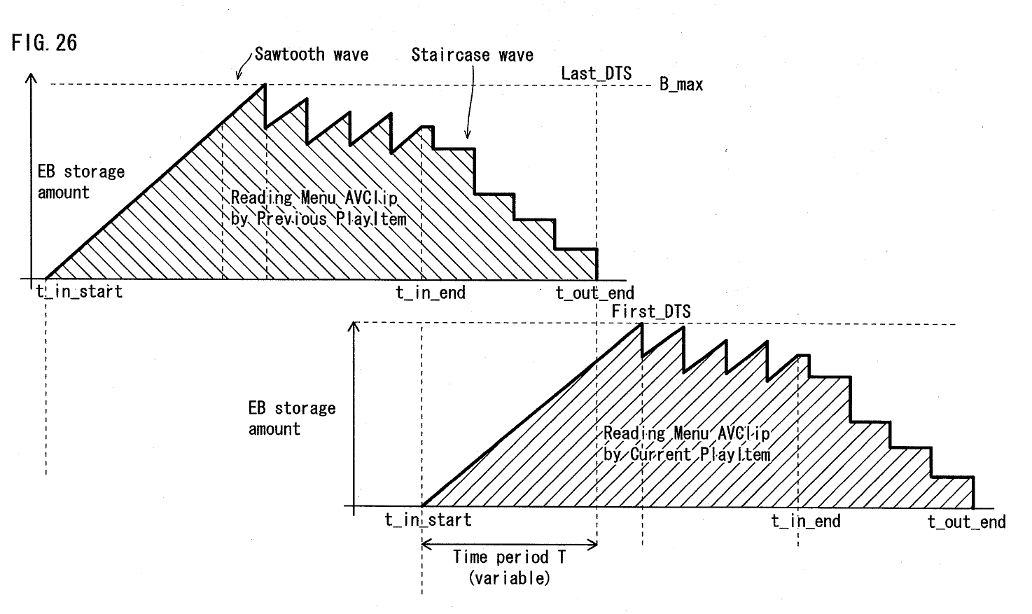

FIG. 26 shows the temporal transition of storage in the elementary buffer in the video decoder. The upper row of the drawing shows the temporal transition of the amount of storage in the elementary buffer when the stream is read during a playback by the Previous PlayItem. The lower row of the drawing shows the temporal transition of the amount of storage in the elementary buffer when the stream is read during a playback by the Current PlayItem.

The following describes how to read the graphs shown in the upper and lower rows of the drawing. The horizontal axis represents a time axis, and the vertical axis represents the amount of storage at each point in time. As shown in the drawing, the temporal transition of the amount of storage in the elementary buffer forms a sawtooth wave in the graph.

The “t_in_start” represents a time at which the input of the start picture data into the elementary buffer starts.

The “t_in_end” represents a time at which the input of the last picture data into the elementary buffer ends.

The “t_out_end” represents a time at which the output of the last picture data from the elementary buffer ends.

The “Last_DTS” represents a time at which decoding of the last picture data ends.

The “First_DTS” represents a time at which decoding of the first picture data ends.

In the time period from t_in_start to t_in_end, inputs into and outputs from the elementary buffer are performed concurrently. The sawtooth wave in this time period indicates both (a) the monotonic increase in the amount of storage in the buffer due to reading of picture data into the elementary buffer and (b) the monotonic decrease in the amount of storage in the buffer due to extraction of picture data from the elementary buffer. The slant of line indicates “Rbx1” that represents a speed of transfer to the elementary buffer.

In the time period from t_in_end to t_out_end, only outputs from the elementary buffer are performed. The staircase wave in this time period indicates the monotonic decrease in the amount of storage in the buffer due to extraction of picture data from the elementary buffer.

With the above-described structure where ATCDiff and STCDiff are added to ATC Sequence and STC Sequence, t_in_end in playback according to Previous PlayItem matches t_in_start in playback according to Current PlayItem. Also noted is presence of First DTS that follows Last DTS with one frame therebetween. Such a match might cause a buffer overflow.

That is to say, in a seamless playback of AVClips by first Previous PlayItem and then by Current PlayItem, the amount of code to be assigned to AVClip should be determined by assuming the state where some data of AVClip to be played back by Previous PlayItem still remains in the elementary buffer. That is to say, in the connection state of connection_condition=1, data creation should be started on the assumption that the buffers have no data. However, when an AVClip to be played back in connection_condition=5 is to be created, creation of AVClip to be played back by Current PlayItem should be started on the assumption that in the initial state, some data of AVClip to be played back by Previous PlayItem still remains in the elementary buffer.

In the case of AVClip for a moving image menu, the moving image menu AVClip should be created such that the decoder model does not break down, on the assumption that in the initial state, the buffer is in the state immediately after decoding of the end portion of the AVClip has been completed.

For this reason, the moving image menu AVClip is multiplexed such that a resultant value of subtracting t_in_end from t_out_end becomes equal to time period “T” in the transition of amount of video data of AVClip stored in the elementary buffer referred to by Previous PlayItem. The time period T may be varied for each AVClip, or may be set to a fixed value.

The t_in_start in AVClip for Current PlayItem is set to be close to t_in_end in AVClip for Previous PlayItem. Accordingly, the amount of code should be assigned to the time period from time period T through t_out_start so that the succeeding video dada is played back seamlessly. For example, the amount of code should be assigned so that the buffer upper-limit value “B_max” is satisfied. For such an assignment of amount of code, the input-limiting straight line is used. The input-limiting straight line is used for assigning the amount of code at a rate lower than bit rate Rbx1 with the elementary buffer.

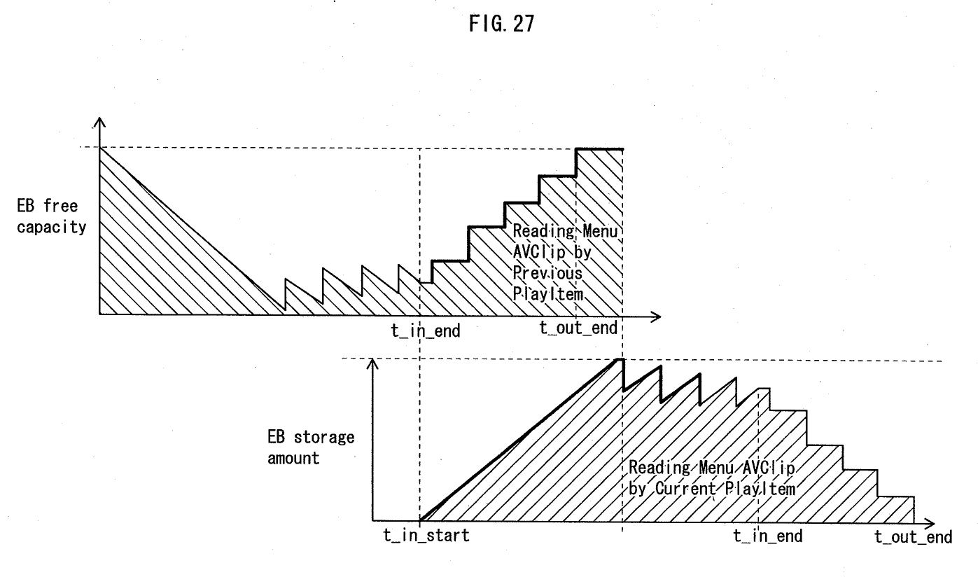

FIG. 27 shows the temporal transition of free capacity and amount of storage in the elementary buffer. The upper row of the drawing shows the temporal transition of the free capacity of the elementary buffer when the stream is read during a playback by the Previous PlayItem. The lower row of the drawing shows the temporal transition of the amount of storage in the elementary buffer when the stream is read during a playback by the Current PlayItem.

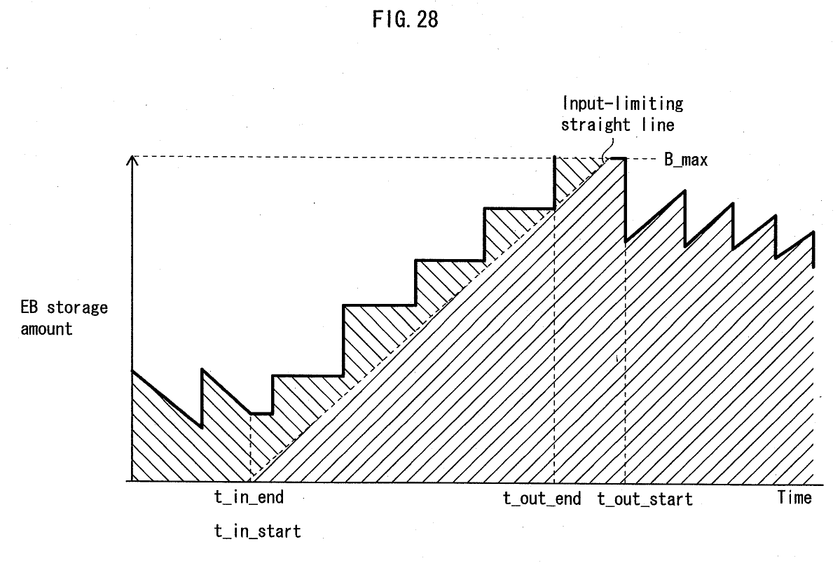

FIG. 28 shows the input-limiting straight line. The input-limiting straight line is obtained by calculating a straight line that passes the data input end time (t_in_end) and meets the sawtooth wave that indicates the buffer free capacity.

When the amount of code assigned to the start portion of the stream is equal to or smaller than the input-limiting straight line, the elementary buffer does not overflow even if data is read from the stream according to the Current PlayItem during the input period corresponding to the Previous PlayItem.

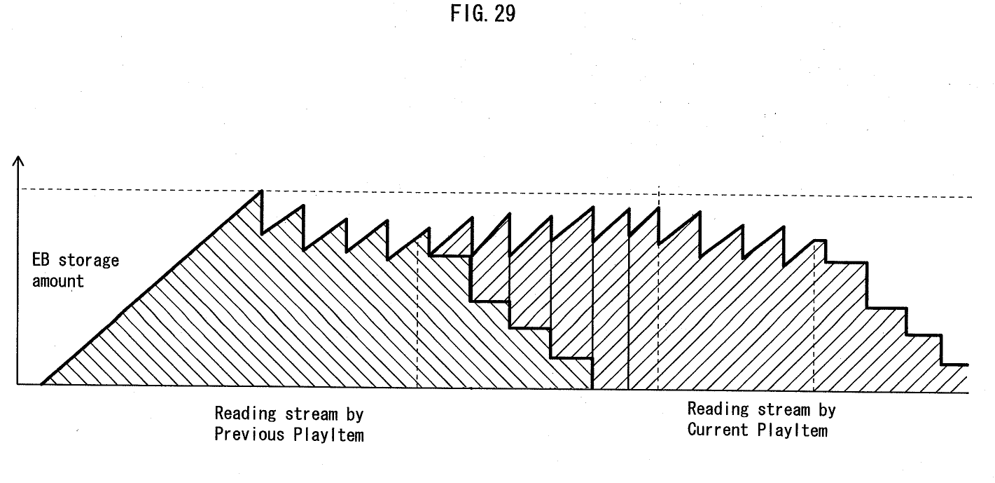

FIG. 29 shows the temporal transition of storage in the elementary buffer when t_in_end in playback according to Previous PlayItem and t_in_start in playback according to Current PlayItem are set to match each other on the same time axis. With such a match, the repetitive playback of the same AVClip according to one piece of PlayItem information is performed seamlessly.

Having been described up to now is a basic assignment of code to a video stream. However, the basic principle should be changed when it is applied to the case where an audio stream is multiplexed in the AVClip. This is because the audio stream has properties that it is smaller than the video stream in buffer size and in gap between frames. Due to such properties, the completion of audio data transfer to the buffer delays, and this delay makes the value of vbv_delay of video smaller than what it should be.

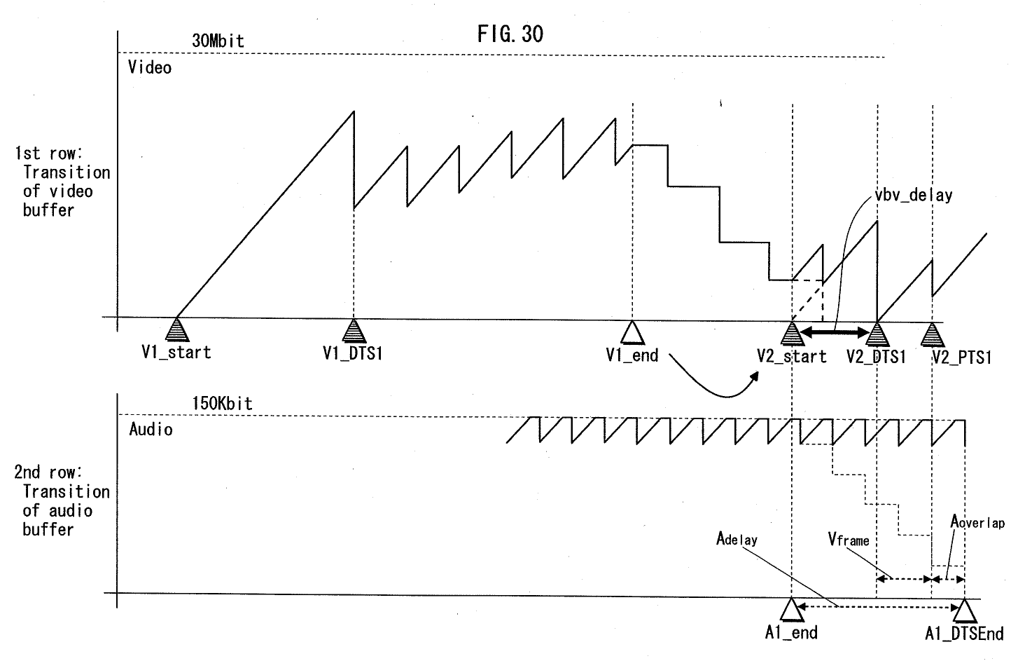

FIG. 30 shows the temporal transition of storage in the video and audio buffers, with relationships therebetween. The first row of the drawing shows the temporal transition of storage in video stream when the Previous PlayItem and Current PlayItem are continuous, and the second row shows the temporal transition of storage in audio stream when the Previous PlayItem and Current PlayItem are continuous. The first row is based on FIG. 26, but the reference signs have partially been changed. More specifically, “t_in_start” has been replaced with “V1_start”; “t_in_end” has been replaced with “V1_end”; “Last DTS” has been replaced with “V1_DTS1”; and “First DTS” has been replaced with “V2_DTS1”.

As shown in the second row that the temporal transition of audio stream storage in the elementary buffers repeats a monotonic increase and a monotonic decrease, where the monotonic increase occurs while the audio data is supplied to the elementary buffer, and the monotonic decrease occurs while the audio data is extracted from the elementary buffer. In the drawing, “A1_end” represents the time at which the audio data transfer ends. It is understood from the drawing that, due to the properties that the audio data is smaller than the video data in buffer size and in gap between frames, the end of audio data transfer (A1_end) lags far behind V1_end. Due to this delay of the end of audio data transfer to the buffer, the start of video data transfer by Current PlayItem delays to a great extent.

It is supposed here that “V2_DTS1” represents the initial decoding time by Current PlayItem, and that “V2_start” represents the time at which the transfer to the buffer by Current PlayItem starts. Then, the buffering time (vbv_delay), namely the time period from the start of transfer to the buffer to the decoding end by Current PlayItem is represented by the following equation.

vbv_{—}delay=V2_{—}DTS1−V2_{—}start

This indicates that due to the delay of the end of audio data transfer to the buffer, the value of vbv_delay in video transfer by Current PlayItem becomes smaller.

To solve this problem, a value of vbv_delay is obtained based on the audio attribute, overhead of the transport stream (TS) and the like, and the connection-destination video (in the present example, the start portion of AVClip to be played back by Current PlayItem) is encoded by using the obtained value.

The following describes how to calculate the value of vbv_delay.

(1) The audio transfer delay is obtained. The “Adelay” shown in the second row of FIG. 30 represents a specific example of the transfer delay.

Audio transfer bit rate (bps): Abitrate

Audio buffer size (bits): Abufsize

Time required for storing audio data into buffer:

Adelay=Abufsize/Abitrate

As shown in the second row of FIG. 30, a target value “VBV_delay” can be obtained by subtracting “Vframe” and “Aoverlap” from the value of “Adelay”, which are obtained as follows.

(2) The overhead in conversion into TS is obtained.

Clip#1 has a limitation to 6 KB Alignment.

This is because it is necessary to insert a Null packet of (6 KB/192)*188 at most into the end portion of Clip#1.

The start portion of Clip#1 requires a system packet of 4*188 bytes.

$$\begin{matrix}TSOverhead = ( 6 * 1024 / 192 * 188 + 4 * 188 ) / Ts\_recording \_rate \\ = 36 * 188 / Ts\_recording \_rate\end{matrix}$$

(3) The audio overlapping section is obtained. The “Aoverlap” in the second row of FIG. 30 represents the audio overlapping section. Here, the worst case is supposed. Then, the audio worst overlapping section is one (“1”) frame. Therefore, the worst overlapping section can be obtained by the following calculation.

Aoverlap=(the number of samples)/(sampling frequency)

(4) A difference “Vpts1−dts1” between the first DTS of video and PTS. The value is equivalent with one gap between video frames, and is determined by the video frame rate. The “Vrame” shown in the second row of FIG. 30 represents a specific example value of “Vpts1−dts1”.

Vpts1−dts1=1/(video frame rate)

As described above, the target value “VBV_delay” can be obtained by subtracting “Vframe” and “Aoverlap” from the value of “Adelay”. It is therefore possible to calculate VBV_delay from the following equation.

Obtain the value of:

VBV_{—}delay=Adelay−TSOverhead−Aoverlap−Vpts1−dts1

It should be noted here that when a plurality of audio are included in the TS, the above-described smallest value is applied.

Here, a value of vbv_delay will be calculated on the presumption that the following audio streams (Audio1, Audio2) respectively having the following two bit rates are multiplexed in an AVClip.

Audio1=AC3: 448 kbps, sampling frequency=48 KHZ, the number of samples: 1536

Audio2=DTS: 1509 kbps, sampling frequency=48 KHZ, the number of samples: 512

TS_recording_rate=48 Mpbs

Video Frame Rate=24 Hz

1. First of all, VBV_delay of Audio1 is as follows.

Adelay=18640*8/448000=0.3328

TSOverhead=36*188/6000000=0.0012

Aoverlap=1538/48000=0.0320

Vpts1−dts1=1/24=0.0416

VBV_Delay=0.3328−0.0012−0.0320−0.0416=0.2580

2. Secondly, VBV_delay of Audio2 is as follows.

Adelay=43972*8/1509000=0.2331

TSOverhead=36*188/6000000=0.0012

Aoverlap=1538/48000=0.0106

Vpts1−dts1=1/24=0.0416

VBV_Delay=0.233−0.0012−0.0106−0.0416=0.1796

The results of these calculations show that Audio2 is smaller than Audio1 in VBV_delay, and thus the value of VBV_delay of Audio2 is adopted for the encoding.

After vbv_delay is calculated as described above, a Source packet is obtained by attaching ATSs to the TS packets respectively storing video data and audio data such that the time (V2_DTS1_vbv_delay), which is obtained by subtracting vbv_delay from V2_DTS1, is indicated. This makes it possible to play back AVClips by Previous PlayItem and Current PlayItem.

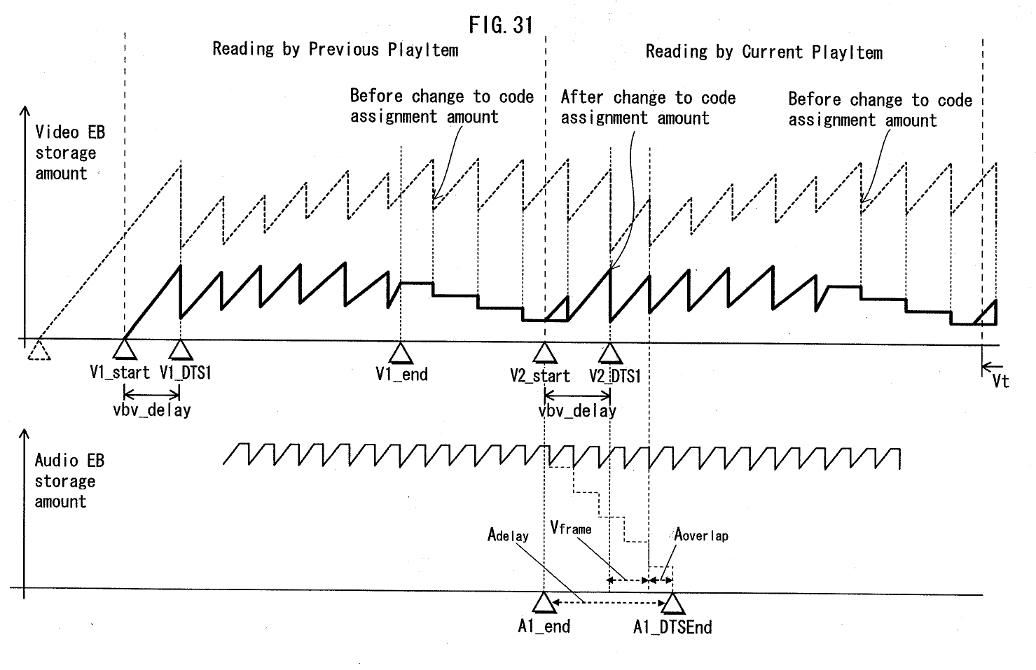

The amount of code that can be assigned to the video stream depends on the input rate of vbv_delay and the elementary buffer. Accordingly, when vbv_delay is short, it is necessary to decrease the amount of code to be assigned to the video stream. FIG. 31 shows the temporal transition of storage in the elementary buffer for video stream before and after the change to the amount of code assignment, for comparison therebetween. Originally, time points at which video is decoded or video or audio is played back should align at regular intervals (as in gaps between saw tooth waves or staircase waves). It should be noted here that these gaps are not represented at regular intervals in the drawing, for the sake of conveniences. In the drawing, the dotted line indicates the temporal transition of storage before the change to the amount of code assignment, and the solid line indicates the temporal transition of storage after the change to the amount of code assignment. The temporal transition of storage indicated by the dotted line is the same as that shown in FIG. 29.

As understood from the drawing, the temporal transition of storage is reduced as a whole since vbv_delay has been set to a small value. In this way, when a video stream is encoded, vbv_delay is adjusted by taking into account the audio input to the elementary buffer, and then based on this, the amount of code assignment is changed. Accordingly, the elementary buffer in the decoder does not break down even if one AVClip is repeatedly subjected to the decoder according to a plurality of pieces of PlayItem.

The above-provided description with reference to FIGS. 26 through 31 also indicates the achievement of “2-path encoding”. The 2-path encoding is composed of executions of the first and second paths: in the first path, the video stream is encoded using a provisional amount of code; and in the second path, the amount of code is re-calculated using the value of vbv_delay. After the execution of the first path, the value of vbv_delay is obtained so that data of both the video and audio streams can be read into the elementary buffer. Then, based on the obtained value of vbv_delay, the amount of code to be assigned to the video stream is calculated in the second path. With this structure, the buffer model in the playback device does not break down even if an AVClip for a moving image menu is repeatedly played back according to 999 pieces of PlayItem information. It is therefore possible to achieve a playback process unique to a moving image menu where an AVClip is repeatedly played back seamlessly according to 999 pieces of PlayItem information.

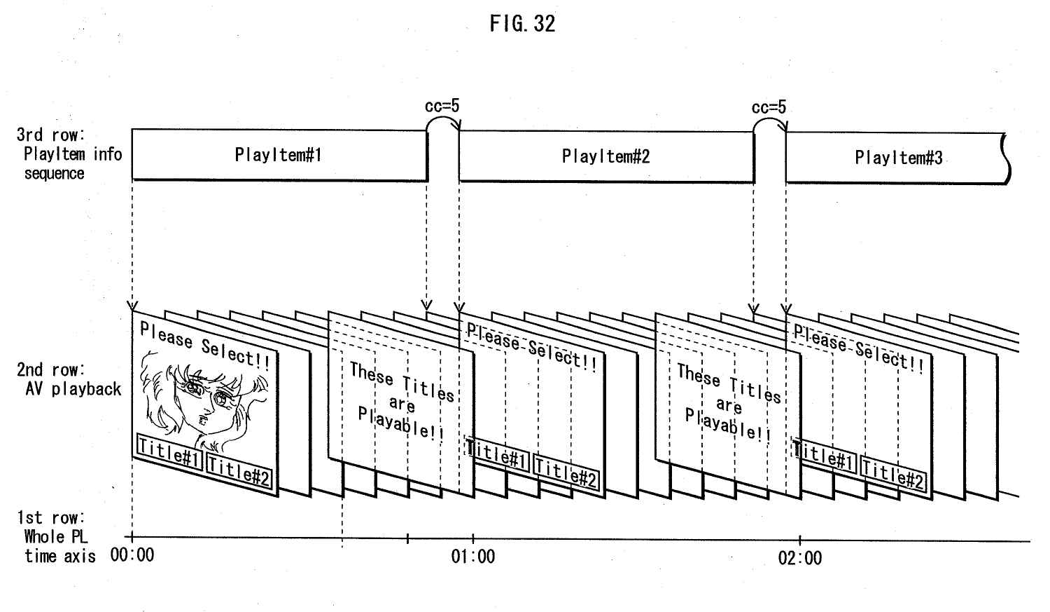

FIG. 32 shows a specific example of a moving image menu. In FIG. 32, the first row indicates a time axis covering the whole PlayList. The second row indicates a plurality of pictures to be displayed with the menu AVClip. The third row indicates the first three pieces of PlayItem information (PlayItem#1, PlayItem#2, PlayItem#3) among 999 pieces of PlayItem information constituting the PlayList information. The drawing indicates that through the time axis covering the whole PlayList, a same set of images with messages (“Please Select!!” that urges the viewer to select Title#1 or Title#2, and “These Titles Are Playable!!”) is repeatedly displayed, where the set of images is displayed once during a time period from 00:00 to 01:00, a second time during a time period from 01:00 to 02:00, and similarly thereafter.

The repetitive display is performed in accordance with a plurality of pieces of PlayItem information in the PlayList information. Further, the pictures shown in the second row of FIG. 32 is seamlessly played back since the connection_condition information is set as “connection_condition=5”, defining the connection state of the pieces of PlayItem information.

As described above, in the present embodiment, 999 pieces of PlayItem information are provided in the PlayList information, and the connection state of the pieces of PlayItem information is defined as “connection_condition=5”. With this structure, there is no occurrence of a stop of a moving image or disappearing of buttons or a subtitle while the 999 pieces of PlayItem information are executed in a circumstance where such a stoppage of a moving image or disappearing of buttons or a subtitle occurs between executions of a command instructing a playback of a digital stream and a jump command instructing to repeat executing the command. When the digital stream is, for example, one minute long, a playback of the digital stream as a moving image menu is not interrupted for 999 minutes=16.5 hours. Namely, when the jump command is executed to repeat the execution of the playback command, an interruption to the playback occurs once in 16.5 hours. This enables an input wait state to be continued for a long period in time without interruption to the playback.

Furthermore, since the continuous playback according to the present embodiment requires little increase in capacity of the recording medium, it is possible to meet the practical demand of achieving a seamless playback of a moving image menu without reducing a large capacity of the recording medium.

### Embodiment 2

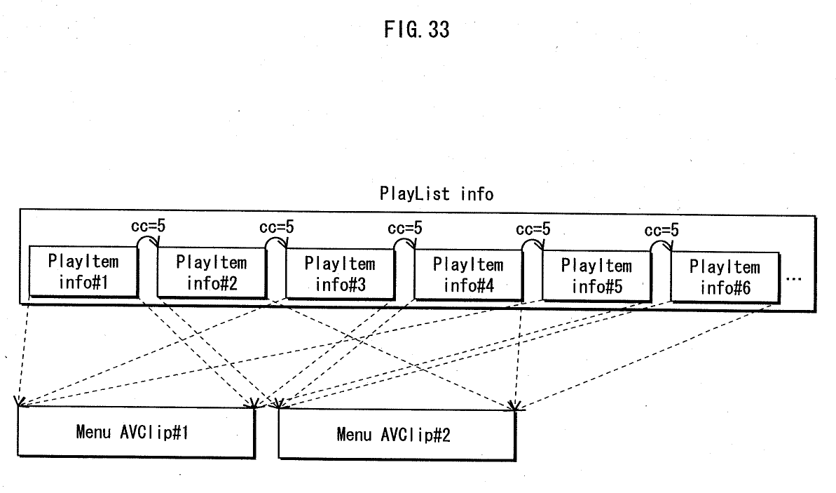

In Embodiment 1, only one AVClip is prepared as shown in FIG. 17. In Embodiment 2, two AVClips are prepared, and the PlayItem information is set such that the two AVClips are repeatedly played back. FIG. 33 shows the structure of a moving image menu in Embodiment 2. The first row from bottom indicates AVClip#1 and AVClip#2 that are AVClips for a moving image menu. The second row from bottom indicates PlayList information. As is the case with Embodiment 1, the PlayList information has 999 pieces of PlayItem information. AvClip#1 is set in PlayItem information having odd numbers in the order of arrangement of the 999 pieces (PlayItem information #1, #3, #5 in the drawing), and AVClip#2 is set in PlayItem information having even numbers (PlayItem information #2, #4, #6 in the drawing).

Such settings give versatility to the structure of AVClip, and enable the structure of AVClip to be changed in accordance with the intention of the content maker. For example, as shown in FIG. 33, it is possible to provide a combination of different AVClips such as AVClip#1→AVClip#2→AVClip#1→AVClip#2, as well as a simple playback of AVClip in loop.

### Embodiment 3

In Embodiment 1, only one AVClip is prepared as shown in FIG. 17. In Embodiment 3, three AVClips are prepared so that a moving image menu with a multi-angle section can be provided.

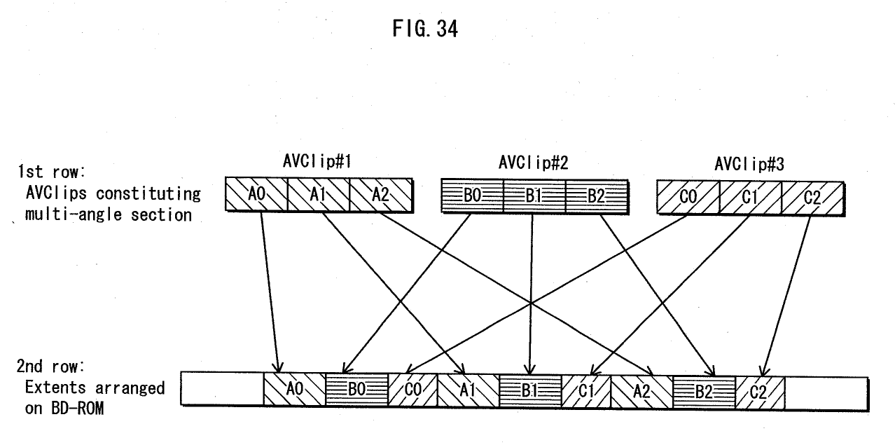

FIG. 34 shows three AVClips (AVClip#1, AVClip#2, AVClip#3) that constitute the multi-angle section. The first row of the drawing indicates the three AVClips (AVClip#1, AVClip#2, AVClip#3), and the second row indicates the Extent arrangement in the BD-ROM. As shown in the first row, AVClip#1 is composed of three Extents A0, A1 and A2, AVClip#2 is composed of three Extents B0, E1 and B2, and AVClip#3 is composed of three Extents C0, C1 and C2. As shown in the second row, these Extents are arranged on the BD-ROM in a cyclic manner: A0→B0→C0→A1→B1→C1→A2→B2→C2.

In arranging the AVClip Extents constituting the multi-angle section onto the disc, the size and the jump distance of the Extents are adjusted so that a seamless connection to the first Extent of the first AVClip of the multi-angle section is possible.

For example, in the case of FIG. 34, the position and size of the Extents are determined so that the end Extents A2, B2, and C2 of AVClip#1, AVClip#2, and AVClip#3 can jump to any of the first Extents A0, B0, and C0 of AVClip#1, AVClip#2, and AVClip#3. More specifically, all combinations of the end Extents and the first Extents are obtained, and the Extents are arranged such that any of the combinations does not exceed the maximum jump distance, and the size of each Extent is set to a value that is equal to or larger than the minimum Extent size described in Embodiment 1.

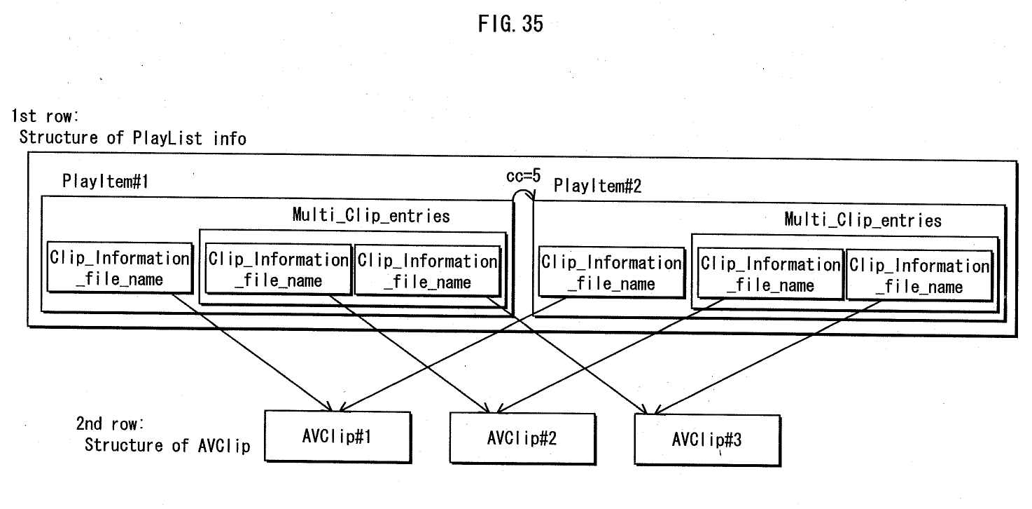

FIG. 35 shows the structure of the PlayList information for a moving image menu with a multi-angle section. As is the case with Embodiment 1, the PlayList information of the present embodiment has 999 pieces of PlayItem information. The first row indicates the first two pieces of PlayItem information (PlayItem#1, PlayItem#2) among the 999 pieces of PlayItem information. As described in Embodiment 1, the PlayItem information has one or more pieces of “Clip_Information_file_name” that indicate AVClips as destinations of settings in In_time and Out_time. The Clip_Information_file_name can uniquely specify. AVClips that corresponds to the PlayItem information. The PlayItem information has “Multi_clip entries” as well as “Clip_Information_file_name”. It is possible to specify other AVClips that constitute the multi-angle section by writing to the Clip_Information_file_name in the Multi_clip entries. In each of the two pieces of PlayItem information shown in FIG. 35, the two pieces of Clip_Information_file_name in Multi_clip_entries specify AVClip#2 and AVClip#3, and the Clip_Information file_name outside the Multi_clip_entries specifies AVClip#1. The multi-angle section is composed of a plurality of AVClips that indicate menu images respectively. When each of the AVClips constituting the multi-angle section includes an IG stream, the user can selectively play back the IG streams in the three AVClips by operating the remote control for an angle switch. This achieves a seamless switching among moving image menus.

### Embodiment 4

Embodiment 4 describes a form in which the recording device of the present invention is implemented.

The recording device described here is an authoring device and is installed in a studio for use by the authoring staff for distribution of a movie content. In the use form of the recording device of the present invention, the device is operated by the authoring staff to generate digital streams that have been compress-encoded conforming to the MPEG standard, to generate a scenario which shows how to play back the movie title, and to generate a volume image for the BD-ROM including the generated data.

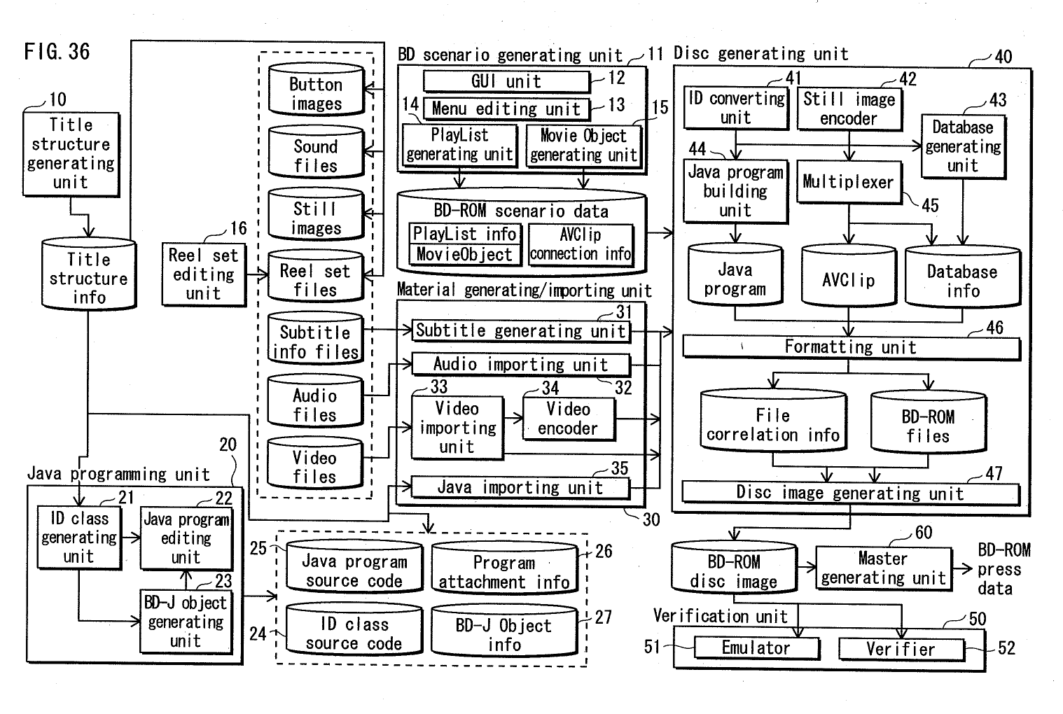

FIG. 36 shows the internal structure of the recording device of the present invention. As shown in FIG. 36, the recording device of the present invention includes a title structure generating unit 10, a BD scenario generating unit 11, a reel set editing unit 16, a Java™ programming unit 20, a material generating/importing unit 30, a disc generating unit 40, a verification unit 50, and a master generating unit 60.

Conventional recording devices for authoring have a problem that a task of editing a Java™ program and a task of generating AVClips or scenario cannot be executed in parallel. In view of this problem, the recording device of the present invention has adopted a structure where a Java™ program generating unit and a scenario generating unit are separated from each other. The structure will also be described in the following.

### 1) Title Structure Generating Unit 10

The title structure generating unit 10 determines structural elements of each title indicated by Index.bdmv. When a BD-ROM disc is generated, the title structure should be defined by using the structural elements. The title structure generated by this unit is used by the reel set editing unit 16, the BD scenario generating unit 11, the Java™ programming unit 20, and the material generating/importing unit 30. With this arrangement where the title structure is defined in the first step of the authoring process, it is possible to execute, in parallel, a plurality of tasks that use the reel set editing unit 16, the BD scenario generating unit 11, the Java™ programming unit 20, and the material generating/importing unit 30. The mechanism for executing the processes in parallel will be described later.

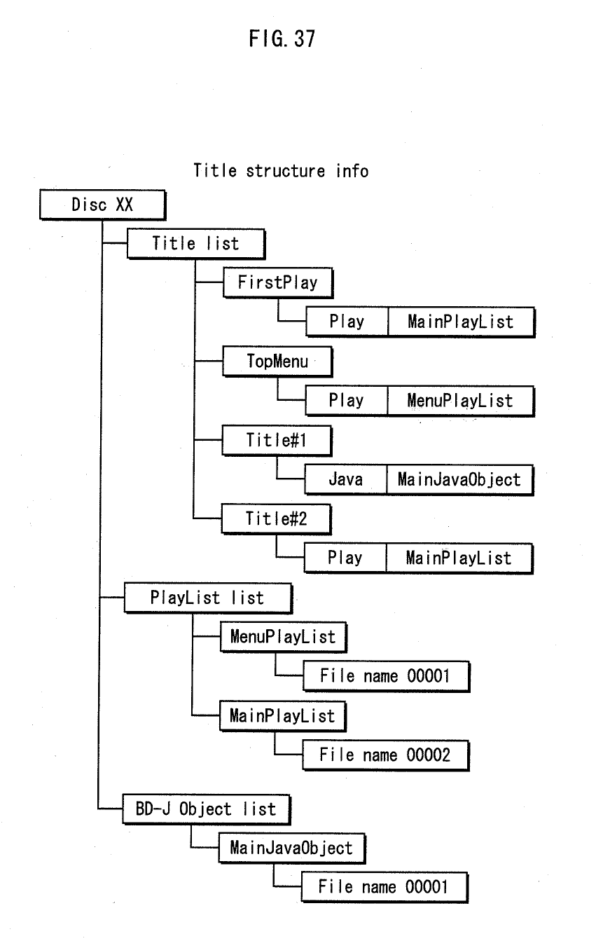

FIG. 37 shows an example of the data structure of the title structure information generated by the title structure generating unit 10. The title structure information has a tree structure. Disc name node “Disc XX”, which is the top item of the tree structure, indicates a disc name for identifying the disc. The disc name node “Disc XX” is connected to nodes “Title List”, “PlayList List”, and “BD-J Object List”.

The node “Title List” is a prototype of index.bdmv, and has thereunder nodes “FirstPlay”, “TopMenu”, “Title#1”, and “Title#2”. These are title nodes, namely, nodes corresponding to the titles recorded on the BD-ROM. The title nodes respectively correspond to the titles indicated by index.bdmv eventually. The title names (“FirstPlay”, “TopMenu”, “Title#1”, and “Title#2”) attached to the nodes are reserved words.

The title nodes respectively have thereunder nodes “Play MainPlayList”, “PlayMenuPlayList”, “MainJava™ Object”, and “Play MainPlayList”. These nodes respectively define how the titles operate, and each have a command name such as “Play”, a method name such as “Java™”, and a target being an argument.

In the case of the command “Play”, the argument indicates the name of the PlayList to be played back in the title. A PlayList identified by the name of the PlayList is defined under the node “PlayList”. When the command is “Java™”, the argument indicates the name of BD-J Object to be executed in the title. A BD-J Object identified by the name of the BD-J Object is defined under the node “BD-J Object List”.

The node “PlayList List” has thereunder nodes “MenuPlayList” and “MainPlayList”. These nodes are nodes of PlayList, and their names “MenuPlayList” and “MainPlayList” are reserved words. The nodes “MenuPlayList” and “MainPlayList” have thereunder nodes “file name 00001” and “file name 00002”, respectively. These are PlayList file nodes. In the example shown in FIG. 37, these PlayList files have been assigned with specific file names, “00001” and “00002”, which are assigned as they are stored onto the BD-ROM. It should be noted here that the PlayList information is not set by the title structure generating unit 10, but is set by the BD scenario generating unit 11.

The node “BD-J Object List” has thereunder a node “MainJava™ Object”. The name “MainJava™ Object” is a reserved word. The node “MainJava™ Object” has thereunder a node “file name 00001”. This is a node of a BD-J Object file. The specific file name “00001” is assigned as it is stored onto the BD-ROM. It should be noted here that the BD-J Object is not set by the title structure generating unit 10, but is set by the Java™ importing unit 35.

### 2) BD Scenario Generating Unit 11

The BD scenario generating unit 11 generates a scenario using the title structure information generated by the title structure generating unit 10, in accordance with an operation received from the authoring staff via the GUI, and outputs the generated scenario. The term “scenario” used here means information that that causes the playback device to perform a playback in units of titles when playing back the digital streams. For example, information “IndexTable”, “MovieObject”, and “PlayList” having been described in the embodiments are scenarios. The BD-ROM scenario data includes material information, playback path information, menu screen arrangement, and menu transition condition information, which constitute the stream. Also, the BD-ROM scenario data output from the BD scenario generating unit 11 includes a parameter that is used for achieving the multiplexing by a multiplexer 45, as will be described later. The BD scenario generating unit 11 includes a GUI unit 12, a menu editing unit 13, a PlayList generating unit 14, and a Movie Object generating unit 15.

### GUI Unit 12>

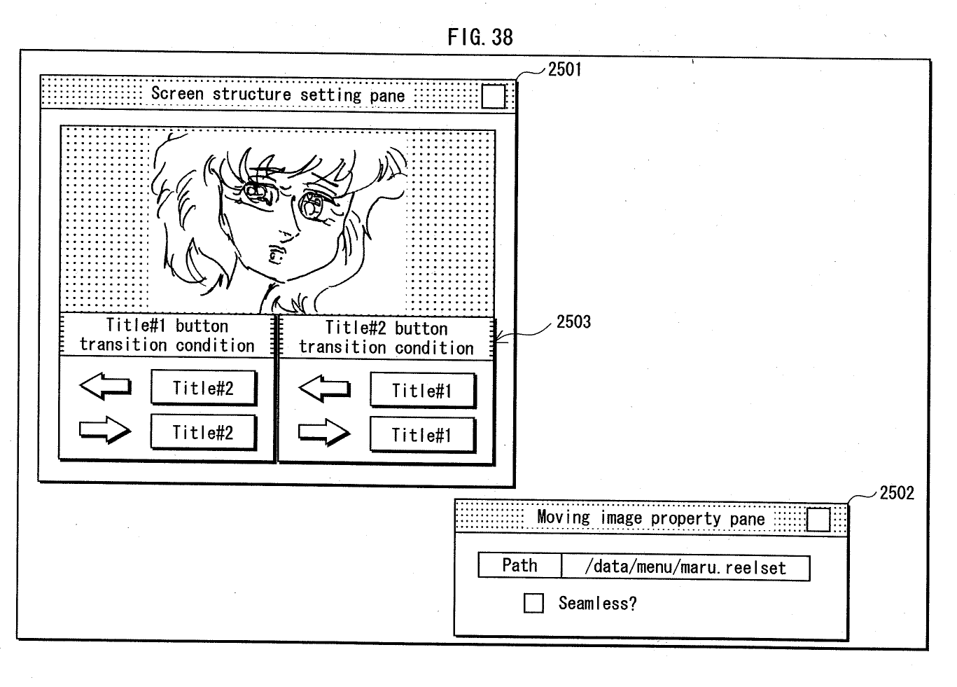

The GUI unit 12 receives operation for editing the BD scenario. FIG. 38 shows an example of the GUI screen when the menu screen structure is set. The GUI shown in FIG. 38 includes a screen structure setting pane 2501 and a moving image property pane 2502.

The screen structure setting pane 2501 is a GUI part for receiving, from the authoring staff, an operation for setting the arrangement or structure of button images on the menu. For example, the authoring staff can read a still image of a button, display the image on the screen structure setting pane 2501, and perform drag and drop operation to setting the position of the button on the screen.

The moving image property pane 2502 is provided to receive settings for a reel set file for a background moving image of the menu. More specifically, it includes a path name “data/menu/maru/maru.reelset” of the reel set file, and a check box for receiving a specification of whether or not “seamless” should be set.

A button transition condition pane 2503 is generated for each button, displays directions available with a cross-shape key on the remote control, displays transition destination buttons corresponding to specified directions, and urges the authoring staff to set transition destinations of the buttons of when transition directions are specified using the cross-shape key. For example, in the example shown in FIG. 38, buttons for receiving selections of Title#1 (Title#1 button) and Title#2 (Title#2 button) are combined with the picture. In this GUI example shown in FIG. 38, a button transition condition pane 2503 is generated for each of the Title#1 button and Title#2 button. In the button transition condition pane 2503 for the Title#1 button, the transition conditions are set such that, when the right-hand side of the cross-shape key is pressed, the button transits to Title#2, and that, when the left-hand side of the cross-shape key is pressed, the button transits to Title#2, as well.

In the button transition condition pane 2503 for the Title#2 button, the transition conditions are set such that, when the right-hand side of the cross-shape key is pressed, the button transits to Title#1, and that, when the left-hand side of the cross-shape key is pressed, the button transits to Title#1, as well.

### <Menu Editing Unit 13>

The menu editing unit 13, according to an operation received from the authoring staff via the GUI unit 12, arranges buttons constituting the IG stream and generates functions such as a button animation and a navigation command to be executed when a button is confirmed.

When generating a scenario of the data structure of the seamless moving image menu described above, the menu editing unit 13 receives a selection of an image that should be played back seamlessly as a background image of the menu.

<PlayList generating unit 14>

The PlayList generating unit 14 generates PlayList information having a play item sequence composed of 999 pieces of PlayItem information, based on the user operation received by the GUI unit 12, after having set the contents of the PlayList list of the title structure information. In doing this, the PlayList generating unit 14 generates a PlayList so as to conform to the data structure of the seamless moving image menu. Also, the PlayList generating unit 14 adjusts the number of pieces of PlayItem information so that it matches the number of AVClips, and sets the Connection_condition information in the PlayItem information. More specifically, the PlayList generating unit 14 sets the number of pieces of PlayItem information to 999, and sets the Connection_condition information to “CC=5” indicating that an AVClip and another AVClip should be played back seamlessly in accordance with a piece of PlayItem information and another piece of PlayItem information that is immediately before it. In connection with such a setting of the Connection_condition information, AVClip connection information is generated as a parameter to be used as the multiplexer 45 achieves multiplexing. Each piece of AVClip connection information has a node corresponding to an AVClip, and has items “Prev” and “Next” for the node. The nodes contained in a plurality of pieces of AVClip connection information symbolically represent, on a one-to-one basis, AVClips that are played back continuously according to the PlayItem information contained in the PlayList information. These nodes have the items “Prev” and “Next” as detailed items.

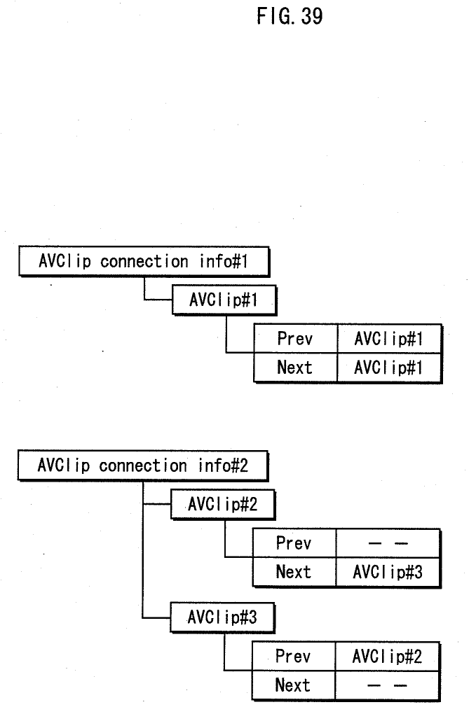

FIG. 39 shows how the AVClip connection information is described when the three AVClips shown in FIG. 32 are generated. As described above, AVClip#1 is an AVClip for a moving image menu. Accordingly, AVClip#1 is set in both the items “Prev” and “Next”. On the other hand, AVClip#2 and AVClip#3 constitute normal movie works. Therefore, for AVClip#2, “- -”, which indicates no specification, is described in the item “Prev”, and “AVClip#3” is described in the item “Next”. Also, for AVClip#3, “AVClip#2” is described in the item “Prev”, and “- -” is described in the item “Next”. The AVClip connection information is generated for each AVClip sequence referred to by the PlayList.

When the authoring staff checks the check box of the moving image property pane 2502, the items “Next” and “Prev” of the AVClip connection information are set to indicate the own AVClic as the AVClic to be connected seamlessly. That is to say, both the items “Next” and “Prev” for the seamless connection node are set to AVClic#1. With such setting, it is possible to cause the multiplexer 45 to perform the multiplexing process for the seamless moving image menu.

<Movie Object generating unit 15>

The Movie Object generating unit 15 generates a Movie Object upon receiving a program description from the authoring staff. The program description is generated as the authoring staff describes the navigation command defined in the BD-ROM standard. Especially, the Movie Object generating unit 15 causes the playback device to control the state of waiting for a user operation by describing into the BD-Jobject the Jump command that repeatedly execute the PlayPL command.

### 3) Reel Set Editing Unit 16

The reel set editing unit 16 sets the reel set based on the user operation. The reel set is a set of information that indicates relationships among a plurality of elementary streams, such as streams of video, audio, subtitle, and button, that complete themselves as a movie. By defining the reel set, it is possible, for example, to specify that one movie is composed of one piece of video, two pieces of audio, three pieces of subtitle, and one button stream. Also, the reel set editing unit 16 has a function to specify a director's cut that is different from the original version of a movie only in part, and a function to set a multi-angle to have a plurality of angles. The reel set file output from the reel set editing unit 16 is a set of the above-described information.

4) Java™ programming unit 20

The Java™ programming unit 20 includes an ID class generating unit 21, a Java™ program editing unit 22, and a BD-J object generating unit 23.

### <ID Class Generating Unit 21>

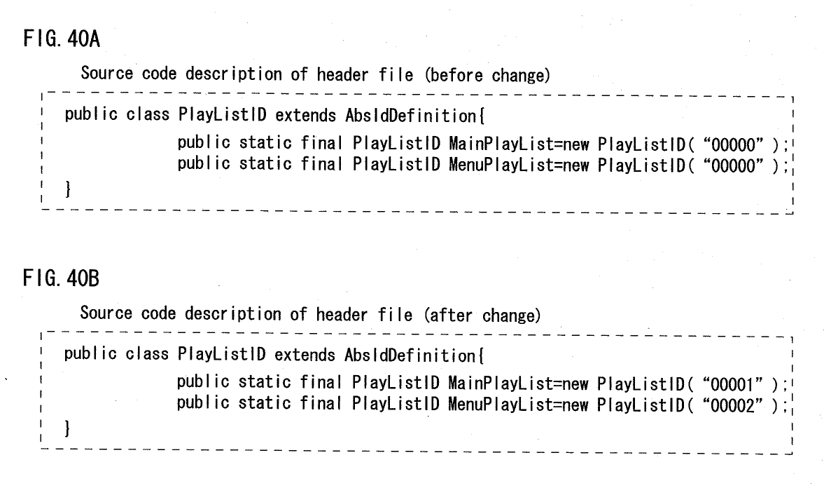

The ID class generating unit 21 generates an ID class source code using the title structure information generated by the title structure generating unit 10. The ID class source code is a source code of a Java™ class library with which a Java™ program accesses the Index.bdmvor the PlayList information that are finally created on the disc. A Java™ class library obtained by compiling the ID class source is referred to as an ID class library. FIG. 40A shows an example of a source code of a header file for accessing the PlayList of the ID class source code. The class PlayListID has been designed and implemented such that it has a constructor that read a predetermined PlayList file from the disc by specifying the PlayList number, and an AVClip or the like can be played back by using an instance generated by executing the constructor. As is the case with MainPlaylist or MenuPlaylist shown in FIG. 40A, the ID class generating unit 21 defines the variable name of the ID class library using the PlayList node name defined by the title structure information. In this definition, a dummy number is set as a PlayList number. The PlayList number is converted into a correct value by an ID converting unit 41, which will be described later.

<Java™ program editing unit 22>

The Java™ program editing unit 22 generates a Java™ program source code by direct editing of a Java™ source code of a Java™ program via a keyboard input such as a text editor, and outputs the generated Java™ program source code. The ID class library is used to describe, among the Java™ program generated by the Java™ program editing unit 22, a method portion for accessing the information defined by the BD scenario generating unit 11. For example, when it is to access a PlayList using the ID class library shown in FIG. 40A, the Java™ program uses MainPlayList and MenuPlayList that are variables defined by the ID class library. The information, such as the font file, still images, and audio, used by the Java™ program source code is output as the program attachment information. The Java™ program editing unit 22 may be a means for enabling the authoring staff to generate a program via the GUI or the like using a Java™ program template that has been prepared in advance. The Java™ program editing unit 22 may take any form in so far as it can generate a Java™ program source code.

### <BD-J Object Generating Unit 23>

The BD-J Object generating unit 23 generates a BD-J Object based on the Java™ program source code generated by the Java™ program editing unit 22 and the ID class source code generated by the ID class generating unit 21, where the generated BD-J Object is used to generate a data format of the BD-J Object defined by the BD-ROM. The BD-J Object needs to specify the name of a PlayList played back by the executed Java™ program. However, at this point in time, a variable name defined by the ID class library is set based on the ID class source code.

### 5) Material Generating/Importing Unit 30

The material generating/importing unit 30 includes a subtitle generating unit 31, an audio importing unit 32, a video importing unit 33, and a Java™ importing unit 35. The material generating/importing unit 30 converts the received video material, audio material, subtitle material, Java™ program source code and the like into a video stream, audio stream, subtitle stream, Java™ program source code and the like that conform to the BD-ROM standard, and sends them to the disc generating unit 40.

### <Subtitle Generating Unit 31>

The subtitle generating unit 31 generates subtitle data that conforms to the BD-ROM standard, based on the subtitle and the display timing, and a subtitle information file that includes effects for the subtitle such as fade in/fade out, and outputs the generated subtitle data.

### <Audio Importing Unit 32>

The audio importing unit 32, upon receiving audio data that has been compressed in advance by MPEG-AC3 or the like, outputs the data after attaching thereto timing information for timing with the corresponding video and/or deleting unnecessary data therefrom and/or performing thereto other necessary operation; and upon receiving audio data that has not been compressed, outputs the data after converting it into a format specified by the authoring staff.

### <Video Importing Unit 33>

The video importing unit 33, upon receiving a non-compressed video file that has not been compressed, imports the video file to the video encoder; and upon receiving a video stream that has been compressed in advance by MPEG2, MPEG4-AVC, VC1, or the like, outputs the data after deleting unnecessary data therefrom and/or performing thereto other necessary operation.

### <Video Encoder 34>

The video encoder 34 calculates an amount of code to be assigned, in accordance with a parameter specified by the authoring staff, compresses the input video file to obtain a compressed sequence of encoded data, and outputs the obtained compressed sequence of encoded data as the video stream. When it constitutes an AVClip for the moving image menu, the video encoder 34 derives the input-limiting straight line and vbv_delay from the buffer free capacity in the state where the end portion of the video stream exists in the buffer in the decoder. The process of this derivation is a process of the 2-path encoding as described in Embodiment 1, as shown in FIGS. 26 through 34. And the video encoder 34 determines the amount of code to be assigned to the start portion of the AVClip, based on the derived input-limiting straight line and vbv_delay. The video encoder 34 performs encoding after determining the amount of code to be assigned.

### <Java™ Importing Unit 35>

The Java™ importing unit 35 transfers, to the disc generating unit 40, the Java™ program source code, program attachment information, ID class source code, and BD-J Object generation information generated by the Java™ programming unit 20. The Java™ importing unit 35, using the title structure information, correlates BD-J Objects with the files of the Java™ program source code, program attachment information, ID class source code, and BD-J Object generation information, which are to be imported, and generates BD-J Object information for the BD-J Object node in the title structure information.

### 6) Disc Generating Unit 40

The disc generating unit 40 includes an ID converting unit 41, a still image encoder 42, a database generating unit 43, a Java™ program building unit 44, a multiplexer 45, a formatting unit 46, and a disc image generating unit 47.

It should be noted here that the “database” is a generic name of the above-described Index.bdmv, PlayList, BD-J Object, and the like defined by the BD-ROM. The disc generating unit 40 generates scenario data conforming to the BD-ROM, based on the input BD-ROM scenario data and the BD-J Object information transferred from the ID converting unit 41.

### <ID Converting Unit 41>

The ID converting unit 41 converts the ID class source code transferred from the Java™ importing unit 35 to the disc generating unit 40 such that it matches the actual title number and the PlayList number recorded on the disc. For example, in the case of the example shown in FIG. 40, the ID converting unit 41 automatically changes the PlayList number that is specified for generating MenuPlaylist and MainPlaylist. It makes this conversion by referring to the PlayList node in the title structure information. In FIG. 40A, the final file names of MenuPlaylist and MainPlaylist are 00001 and 00002, respectively. Accordingly, they are changed as shown in FIG. 40B. The BD-J Object information is similarly subjected to the conversion process. The conversion process is performed such that the PlayList name defined in the BD-J Object matches the actual PlayList number on the disc. The conversion method is the same as that for the ID class source code, and the converted BD-J Object information is sent to the database generating unit.

### <Still Image Encoder 42>

The still image encoder 42, when the input BD-ROM scenario data includes a still image or a location in which a still image is held, selects a corresponding still image from still images included in the input material, and converts the selected still image into one of formats MPEG2, MPEG4-AVC, and VC1 which conform to the BD-ROM.

### <Java™ Program Building Unit 44>

The Java™ program building unit 44 compiles an ID class source code that has been converted by the ID converting unit 41, compiles a Java™ program source code, and outputs Java™ programs.

### <Multiplexer 45>

The multiplexer 45 multiplexes a plurality of elementary streams, such as streams of video, audio, subtitle, and button, that are written in the BD-ROM scenario data to obtain AVClips in the MPEG2-TS format. The multiplexer 45 obtains, based on the multiplexing parameters, information indicating inter-connection relationships among AVClips.

The multiplexer 45 outputs Clip information, information concerning an AVClip, at the same time as outputting the AVClip. The Clip information is management information that is provided for each AVClip. In other words, the Clip information is digital stream management information or a kind of database, and includes EP_map and AVClip encoding information. The multiplexer 45 generates Clip information as follows. First, the multiplexer 45 generates EP_map when an AVClip is newly generated. More specifically, the multiplexer 45 detects locations of I-pictures when a digital stream generated for the BD-ROM contains an MPEG2 or VC1 video elementary stream, and the multiplexer 45 detects locations of I-pictures or IDR pictures when a digital stream generated for the BD-ROM contains an MPEG4-AVC video elementary stream. The multiplexer 45 then generates information indicating, for each of the pictures whose locations have been detected, correspondence between the display time of a picture and a position of a TS packet containing the initial data of the picture in a sequence of TS packets constituting a MPEG2-TS AVClip. The generates the Clip information by pairing EP_map with attribute information, where the EP_map is generated by the multiplexer 45 itself, and the attribute information indicates an audio attribute, video attribute and the like for each digital stream detected from the reel set file.

The multiplexer 45 generates EP_map because EP_map is information that is closely related to the AVClip in MPEG2-TS format output from the multiplexer. An other reason is as follows. An AVClip generated for use in BD-ROM may become very large in the file size. In that case, after generating an AVClip of a large size, EP_map corresponding thereto should be generated, and for doing this, the large-size AVClip should be read again. This increases the time required for generating the EP_map. On the other hand, when EP_map is generated in parallel with the generation of AVClip, the time required for generating EP_map can be reduced since there is no need to read such a large-size AVClip twice.

Also, the multiplexer 45 changes multiplexing methods depending on the parameter dedicated to the multiplexer 45 that is included in the BD-ROM scenario data. For example, when the parameter has been set such that an AVClip to be referred to by Previous PlayItem being the target of multiplexing should be connected seamlessly with an AVClip to be referred to by Current PlayItem, the AVClip to be referred to by Current PlayItem is multiplexed by using, as the initial value, the buffer state after the AVClip to be referred to by Previous PlayItem is decoded. This is done to prevent the buffer model from breaking down, as described earlier. When one AVClip is played back according to 999 pieces of PlayItem information, multiplexing of the AVClip to connect the 999 pieces of PlayItem information seamlessly is performed.

This multiplexing of AVClip is performed by adjusting the ATS values to be attached to each of Source packets constituting the AVClip, where the ATS values are adjusted so that, after an AVClip is transferred to the elementary buffer according to Previous PlayItem, reading of the same AVClip into the elementary buffer according to Current PlayItem by using the buffer state immediately after the transfer by Previous PlayItem as the initial state can be performed successfully without being affected by the initial state of the elementary buffer.

### <Formatting Unit 46>

The formatting unit 46 receives aforesaid database, AVClip, and Java™ program, and arranges the files in a data structure adapted to the BD-ROM format. The formatting unit 46 generates the directory structure shown in FIG. 2, and places the files at appropriate positions in the structure. In doing this, the formatting unit 46 correlates the AVClip with the Java™ program, and generates file correlation information.

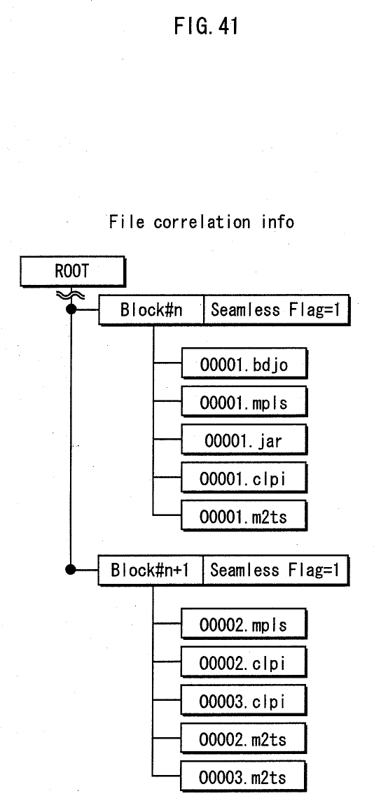

FIG. 41 shows the file correlation information. As shown in FIG. 41, the file correlation information includes one or more modes respectively corresponding to one or more blocks. Each node can specify files to be read out as a group. Also, each node has a seamless flag specifying whether or not files should be read out seamlessly. The specific example shown in FIG. 41 presumes that the files shown in FIG. 2 are to be read out. In FIG. 41, the node corresponding to Block#n specifies, as the files to be readout as a group, “00001.bdjo”, “00001.mpls”, “00001.jar”, “00001.clpi”, and “00001.m2ts”.

Also, in FIG. 41, the node corresponding to Block#n+1 specifies, as the files to be read out as a group, “00002.mpls”, “00003.mpls”, “00002.clpi”, “00003.clpi”, “00002.m2ts”, and “00003. m2ts”. In the example shown in FIG. 41, Block#n specifies files that are arranged in an order in which the files are read out from the disc for the execution of “00001.bdjo” (a BD-J Object).

### <Disc Image Generating Unit 47>

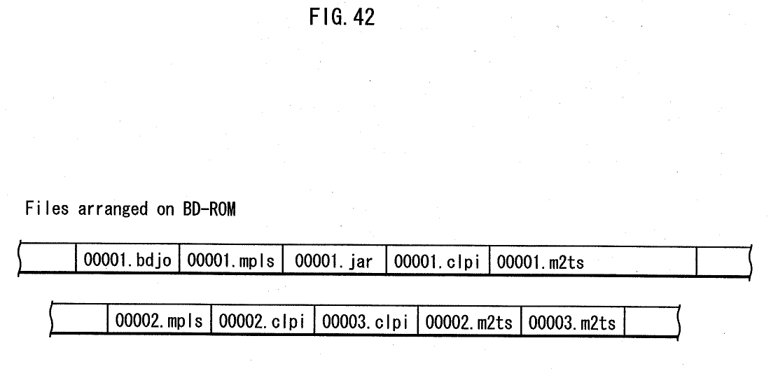

The disc image generating unit 47 receives aforesaid database and AVClip, and obtains a volume image by assignment to addresses conforming to the BD-ROM format. A BD-ROM-adapted format has already been described with reference to FIG. 2. To generate its volume image, the file correlation information generated by the formatting unit 46 is used. The disc image generating unit 47 arranges the blocks in the ascending order, and arranges the files in each block so as to be physically continuous. For example, the blocks and files shown in FIG. 41 are arranged as shown in FIG. 42.

FIG. 42 shows an allocation on the BD-ROM based on the file correlation information shown in FIG. 41. As shown in FIG. 42, “00001.bdjo”, “00001.mpls”, “00001.jar”, “00001.clpi”, and “00001.m2ts” belonging to Block#n are arranged in continuous areas on the BD-ROM. Also, “00002.mpls”, “00003.mpls”, “00002.clpi”, “00003.clpi”, “00002.m2ts”, and “00003.m2ts” belonging to Block#n+1 are arranged in continuous areas on the BD-ROM.

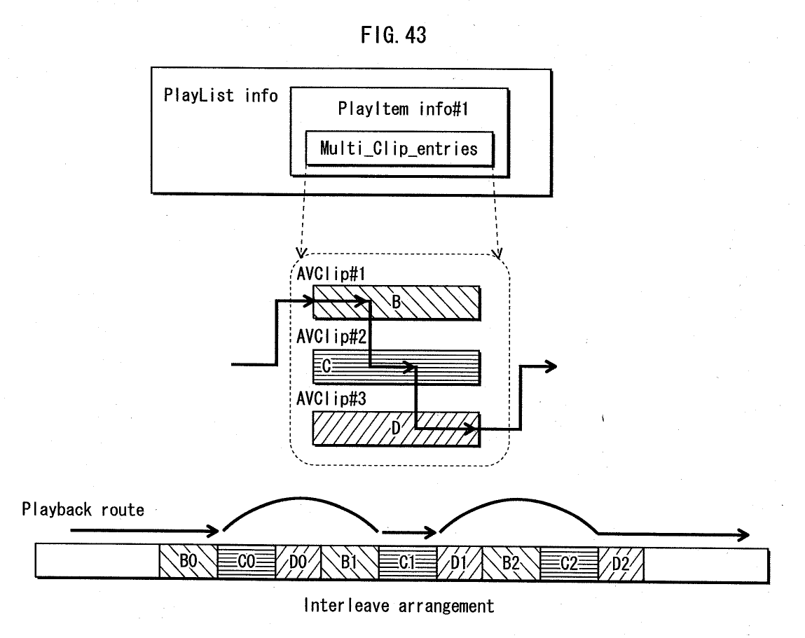

By arranging the files necessary for a playback to be continuous physically, as described above, it is possible to read the files from the disc efficiently during the playback. Further, in the example shown in FIG. 41, the seamless flag is ON in both Block#n and Block#n+1. In this case, to arrange the AVClips seamlessly, the allocation of the AVClips on the BD-ROM is determined so that some conditions for the above-described physical arrangement for seamless playback, such as the minimum Extent size or the maximum jump distance, are satisfied. Here, as an option, a multi-angle flag may be added to the blocks in the file correlation information. To achieve this, the disc image generating unit 47 arranges the AVClips on the disc by interleaving so that the AVClips can be switched in response to a request from the authoring staff to switch angles. Here, the interleaving means that each AVClip is divided into Extents as appropriate units, and the Extents of each AVClip are arranged by rotation on the disc. One example of the interleave arrangement is shown in FIG. 43.

### 7) Verification Unit 50

The verification unit 50 includes an emulator unit 51 and a verifier unit 52.

The emulator unit 51 receives the above-described volume image, and plays back an actual movie content to verify whether or not it operates in accordance with the intention of the creator, for example, whether or not a transition from the menu to an actual movie content is performed correctly, whether or not a subtitle switch and an audio switch operate as intended, and whether or not the image quality and the audio quality are provided as intended.

The verifier unit 52 receives the above-described volume image, and verifies whether or not the generated data conforms to the BD-ROM standard.

In this way, the volume image is verified by the emulator unit 51 and the verifier unit 52, and if an error is found, the work goes back to a corresponding process to be repeated.

### 8) Master Generating Unit 60

The master generating unit 60 writes the AVClip, PlayList information, and BD-J Object onto the optical disc. The master generating unit 60 generates a master of the BD-ROM disc by completing the data for pressing after the above-described internal verification process, and performing the press process. Such a press process is only one example of a method for writing an optical disc. In regards with rewritable recording mediums such as BD-RE and AVC-HD, the AVClip, PlayList information, and BD-J Object may be sent to the drive device so as to be written onto the disc.

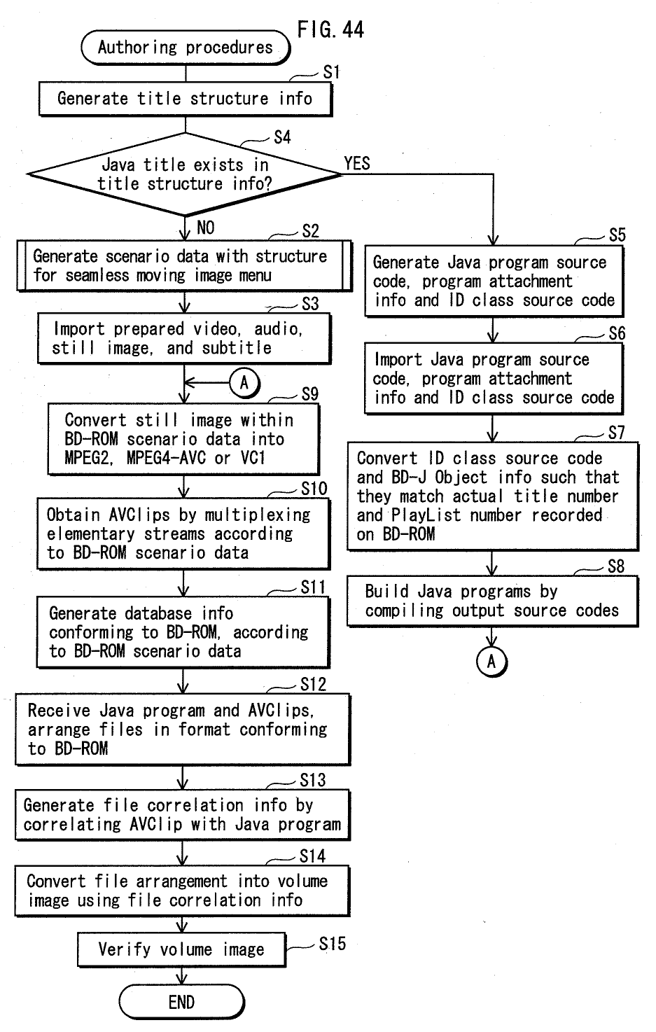

Next, authoring procedures performed in the recording device of the present embodiment will be described with reference to FIG. 44.

In step S1, the title structure generating unit 10 generates the title structure information of the BD-ROM based on the user operation. The title structure information is generated in this step.

In step S2, the BD scenario generating unit 11 generates scenario data with a structure of a seamless moving image menu, based on a user operation. With this generation, PlayList information for the seamless moving image menu is generated in the BD-ROM scenario data.

In step S3, the material generating/importing unit 30 imports, to the disc generating unit 40, the video, audio, still image, and subtitle prepared by the authoring staff.

In step S4, it is judged whether or not a Java™ title exists in the title structure information. When it is judged that a Java™ title exists, steps S2 through S3 and steps S5 through S8 are executed in parallel; and when it is judged that a Java™ title does not exist, steps S2 through S3 are executed without executing steps S5 through S8. The control then goes to step S9.

In step S5, the Java™ programming unit 20 generates a Java™ program source code, program attachment information, and ID class source code for a Java™ title, based on a user operation.

In step S6, the Java™ importing unit 35 imports the Java™ program source code, program attachment information, and ID class source code generated in step S5 to the disc generating unit 40. Steps S5 and S6 are performed in parallel with steps S2 and S3 in which scenario data is generated and the materials are generated and imported, respectively.

In step S7, the ID converting unit 41 converts the ID class source code and BD-J Object information such that they match the actual title number and the PlayList number recorded on the disc. With the conversion process, steps S5 and S6 can be processed in parallel with step S2 independently therefrom.

In step S8, the Java™ program building unit 44 builds Java™ programs by compiling the source codes that are output in step S6.

In step S9, the still image encoder 42 converts a still image within the BD-ROM scenario data into one of formats MPEG2, MPEG4-AVC, and VC1 which conform to the BD-ROM. When the BD-ROM scenario data includes a location in which a still image is held, the still image encoder 42 reads still image data from the holding location and performs the conversion.

In step S10, the multiplexer 45 generates AVClips in the MPEG2-TS format by multiplexing a plurality of elementary streams according to the BD-ROM scenario data.

In step S11, the database generating unit 43 generates, in accordance with the BD-ROM scenario data, database information conforming to the BD-ROM.

In step S12, the formatting unit 46 receives the Java™ program generated in step S8, the AVClips generated in step S10, and the database information generated in step S11, and arranges the files in a format conforming to the BD-ROM.

In step S13, the formatting unit 46 generates the file correlation information by correlating the AVClip with the Java™ program.

In step S14, the disc image generating unit 47 converts the files generated in step S11 into a volume image conforming to the BD-ROM format.

In step S15, the verification unit 50 verifies the disc image generated in step S13. If an error is found, the work goes back to a corresponding process to be repeated.

Up to now, the recording procedures in the present embodiment have been explained.

Next, procedures for generating scenario data having a moving image menu will be explained with reference to the drawings.

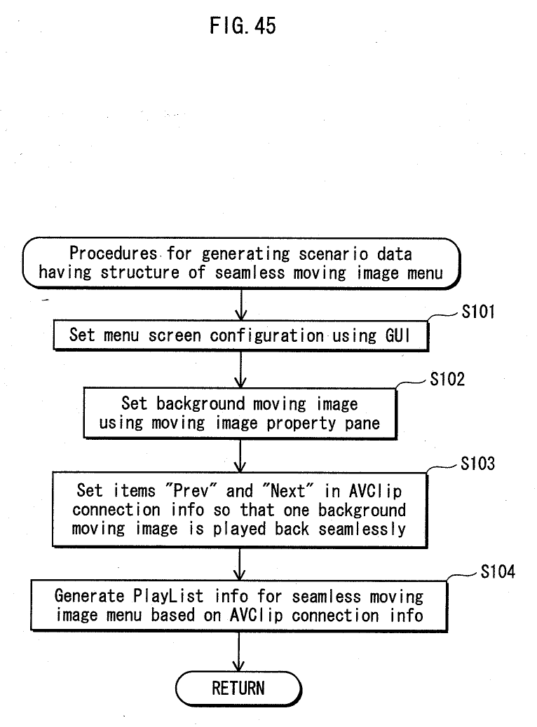

FIG. 45 shows procedures for generating scenario data having a structure of a seamless moving image menu. The procedures will be described.

In step S101, the authoring staff sets a menu screen configuration using a GUI as shown in FIG. 29 and the GUI unit 12.

In step S102, the authoring staff sets the background moving image constituting the menu, using the moving image property pane 2502.

In step S103, the authoring staff sets the items “Prev” and “Next” in the AVClip connection information so that one background moving image is played back seamlessly.

In step S104, the PlayList information for the seamless moving image menu is generated based on the AVClip connection information.

As described above, the present embodiment enables a BD-ROM disc, on which an AVClip for a moving image menu is recorded, to be generated with use of a recording device, making it possible to supply copies of a movie work that has been improved in operability by the moving image menu, in large volumes and at high speeds.

### Embodiment 5

According to the data structure of the moving image menu described in Embodiment 1, any playback device conforming to the BD-ROM application layer standard can play back the moving image menu seamlessly. The present embodiment relates to the internal structure of the playback device that is improved such that the seamless playback is performed even if AVClips are not generated by the procedures described in Embodiment 1.

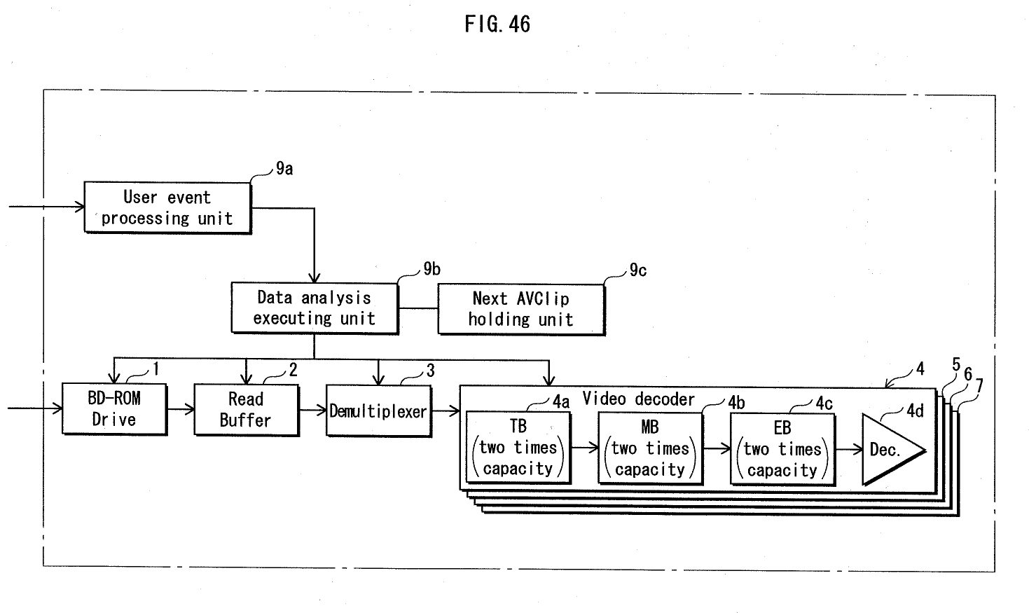

The structure of the playback device in the present embodiment will be described with reference to FIG. 46. The playback device shown in FIG. 46 is different from the playback device 200 shown in FIG. 23, in the following points.

That is to say, the buffer capacity in the decoder 4 has been changed, a next AVClip holding unit 9c has been added, and the data analysis executing unit 9b performs a process unique to the present embodiment.

First, the buffer capacity in the decoder 4 will be described.

The decoder 4 has buffer capacities that are respectively twice as the maximum buffer sizes of Transport Buffer, Multiplexed Buffer, and Elementary Buffer defined in the decoder model of the standard. With this structure, even if a video stream exists doubly in Transport Buffer, Multiplexed Buffer, and Elementary Buffer, the input amount of data does not exceed the capacity of any of Transport Buffer, Multiplexed Buffer, and Elementary Buffer defined in the decoder model. As a result, this structure prevents data from overflowing from the buffers, thereby preventing a breakdown.

Next, the next AVClip holding unit 9c, a new addition, will be described.

The next AVClip holding unit 9c holds a piece of Clip information corresponding to an AVClip to be played back next.

Up to now, the next AVClip holding unit 9c has been described. Next, improvement contained in the next AVClip holding unit 9c in the present embodiment will be described.

The data analysis executing unit 9b, when analyzing a Movie Object, specifies an AVClip to be played back, obtains a piece of Clip information corresponding to an AVClip to be played back next, and stores the obtained Clip information into the next AVClip holding unit 9c. For example, in the case of the BD-ROM having the data structure shown in FIG. 16, MovieObject#1 has commands (1) PlayPL PlayList#1; and (2) Jump Movieobject#1. Here, the PlayPL PlayList#1 has an instruction to play back only one AVClip. However, the data analysis executing unit 9b analyzes the next command. With this analysis, the contents of MovieObject#1 executed by (2) Jump MovieObject#1 are recognized. From the analysis results, the data analysis executing unit 9b identifies an AVClip to be played back and identifies the positions at which the AVClip starts and ends being played back. The data analysis executing unit 9b stores the information into the next AVClip holding unit 9c.

After this, the data analysis executing unit 9b performs a playback by controlling the BD-ROM drive 1 so that an AVClip held by the next AVClip holding unit 9c starts to be transferred into the decoder 4 immediately after a currently played back AVClip is input into the decoder 4.

With the above-described structure where a command analysis is done before the playback of an AVClip, and the buffer capacity in the decoder is twice the value defined in the standard, it is possible to seamlessly play back a BD-ROM even if the BD-ROM has not been set for a seamless playback.

### Embodiment 6

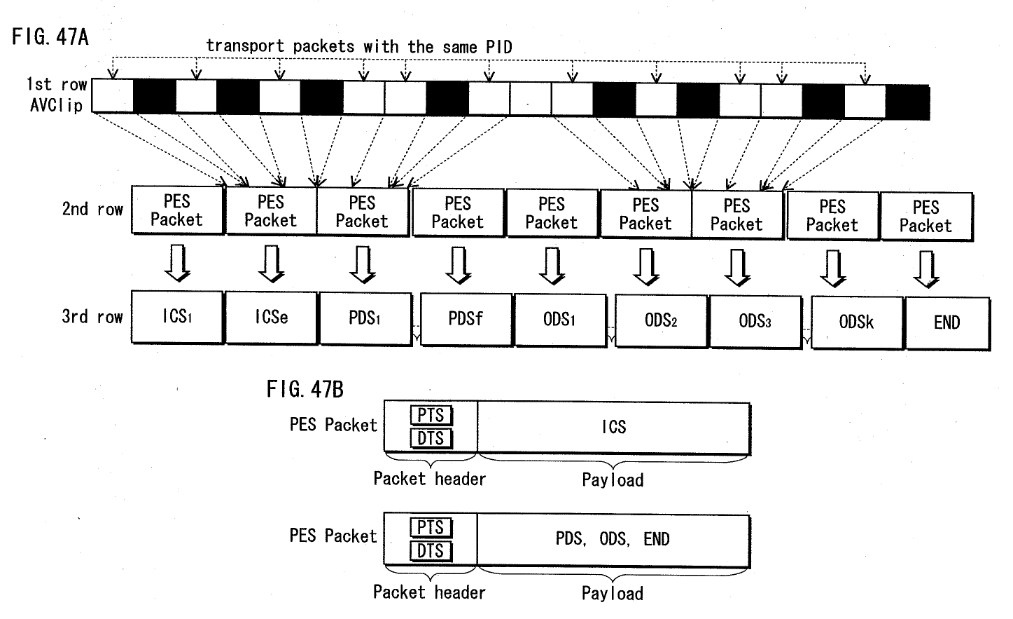

The present embodiment discloses a specific structure of the IG stream. FIG. 47A shows the structure of the IG stream. The first row of the drawing indicates a sequence of TS packets constituting an AVClip. The second row of the drawing indicates a sequence of PES packets constituting a graphics stream. The PES packet sequence indicated in the second row is created as a concatenation of payloads that are extracted from TS packets having a predetermined PID, among the TS packets indicated in the first row.

The third row of the drawing indicates the structure of the graphics stream. The graphics stream is composed of functional segments such as: ICS (Interactive Composition Segment); PDS (Palette Definition Segment); ODS (Object_Definition_Segment); and END (END of Display Set Segment) Of these functional segments, the ICS is called a screen structure segment, and the PDS, ODS, and END are called definition segments. The PES packet and the functional segment are in a one-to-one or one-to-many relationship. That is to say, the functional segment is converted into one PES packet to be recorded onto a BD-ROM, or is divided into a plurality of fragments, which are converted into a plurality of PES packets and recorded onto a BD-ROM.

In the following, the functional segments will be described.

The Interactive Composition Segment (ICS) is a functional segment that controls the screen structure of the interactive graphics object. As one interactive screen structure, the ICS of the present embodiment achieves a multi-page menu.

The Object_Definition_Segment (ODS) is a graphics object in a run-length encoding format. The graphics object in a run-length encoding format is composed of a plurality of pieces of run-length data. The run-length data is composed of: pixel code indicating a pixel value; and the length of a sequence of the pixel value. The pixel code is an 8-bit value that can represent a value in a range from 0 to 255. The run-length data, with use of the pixel code, can set any 256 colors selected from 16,777,216 colors (full colors).

The Palette Definition Segment (PDS) is a functional segment for storing palette data. Each piece of palette data is a combination of: a pixel code representing a value in a range from 0 to 255; and a pixel value. The pixel value is composed of a red color difference component (Cr value), a blue color difference component (Cb value), a luminance component (Y value), and a transparency (T value). When a color is displayed, a pixel code contained in a piece of run-length data is replaced with a corresponding pixel value in accordance with the palette.

The END of Display Set Segment (END) is an index that indicates an end of transfer of a functional segment. The END is displosed at a position immediately after the last ODS. Up to now, the functional segments have been described.

FIG. 47B shows a PES packet that is obtained by converting a functional segment. As shown in FIG. 47B, the PES packet is composed of a packet header and a payload. The payload is substantially the functional segment. The packet header includes DTS and PTS that correspond to the functional segment. In the description herein after, DTS and PTS that exist in the header of the PES packet in which the functional segment is stored are treated as the DTS and PTS of the functional segment.

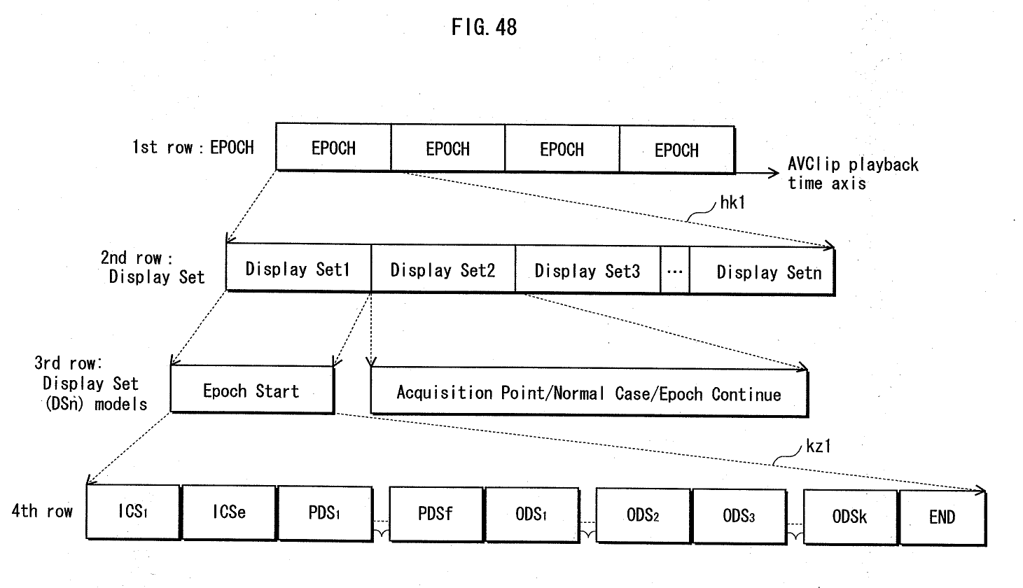

Such a variety of types of functional segments build a logical structure such as the one shown in FIG. 48. FIG. 48 shows a logical structure composed of a variety of types of functional segments. In FIG. 48, the first row indicates Epochs, the second row indicates display sets, and the third row indicates types of display sets. The fourth row indicates the functional segments shown in the third row of FIG. 47A.

First, the Epoch indicated in the first row will be explained. In the IG streams, the Epoch refers to a time period, on an AVClip playback time axis, that has continuity in memory management, and also refers to a set of data assigned to the time period. The memory presumed here is: a graphics plane for storing graphics objects constituting a display; and an object buffer for storing non-compressed graphics objects. That there is continuity in memory management in connection with the graphics plane and the object buffer means that no flush occurs to the graphics plane and the object buffer during the period of the Epoch, and that the graphics are erased and re-drawn only within a predetermined rectangular area in the graphics plane. The vertical and horizontal sizes and the position of the rectangular area are fixed all through the period of the Epoch. The seamless playback is ensured as far as the graphics are erased and re-drawn only within the fixed area in the graphics plane. That is to say, the Epoch is a unit, on a playback time axis, that ensures the seamless playback therein. When the area in the graphics plane, in which the graphics are erased and re-drawn, should be changed, it is necessary to define a new time point as the start of a new Epoch on a playback time axis. In this case, the seamless playback is not ensured at the boundary between the two Epochs.

It should be noted here that in the seamless playback here, the erasure and re-drawing of graphics are completed within a predetermined number of video frames. In the case of the IG stream, the number of video frames is 4.5 frames. The number of video frames is determined by a ratio of the fixed area size to the whole graphics plane and a transfer rate between the object buffer and the graphics plane.

The Display Set (acronymized as DS) indicated in the second row of FIG. 48 is a set of functional segments constituting one screen structure, among a plurality of functional segments constituting the graphics stream. The dotted line hk1 in FIG. 48 indicates relationships between the Epochs and the DSs, more specifically, it indicates Epochs to which DSs belong, respectively. In the example shown in FIG. 48, it is understood that DS1, DS2, DS3, . . . DSn belong to an Epoch in the first row.

The third row of FIG. 48 indicates types of Display Sets. The type of the start Display Set in an Epoch is “Epoch Start”. Also, types of Display Sets other than the start Display Set are “Acquisition Point”, “Normal Case”, and “Epoch Continue”. The order of “Acquisition Point”, “Normal Case”, and “Epoch Continue” indicated in the example of this drawing is merely an example, but may be arranged in any other order.

“Epoch Start” is a Display Set placed at the start of an Epoch. For this reason, Epoch Start includes all functional segments necessary for the next screen combination. Epoch Start is arranged at a position from which a playback starts, for example, a position from which a chapter of a movie work starts.

“Acquisition Point” is a Display Set that is not placed at the start of an Epoch, but includes all functional segments necessary for the next screen combination. When a playback is started with the Acquisition Point DS, the graphics display is ensured. That is to say, the Acquisition Point DS has a role to construct a screen from the middle of an Epoch. The Acquisition Point DS is imbedded at a position from which a playback can be started. One of such positions is a position specified by a time search. The time search is an operation where, upon receiving a user input specifying a time period such as several minutes or seconds, the device starts a playback from a time point corresponding to the specified time period. The time period is specified in a rough unit of, for example, 10 minutes or 10 seconds. Accordingly, the time search can specify, as a playback start point, one among the points positioned at intervals of 10 minutes or 10 seconds. In this way, by imbedding Acquisition Points at positions that can be specified by the time search, the graphics streams can be played back appropriately when the time search is performed.

“Normal Case” is a DS that provides a display effect called “display update”, and includes only differences from the previous screen combination. For example, suppose a Display Set DSv and a Display Set DSu have the same contents, but differ in the screen structure. In such a case, the DSv is set as a Normal Case DS by making it to be composed of only ICSs or ODSs. This eliminates the necessity for including overlapping ODSs, and thus contributes to reduction in the capacity of ED-ROM. Since the Normal Case DS has only differences, Normal Case cannot construct a screen by itself.

“Epoch Continue” indicates that an Epoch continues across a boundary between AVClips. When Composition State of DSn has been set to Epoch Continue, DSn and DSn−1, which precedes DSn, belong to the same Epoch even if DSn and DSn−1 exist in different AVClips. With this structure, even if a branch from AVClip occurs between the two DSs, a flush of the graphics plane and the object buffer does not occur.

The dotted line kz1 in FIG. 48 indicates relationships between the DSs and the functional segments indicated in the fourth row, more specifically, it indicates DSs to which the functional segments belong, respectively. Since the functional segments in the fourth row are the same as those shown in FIG. 47A, it is understood that they all belong to Epoch Start. Also, the same functional segments belonging to Epoch Start belong to Acquisition Point, as well. The functional segments belonging to Normal Case are part of the functional segments belonging to Epoch Start.

Up to now, the logical structure composed of functional segments has been explained. Next will be explained how these Display Sets having ICSs and ODSs should be assigned on an AVClip playback time axis. The Epoch is a period having continuity in memory management on the playback time axis, and is composed of one or more Display Sets. As a result, a question is how to assign Display Sets on the AVClip playback time axis. It should be noted here that the AVClip playback time axis is a time axis prepared to define the decoding timing and playback timing of each picture data constituting the video stream multiplexed in the AVClip. On the playback time axis, the decoding timing and playback timing are represented with a temporal accuracy of 90 KHz. The DTSs and PTSs attached to the ICSs and ODSs in the Display Sets indicate the timings for the synchronization control. The Display Sets are assigned on the playback time axis by performing the synchronization control using DTSs and PTSs attached to the ICSs and ODSs.

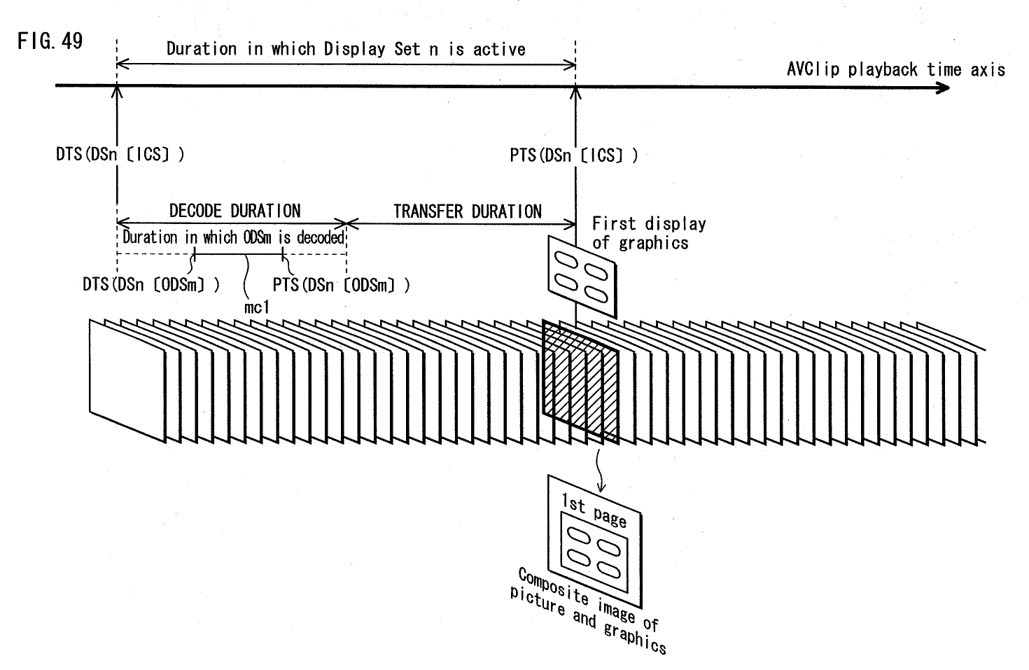

Suppose that DSn is a given Display Set among a plurality of Display Sets belonging to an Epoch, and that DSn is assigned on the AVClip playback time axis by setting the DTSs and PTSs as shown in FIG. 49.

FIG. 49 shows an AVClip playback time axis on which DSn is assigned. In FIG. 49, the start of DSn is indicated by a DTS value (DTS(DSn[ICS])) of an ICS belonging to DSn, and the end of DSn is indicated by a PTS value (PTS(DSn[ICS])) of an ICS belonging to DSn. Also, the timing when the first display of DSn is performed is indicated by a PTS value (PTS(DSn[ICS])) of an ICS. When a PTS(DSn[ICS]) matches a timing of display of a desired picture in a video stream, the first display of DSn synchronizes with the video stream.

The value PTS(DSn[ICS]) is obtained by adding, to DTS(DSn[ICS]), values indicating (i) a time period (DECODE DURATION) required for decoding the ODS and (ii) a time period (TRANSFER DURATION) required for transferring a graphics object that was obtained by the decoding.

The ODS necessary for the first display is decoded in this DECODE DURATION. In FIG. 49, “mc1” indicates a time period in which a given ODS (ODSm) belonging to DSn is decoded. The start point of the decoding period is indicated by DTS(ODSn[ODSm]), and the end point of the decoding period is indicated by PTS(ODSn[ODSm]).

An Epoch is defined when the above-described assignment on the playback time axis is performed onto all the ODSs belonging to the Epoch. This completes the description of the assignment on the playback time axis.

The present embodiment is characterized by controlling the multi-page menu as the moving image playback proceeds on the above-described playback time axis. A novel structure for realizing the characteristic exists in “Interactive_composition” within the ICS. The following will explain the internal structures of the ICS and Interactive_composition.

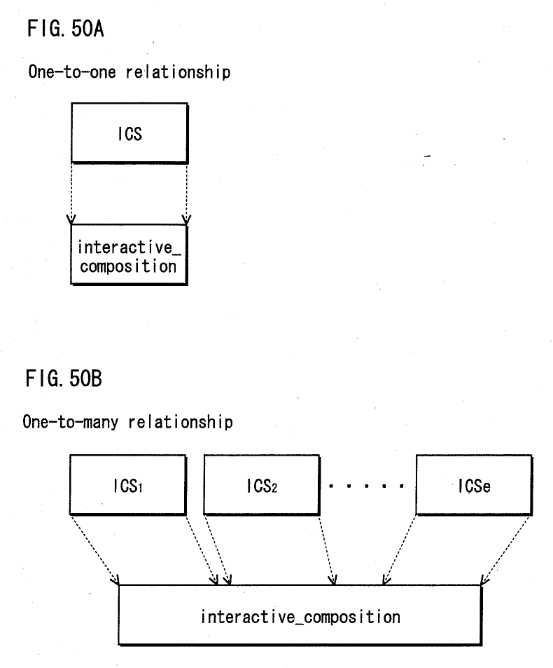

FIGS. 50A and 50B shows relationships between ICS and Interactive_composition. The relationships between ICS and Interactive_composition include a one-to-one relationship as shown in FIG. 50A and a one-to-many relationship as shown in FIG. 50B.

The one-to-one relationship is generated when Interactive_composition is small enough in size to be included in one ICS.

The one-to-many relationship is generated when Interactive_composition has a large size and is divided into a plurality of fragments to be stored in a plurality of ICSs. In this case, Interactive_composition has no limit in size, but may have any desired size such as 512 KB or 1 MB. As described up to now, the ICS and Interactive_composition may have one-to-many relationship. However, in the description herein after, it is presumed that they have one-to-one relationship for the sake of convenience.

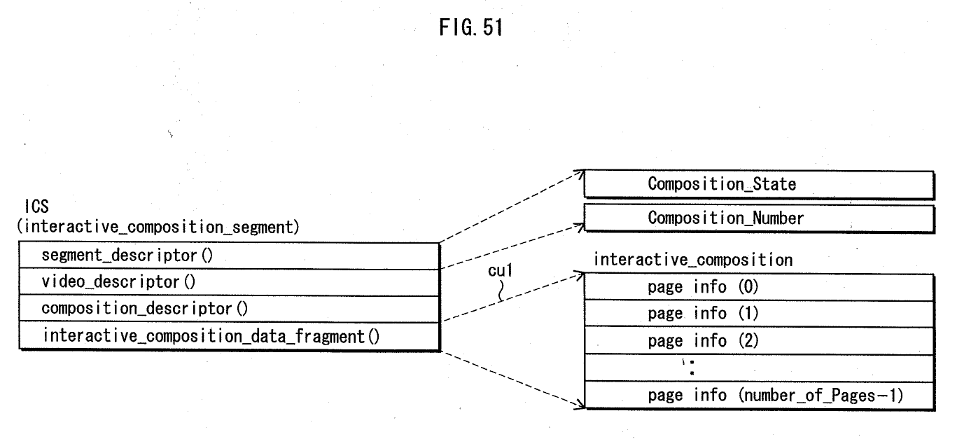

FIG. 51 shows the internal structure of ICS. The ICS stores the whole Interactive_composition or part of Interactive_composition obtained by dividing it into fragments. As shown on the left-hand side of FIG. 51, the ICS includes “segment_descriptor” indicating that the segment itself is ICS, “video_descriptor” indicating the number of pixels in the vertical and horizontal directions and the frame rate presumed in the ICS itself, “composition_descriptor”, and “interactive_composition_data_fragment” that is the whole Interactive_composition or part of Interactive composition obtained by dividing it into fragments. The “composition_descriptor” is composed of “composition_state” and “composition_number”, where “composition_state” indicates one of “Normal Case”, “Acquisition Point”, “Epoch Start”, and “Effect Sequence”, to which the Display Set including the ICS itself belongs, and “composition_number” indicates the number of times the screen is combined.

The lead line “cu1” in FIG. 51 indicates the close-up of the internal structure of Interactive_composition. As shown in FIG. 51, Interactive_composition includes page information (0), page information (1), . . . page information (i), . . . page information (number_of_pages-1) that respectively correspond to a plurality of pages that can be displayed on the multi-page manu.

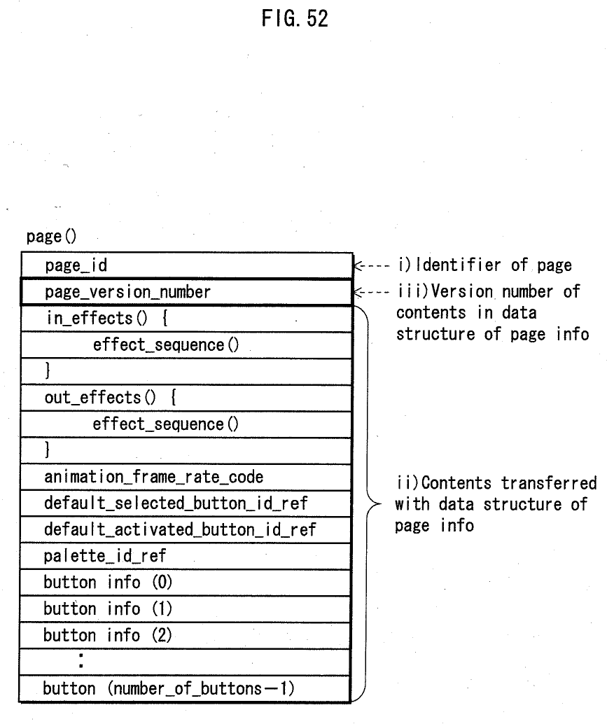

FIG. 52 shows the internal structure of page information of a given page (page “y”) among a plurality of pages belonging to the x^{th} Display Set in an Epoch. As shown in FIG. 52, the page information (y) includes:

i) “page_id” uniquely identifying page (y);

ii) “in_effects”, “out_effects”, “animation_frame_rate_code”, “default_selected_button_id_ref”, “default_activated_button_id_ref”, “palette_id_ref”, “button information (0)”, “button information (1)”, . . . “button information (number_of_buttons-1)”; and

iii) “page_version number” that indicates the version of the content of page information (y).

First, each of the fields constituting the data structure to be transferred by page information (y) will be described.

The “in_effects” indicates display effects that should be played back when page (y) starts to be displayed. The “out_effects” indicates display effects that should be played back when page (y) ends being displayed.

The “animation_frame_rate_code” describes a frame rate that should be applied when the animation display is applied to page (y).

The “default_selected_button_id_ref” indicates whether to dynamically or statically define buttons that are to be set to the selected state as the default state when page (y) starts to be displayed. When this field is “0×FF”, it indicates that the buttons, which are to be set to the selected state as the default state, should be defined dynamically. When the buttons should be defined dynamically, values that are set in the Player Status Registers (PSRs) are interpreted by priority, and the buttons indicated by the PSRs enter the selected state.

The “default_activated_button_id_ref” indicates a button that enters the active state automatically when the time indicated by selection_time_out_pts is reached. When the “default_activated_button_id_ref” is “FF”, a button in the selected state is automatically selected at a predetermined set time; and when the “default_activated_button_id_ref” is “00”, the automatic selection is not performed. When the “default_activated_button_id_ref” is a value other than “FF” and “00”, this field is interpreted as an effective button number.

The “palette_id_ref” indicates an ID of a palette to be set in the CLUT unit.

The “button information ( )” is information for defining the buttons to be displayed on page (y). These fields define the contents of pages constituting the multi-page manu.

The “page_version_number” is a field that indicates the version of the content that is transferred with the data structure of page information (y) in the Epoch. Here, the “page_version_number” will be described in more detail since it is one of main characteristics of the present application. The version of page information (y) indicates the number of updates having been made onto the data structure of page information (y). In the data structure of page information (y), when any value has changed or any change is detected in the fields immediately after the page_version_number, it is judged that page information (y) has been updated.

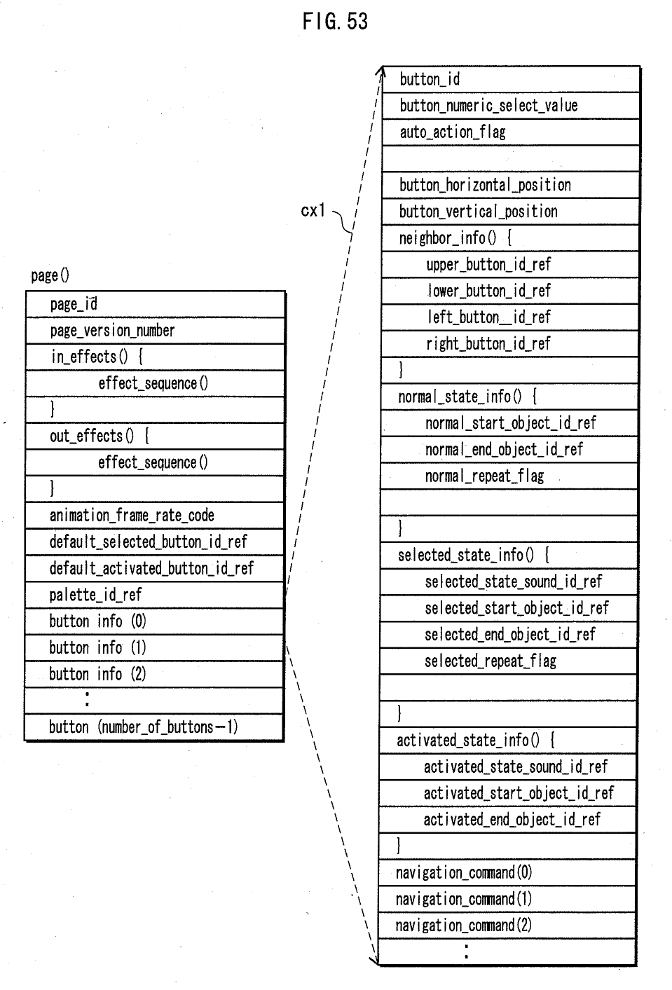

FIG. 53 shows the internal structure of button information (i) in page information (y).

The “button_id” is a numeral for uniquely identifying button (i) in interactive_composition.

The “button_numeric_select_value” is a flag indicating whether or not to permit the numeric selection of button (i).

The “auto_action_flag” indicates whether or not to cause button (i) to enter the active state automatically. When “auto_action_flag” is ON (bit value “1”), button (i) enters the active state instead of the active state; and when “auto_action_flag” is OFF (bit value “0”), button (i) enters the active state when it is selected.

The “button_horizontal_position” and “button_vertical_position” indicate the horizontal and vertical positions of the upper-left pixel of button (i) in the interactive screen, respectively.

The “neighbor_info” is information that indicates which one of buttons should be set to the selected state when the focus is instructed to move in the upward, downward, leftward, or rightward direction while button (i) is in the selected state. The “neighbor_info”, is composed of “upper_button_id_ref”, “lower_button_id_ref”, “left_button_id_ref”, and “right_button_id_ref”.

The “upper_button_id_ref” indicates the number of a button that should be set to the selected state instead of button (i) when a key (MOVE UP key) on the remote control instructing the focus to move upward is pressed while button (i) is in the selected state. If this field has been set to the number of button (i), pressing of the MOVE UP key is disregarded.

The “lower_button_id_ref”, “left_button_id_ref” and “right_button_id_ref” respectively indicate the numbers of buttons that should be set to the selected state instead of button (i) when a key (MOVE DOWN, MOVE LEFT, OR MOVE RIGHT key) on the remote control instructing the focus to move downward, leftward, or rightward is pressed while button (i) is in the selected state. If any of these fields has been set to the number of button (i), pressing of the corresponding key is disregarded.

The “normal_state_info” is information for defining the normal state of button (i). The “normal_state_info” is composed of “normal_start_object_id_ref”, “normal_end object_id_ref” and “normal_repeat_flag”.

The “normal_start_object_id_ref” indicates the initial one among a plurality of sequential numbers attached to a plurality of ODSs constituting an animation that represents button (i) in the normal state.

The “normal_end_object_id_ref” indicates the last one among a plurality of sequential numbers (“object_ID”) attached to a plurality of ODSs constituting an animation that represents button (i) in the normal state. When the ID indicated by the “normal_end_object_id_ref” is identical with the ID indicated by the “normal_start_object_id_ref”, a still image of a graphics object_identified by this ID becomes the image of button (i).

The “normal_repeat_flag” indicates whether or not to continue displaying the animation of button (i) in the normal state repeatedly.

The “selected_state_info” is information for defining the selected state of button (i). The “selected_state_info” is composed of “selected_state_sound_id_ref”, “selected_start_object_id_ref”, “selected_end object_id_ref” and “selected_repeat_flag”.

The “selected_state_sound_id_ref” is information specifying sound data that should be played back as a click sound when the selected state of button (i) changes. The specification is made by describing the identifier of the sound data stored in a file “sound.bdmv”. When this field is “0×FF”, it indicates that no sound data is specified, and the click sound is not played back.

The “selected_start_object_id_ref” indicates the initial one among a plurality of sequential numbers attached to a plurality of ODSs constituting an animation that represents button (i) in the selected state.

The “selected_end_object_id_ref” indicates the last one among a plurality of sequential numbers attached to a plurality of ODSs constituting an animation that represents button (i) in the selected state. When the ID indicated by the “selected_end_object_id_ref” is identical with the ID indicated by the “selected_start_object_id_ref”, a still image of a graphics object_identified by this ID becomes the image of button (i).

The “selected_repeat_flag” indicates whether or not to continue displaying the animation of button (i) in the selected state repeatedly. When the ID indicated by the “selected_end_object_id_ref” is identical with the ID indicated by the “selected_start_object_id_ref”, this field is set to “00”.

The “activated_state_info” is information for defining the active state of button (i), and is composed of “activated_state_sound_id_ref”, “activated_start_object_id_ref” and “activated_end_object_id_ref”.

The “activated_state_sound_id_ref” is information specifying sound data that should be played back as a click sound when the selected state of a button corresponding to the button information changes. The specification is made by describing the identifier of the sound data stored in a file “sound.bdmv”. When this field is “0×FF”, it indicates that no sound data is specified, and the click sound is not played back.

The “activated_start_object_id_ref” indicates the initial one among a plurality of sequential numbers attached to a plurality of ODSs constituting an animation that represents button (i) in the active state.

The “activated_end_object_id_ref” indicates the last one among a plurality of sequential numbers attached to a plurality of ODSs constituting an animation that represents button (i) in the active state.

The “navigation_command” is a command that is executed when button (i) enters the active state. This command is the same as the navigation command written in the Movie Object. Accordingly, by describing a navigation command, which is desired to be executed by the playback device, into the button information, it is possible to cause the playback device to perform a desired control when the corresponding button is confirmed. As is the case with Movie Object, the navigation_command in the button information control the playback device to wait for an operation. Accordingly, the program of the present invention, namely, a program that causes the playback device to perform a control for waiting operation via a menu display is composed of navigation commands respectively written in Movie Object and the button information. In the specific example shown in Embodiment 1, the displayed menu has buttons for receiving selections of Title#1 and Title#2. In this case, navigation commands respectively instructing for jumping to Title#1 and Title#2 may be written into the “navigation_commands” of the button information corresponding to the buttons for receiving selections of Title#1 and Title#2, respectively, so that Title#1 or Title#2 starts to be played back depending on the status change of the buttons for receiving selections of Title#1 and Title#2.

There is also SetButtonPage command that is a navigation command unique to the button information. The SetButtonPage command is a command that instructs the playback device to display a desired page of the multi-page menu and to set a desired button in the displayed page to the selected state. Use of these navigation commands facilitates the authoring staff in describing page change.

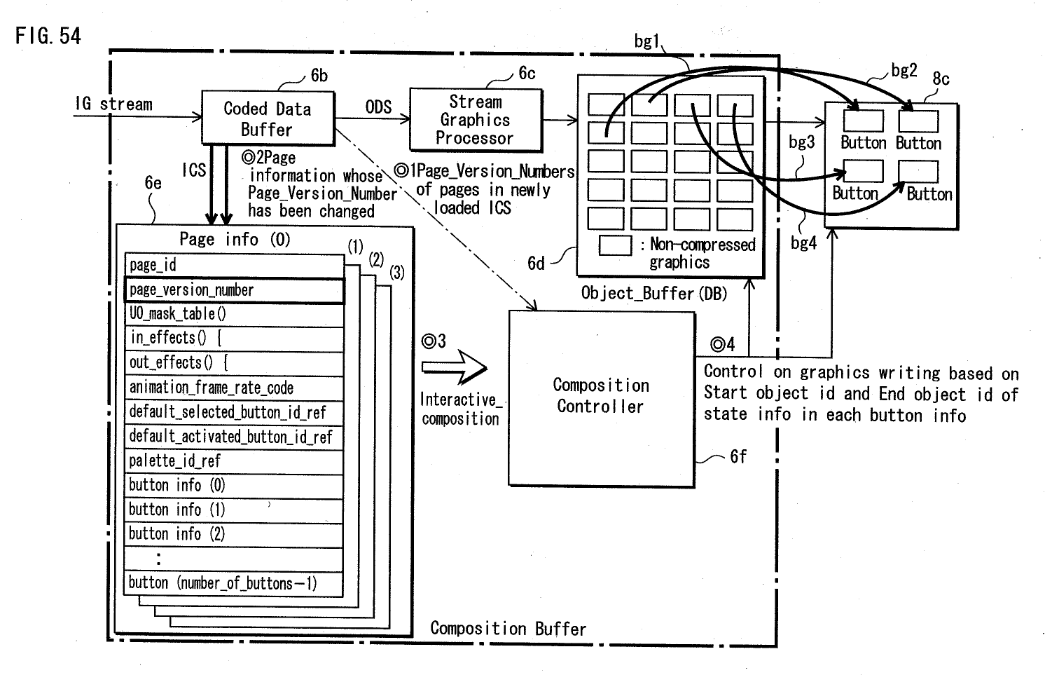

In the following described will be how the IG stream having the above-described structure is processed by the structural elements of the IG decoder 6 shown in FIG. 23, with reference to FIG. 54.

In the Coded Data Buffer 6b, ICSs, PDSs and ODSs are temporarily stored, together with DTSs and PTSs.

The Stream Graphics Processor 6c decodes the ODSs to obtain non-compressed graphics, and writes the obtained graphics to the Object Buffer 6d.

The Object Buffer 6d is provided therein with a plurality of non-compressed graphics objects (in FIG. 54, represented by the boxes) which were obtained as a result of decoding by the Stream Graphics Processor 6c. The graphics objects (the boxes) stored in the Buffer 6b are identified by the object_ids. When a request for permission of a graphics object is issued while the Object Buffer 6d stores another graphics object that has the same object_id as the requested graphics object, the graphics object in the Object Buffer 6d is overwritten with the requested graphics object.

The Composition Buffer 6e is a buffer for storing

Interactive_compositions transferred in correspondence with one or more ICSs. The Interactive_compositions stored therein are supplied to the Graphics Controller 6f to be decoded therein.

The Graphics Controller 6f, each time a new Display Set is reached by the current playback time point, judges which among Epoch Start, Acquisition Point and Normal Case is the Composition_State of the ICS contained in the new Display Set. When it is Epoch Start, the Graphics Controller 6f transfers a new Interactive_composition in the Coded Data Buffer 6b to the Composition Buffer 6e therefrom.

The Graphics Controller 6f, each time an ICS is read into the Coded Data Buffer 6b from a Display Set of the Acquisition Point type, matches the Page_Version_Number in each piece of page information belonging to the read ICS, with the Page_Version_Number in each piece of page information in the Composition Buffer 6e. When there is a piece of page information with a larger value of Page_Version_Number within the Coded Data Buffer 6b, the Graphics Controller 6f transfers the piece of page information from the Coded Data Buffer 6b to the Composition Buffer 6e. In other words, this is an update of a desired piece of page information in the Composition Buffer 6e. It is then judged whether a page corresponding to the updated piece of page information is currently displayed. When it is judged that a page corresponding to the updated piece of page information is currently displayed, the page is re-drawn. The sign ⊚ 1 represents an operation where the Page_Version_Number in the Interactive_composition read into the Coded Data Buffer 6b is referred to. The sign ⊚2 represents an operation where the page information with a larger value of Page_Version_Number is transferred. The sign ⊚3 represents an operation where the updated page information is referred to. The sign ⊚4 represents an operation where the page is re-drawn based on the updated page information. Also, the arrows bg1, bg2, bg3 and bg4 symbolically indicate the re-drawing by the Graphics Controller 6f. With such a drawing operation, a page with buttons 0-A through 0-D arranged therein appears in the title structure generating unit 10, and the page is combined with the moving image.

The Epoch is a unit having continuity in memory management in the graphics decoder. Accordingly, the Epoch should be complete in itself within one AVClip. However, when the moving image menu described in Embodiment 1 is to be presented, it is necessary to display the menu continuously using a plurality of pieces of PlayItem information. This necessitates definition of an Epoch that is continuous through a plurality of pieces of PlayItem information. Here, it is possible to define an Epoch that is continuous through two AVClips that are played back in sequence, when three predetermined conditions are satisfied.

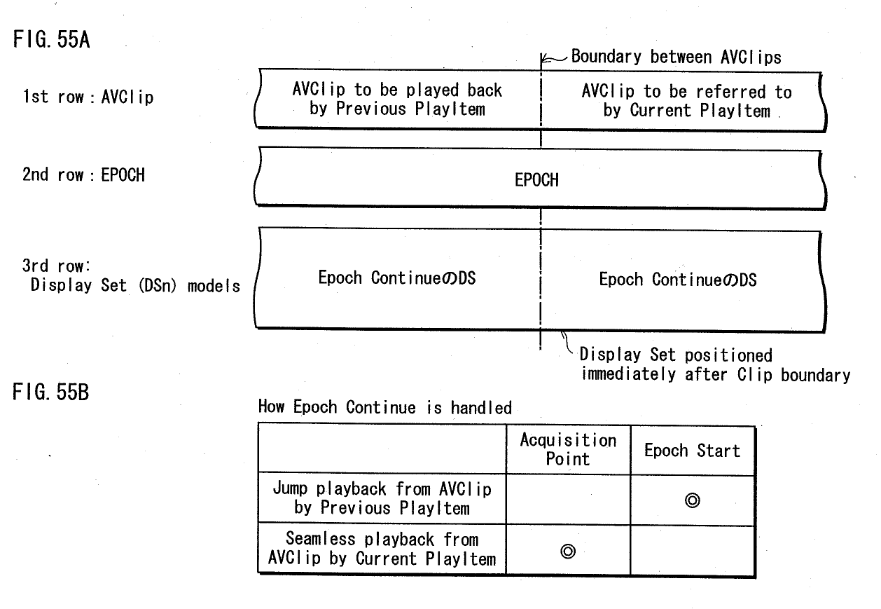

FIG. 55A shows an Epoch that is continuous through two AVClips. The first row of the drawing indicates an AVClip to be played back by Previous PlayItem and an AVClip to be played back by Current PlayItem. The second row indicates an Epoch that is continuous through two AVClips. The third row indicates Display Sets belonging to the Epoch indicated in the second row. The Epoch in the second row has not been divided in correspondence with the two AVClips. However, the separation between two Display Sets in the third row corresponds to the separation between the two AVClips. A noteworthy point in this drawing is that the type of Display Set (DSm+1) positioned immediately after the AVClip boundary is “Epoch Continue” type.

The “Epoch Continue” is a type of Display Set (DSm+1) positioned immediately after the AVClip boundary, and is handled as Acquisition Point when three predetermined conditions are satisfied. It is handled as Epoch Start when any of the three conditions is not satisfied.

FIG. 55B shows how a Display Set of the “Epoch Continue” type is handled. As shown in FIG. 55B, a Display Set of the “Epoch Continue” type is handled as Epoch Start when a jump playback from an AVClip played back by Current PlayItem is performed, and is handled as Acquisition Point when a seamless playback from an AVClip played back by Previous PlayItem is performed

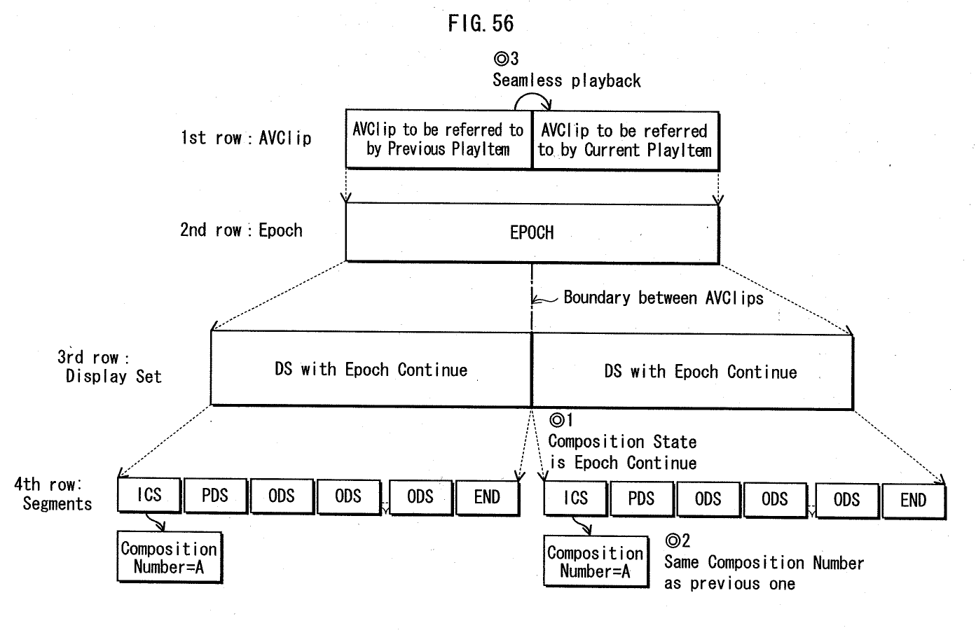

FIG. 56 shows the three conditions to be satisfied when two AVClips are played back seamlessly. The first row of the drawing indicates two AVClips that are played back seamlessly. The second row indicates an Epoch. This Epoch is an Epoch having continuity in memory management between the two AVClips. The third row indicates Display Sets belonging to the Epoch indicated in the second row. The Epoch in the second row has not been divided in correspondence with the two AVClips. However, the separation between two Display Sets in the third row corresponds to the separation between the two AVClips. The fourth row indicates functional segments belonging to the Display Sets. The groups of segments indicated in the fourth row are the same as those indicated in the fourth row of FIG. 5. The signs ⊚1, ⊚2 and ⊚3 represent the three conditions to be satisfied in Epoch when two AVClips are played back seamlessly. The first condition is that the type of Display Set (DSm+1) positioned immediately after the AVClip boundary is “Epoch Continue”.

The second conditions is that all pieces of position information in ICSs belonging to DSm+1 have the same Composition Number (=A) as all pieces of position information in ICSs belonging to DSm that is a Display Set immediately before DSm+1. This means that the contents of graphics display are the same before and after the AVClip boundary. Here, the Composition Number means a screen structure of a Display Set. Accordingly, when DSm and DSm+1 have the same Composition Number, the screen structures of DSm and DSm+1 provide the same graphics contents.

The third condition is that the playback of AVClip by Previous PlayItem is seamlessly connected with the playback of AVClip by Current PlayItem. The seamless connection can be achieved when the following conditions are satisfied.

(i) The same video stream display method (NTSC, PAL or the like) is indicated in the video attribute information of the two AVClips.

(ii) The same audio stream encoding method (AC-3, MPEG, LPCM or the like) is indicated in the audio attribute information of the two AVClips.

The reason why the seamless playback is not available when any of the above-indicated conditions (i) and (ii) is not satisfied is that the video decoder or the audio decoder stop operation to change the display method, encoding method, or bit rate of the video stream or audio stream when a different display method or encoding method is specified.

For example, when two audio streams respectively having been encoded by the AC-3 method and the MPEG standard are to be played back seamlessly, the audio decoder should change the stream attributes when the audio streams change from one to the other. This causes the audio decoder to stop the decoding. This also applies to the case where video stream attributes are changed.

Accordingly, the seamless connection can be performed only when both the above-indicated conditions (i) and (ii) are satisfied. The seamless connection is not available when any of the conditions (i) and (ii) is not satisfied.

DSm+1 of “Epoch Continue” type is handled as Acquisition Point when the above-described three conditions are satisfied. In this case, Display Sets 1 through m and Display Sets m+1 through n form one Epoch, and the buffer state in the graphics decoder is maintained even if the two AVClips are played back in sequence.

Even when DSm+1 is “Epoch Continue” type, if any of the remaining two conditions is not satisfied, the Epoch is divided into two in the vicinity of the AVClip boundary. Accordingly, as described above, a Display Set of “Epoch Continue” type is handled as Acquisition Point when all the above-described three conditions are satisfied; and it is handled as Epoch Start when any of the conditions is not satisfied.

According to the present embodiment with the above-described structure, it is possible to prevent the displayed menu from disappearing when a switch occurs between pieces of PlayItem information, by, in the second and succeeding pieces of PlayItem information in the PlayList information, setting the Composition Type to Epoch Continue and setting the Composition Number to the same value as the Composition Number of the first piece of PlayItem information in the PlayList information.

### Embodiment 7

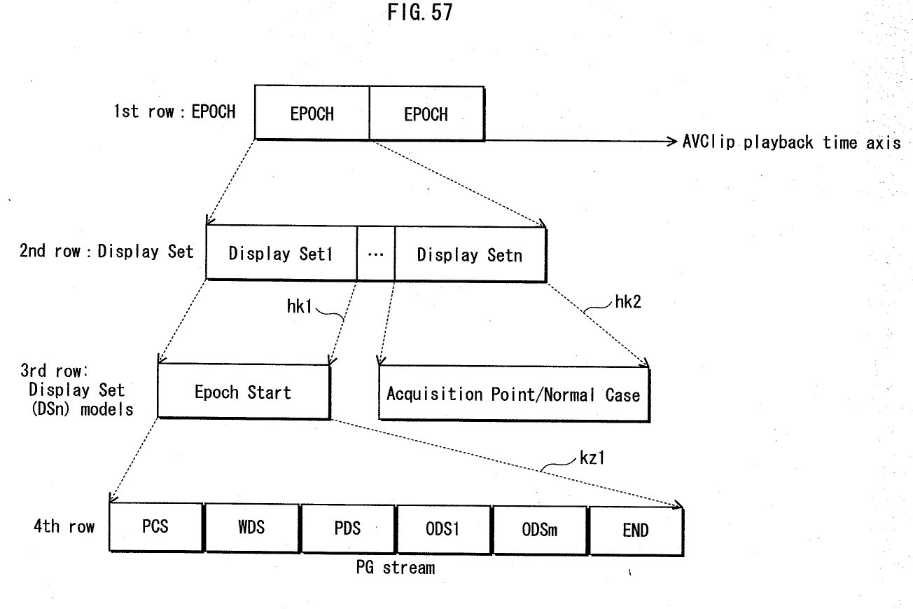

Embodiment 7 discloses a specific structure of the PG stream. FIG. 57 shows a specific structure of the PG stream. The fourth row of the drawing indicates the PG stream. The third row indicates types of Display Sets to which the PG stream belongs. The second row indicates Display Sets. The first row indicates Epochs.

Each Display Set (DS) indicated in the second row is a set of functional segments of one screen, among a plurality of functional segments constituting the graphics stream. The dotted line kz1 in FIG. 57 indicates relationships between the DSs and the functional segments indicated in the fourth row, more specifically, it indicates DSs to which the functional segments belong, respectively. It is understood from the drawing that each DS is composed of a sequence of functional segments: PCS-WDS-PDS-ODS-END, among a plurality of functional segments constituting the PG stream. By reading the sequence of functional segments constituting a DS, the playback device can structure one screen of graphics.

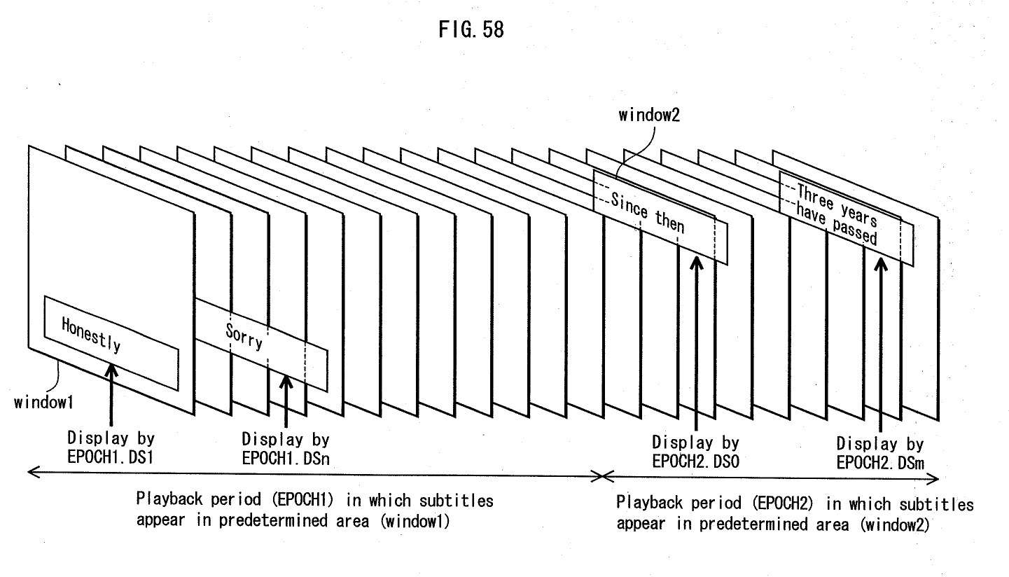

Here, the concept of Epoch in the PG stream will be described. Each Epoch in the first row of the drawing refers to a time period, on an AVClip playback time axis, that has continuity in memory management, and also refers to a set of data assigned to the time period. The memory presumed here is: a graphics plane for storing one screen of graphics; and an object buffer for storing decompressed graphics data. In terms of the relationships between positions of subtitles and Epochs, an Epoch corresponds to a time period for which subtitles appear in a certain rectangular area in the screen, on a playback time axis. FIG. 58 shows the relationships between display positions of subtitles and Epochs. In FIG. 58, display positions of subtitles are changed depending on patterns of pictures. In more detail, two subtitles “Honestly” and “Sorry” are positioned at the bottom of the screen, whereas two subtitles “Since then” and “Three years have passed” are positioned at the top of the screen. Thus, the display positions of subtitles are changed from one margin to another on the screen, to enhance visibility. In such a case, on the reproduction time axis of the AV Clip, a time period during which the subtitles are displayed at the bottom of the screen is Epoch1, and a time period during which the subtitles are displayed at the top of the screen is Epoch2. These two Epochs each have an individual subtitle rendering area. In Epoch1, the subtitle rendering area is Window1 that corresponds to the bottom margin of the screen. In Epoch2, the subtitle rendering area is Window2 that corresponds to the top margin of the screen. In each of Epoch1 and Epoch2, the continuity of memory management on the buffer plane is secured, so that the subtitles are displayed seamlessly in the corresponding margin of the screen. This completes the explanation on the Epoch. The following explains the Display Set.

In FIG. 57, dotted lines hk1 and hk2 indicate which Epoch the DSs in the second row belong to. As illustrated, a series of DSs that are an Epoch Start DS, an Acquisition Point DS, and a Normal Case DS constitutes one Epoch indicated in the first row. Here, Epoch Start, Acquisition Point, and Normal Case are types of DSs. Though the Acquisition Point DS precedes the Normal Case DS in FIG. 57, they may be arranged in reverse order.

Next described will be characteristic functional segments among those constituting the PG stream. Among the functional segments in the PG stream, WDS and PCS are unique to the PG stream. First, the WDS (Window Definition Segment) will be described.

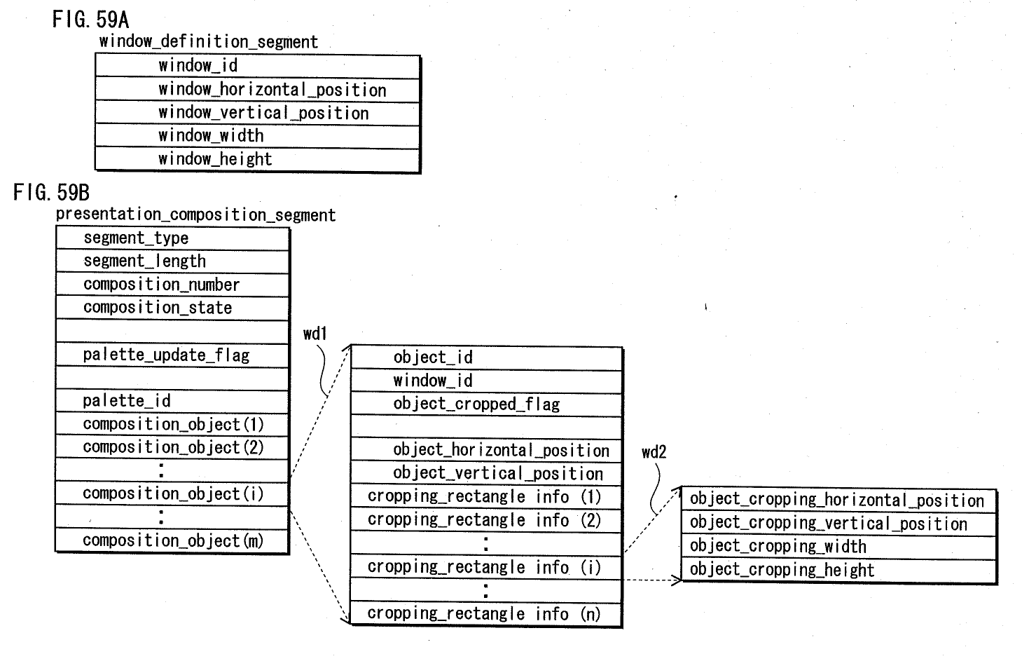

The “window_definition_segment” is a functional segment for defining a rectangular area on the Graphics Plane. As mentioned earlier, the Epoch has continuity in memory management only when the clearing and re-rendering are performed in a certain rectangular area on the Graphics Plane. This rectangular area on the Graphics Plane is called a Window, which is defined by the WDS. FIG. 59A shows a data structure of the WDS. As shown in the drawing, the WDS includes a “window_id” field uniquely identifying the Window on the Graphics Plane, a “window_horizontal_position” field specifying a horizontal position of a top left pixel of the Window on the Graphics Plane, a “window_vertical_position” field specifying a vertical position of the top left pixel of the Window on the Graphics Plane, a “window_width” field specifying a width of the Window on the Graphics Plane, and a “window_height” field specifying a height of the Window on the Graphics Plane.

The fields “window_horizontal_position”, “window_vertical_position”, “window_width” and “window_height” can take the following values. A coordinate system constructed with these values presumes an internal area of the Graphics Plane. This Graphics Plane has a two-dimensional size defined by video_height and video_width parameters.

The window_horizontal_position field specifies the horizontal position of the top left pixel of the Window on the Graphics Plane, and accordingly takes a value in a range of “1” to “video_width”. The window_vertical_position field specifies the vertical position of the top left pixel of the Window on the Graphics Plane, and accordingly takes a value in a range of “1” to “video_height”.

The window_width field specifies the width of the Window on the Graphics Plane, and accordingly takes a value in a range of 1 to (video_width)-(window_horizontal_position). The window_height field specifies the height of the Window on the Graphics Plane, and accordingly takes a value in a range of 1 to (video_height)-(window_vertical_position).

A position and size of a Window can be defined for each Epoch, using these window_horizontal_position, window_vertical_position, window_width, and window_height fields in the WDS. This makes it possible, during the authoring, to adjust a Window to appear in a desired margin of each picture in an Epoch so as not to interfere with a pattern of the picture. The subtitles displayed by Graphics in this way can be viewed clearly. The WDS can be defined for each Epoch. Accordingly, as pictures change in pattern with time, the graphics can always be displayed with high visibility in response to the change. This increases the quality of the movie work to such a level where subtitles are embedded into the movie as an original constituent.

The following explains the PCS (Composition Segment).

The PCS is a functional segment constituting a subtitle in the screen or the like. FIG. 59B shows a data structure of the PCS. As shown in the drawing, the PCS includes a segment_type field, a segment_length field, a composition_number field, a composition_state field, a palette_update_flag field, a palette_id field, and composition_object(1) to composition_object(m) fields.

The composition_number field uniquely identifies a graphics update in the DS, using a number from 0 to 15. In more detail, the composition_number field is incremented by 1 for each graphics update from the beginning of the Epoch to the PCS.

The composition_state field indicates whether the DS is a Normal Case DS, an Acquisition Point DS, or an Epoch Start DS.

The palette_update_flag field shows whether the PCS describes a PaletteOnly Display Update. The PaletteOnly Display Update refers to such an update that only replaces a previous Palette with a new Palette. To indicate a PaletteOnly Display Update, the palette_update_flag field is set to 1.

The palette_id field indicates whether or not the PaletteOnly Display Update has been performed in the concerned PCS. The PaletteOnly Display Update refers to an update of a Display Set where only a palette is replaced with a new one. When the PaletteOnly Display Update is performed in the concerned PCS, the palette_id field is set to 1.

The composition_object(1) to composition_object(m) fields each are control information for realizing a screen structure in the DS to which the PCS belongs. In FIG. 59B, dotted lines wd1 indicate an internal structure of composition_object(i) as one example. As illustrated, composition_object(i) includes an object_id_ref field, a window_id_ref field, an object_cropped flag field, an object_horizontal_position field, an object_vertical_position field, and cropping_rectangle information(1) to cropping_rectangle information(n).

The object_id_ref field indicates a reference value of a graphics Object identifier (object_id) This reference value indicates an identifier of the graphics Object that is to be used in order to produce a screen structure corresponding to composition_object(i).

The window_id_ref field shows a reference value of an identifier of a Window (window_id). This reference value specifies the Window in which the graphics Object is to be displayed in order to produce the screen structure corresponding to composition_object(i).

The object_cropped_flag field shows whether the graphics Object cropped in the Object Buffer is to be displayed or not. When the object_cropped flag field is set to 1, the graphics Object cropped in the Object Buffer is displayed. When the object_cropped_flag field is set to 0, the graphics Object cropped in the Object Buffer is not displayed.

The object_horizontal_position field specifies a horizontal position of a top left pixel of the graphics Object on the Graphics Plane.

The object_vertical_position field specifies a vertical position of the top left pixel of the graphics Object on the Graphics Plane.

The cropping_rectangle information(1) to cropping_rectangle information(n) fields are valid when the object_cropped_flag field value is 1. The dotted lines wd2 indicate an internal structure of a given cropping_rectangle information(i). As illustrated, cropping_rectangle information(i) includes an object_cropping_horizontal_position field, an object_cropping vertical_position field, an object_cropping_width field, and an object_cropping_height field.

The object_cropping_horizontal_position field specifies a horizontal position of a top left corner of a cropping rectangle in the graphics plane. The cropping rectangle is used for taking out one part of the graphics Object, and corresponds to a “Region” in the ETSI EN 300 743 standard.

The object_cropping_vertical_position field specifies a vertical position of the top left corner of the cropping rectangle in the graphics plane.

The object_cropping_width field specifies a horizontal length of the cropping rectangle in the graphics plane.

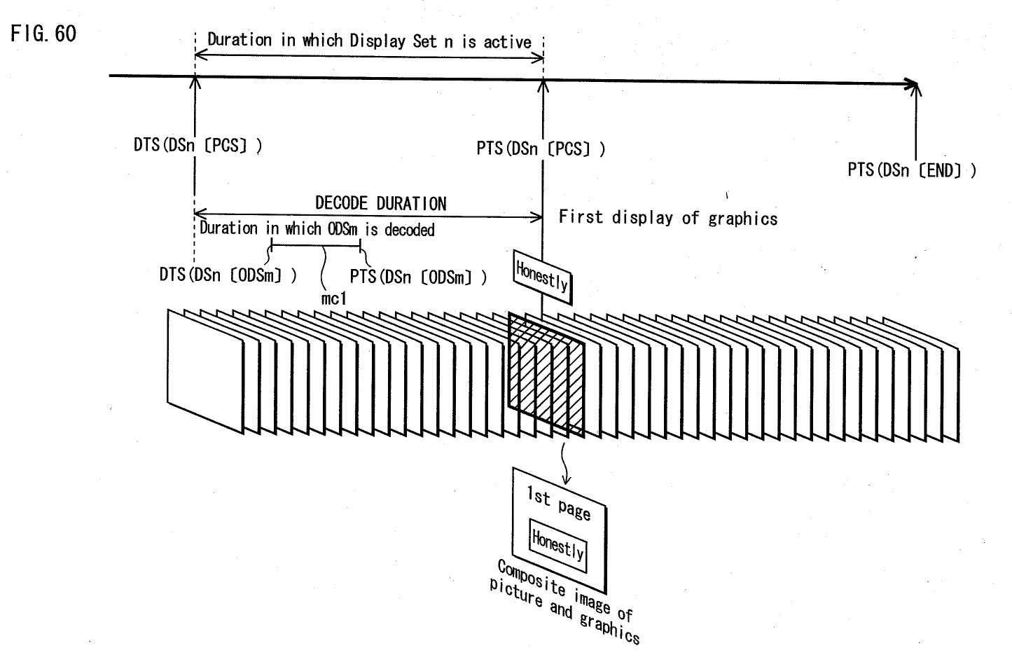

The object_cropping_height field specifies a vertical length of the cropping rectangle in the graphics plane. Here, a “DSn”, a given Display Set among those belonging to an Epoch, is assigned to an AVClip playback time axis, by setting DTS and PTS as shown in FIG. 60. FIG. 60 shows an AVClip playback time axis to which the DSn is assigned. In FIG. 60, the start of the DSn is represented by a DTS value of a PCS belonging to the DSn (DTS (DSn [PCS])), and the end of the DSn is represented by a PTS value of a PCS belonging to the DSn (PTS(DSn[PCS])). Also, the timing of the first display in the DSn is represented by the PTS value of the PCS (PTS(DSn[PCS])). Accordingly, it is possible to make the first display in the DSn synchronize with a desired picture in the video stream by making PTS(DSn[PCS]) match the timing at which the desired picture appears on the AVClip playback time axis.

The PTS (DSn [PCS]) is obtained by adding DTS (DSn [PCS]) to “DECODE DURATION” that represents a time period required for decoding the ODS.

The ODS that is necessary for the first display is decoded is the DECODE DURATION. In FIG. 60, the sign “mc1” represents a time period during which a given ODS (ODSm) belonging to DSn is decoded. The start point of the decoding time period mc1 is represented by DTS (ODSn [ODSm]), and the end point of the decoding time period mc1 is represented by PTS(ODSn[ODSm]).

An Epoch is defined when the above-described assignment to the playback time axis is performed for each ODS belonging to the Epoch. This completes the explanation about assignment to the playback time axis.

The Epoch is a unit having continuity in memory management in the graphics decoder. Accordingly, the Epoch should be complete in itself within one AVClip. However, it is possible to define an Epoch that is continuous through two AVClips that are played back in sequence, when three predetermined conditions are satisfied.

The “Epoch Continue” is a type of Display Set (DSm+1) positioned immediately after the AVClip boundary, and is handled as Acquisition Point when the three predetermined conditions described in Embodiment 6 are satisfied. It is handled as Epoch Start when any of the three conditions is not satisfied. That is to say, a Display Set of the “Epoch Continue” type is handled as Epoch Start when a jump playback from one of succeeding AVClips is performed, and is handled as Acquisition Point when a seamless playback from a previous AVClip is performed.

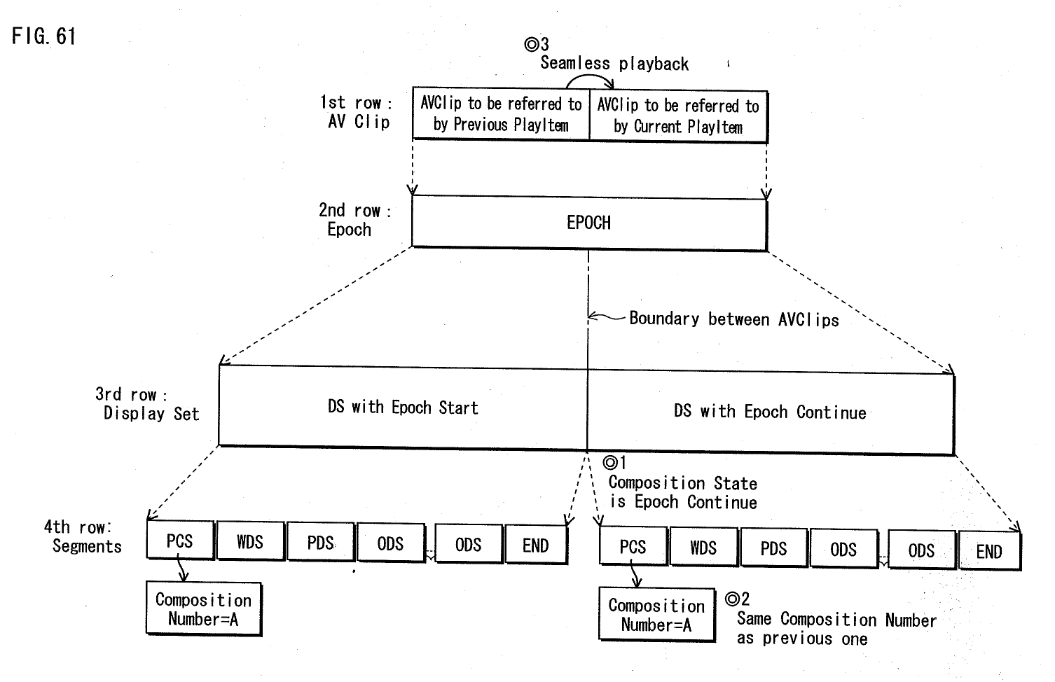

FIG. 61 shows the three conditions to be satisfied when two AVClips are played back seamlessly. The first row of the drawing indicates two AVClips that are played back seamlessly. The second row indicates three Epochs. Of the three Epochs, the Epoch in the middle has continuity in memory management between the two AVClips. The third row indicates Display Sets belonging to each of the three Epochs. The Epoch in the second row has not been divided in correspondence with the two AVClips. However, the separation between two Display Sets in the third row corresponds to the separation between the two AVClips. The fourth row indicates functional segments that are the same as those shown in the fourth row of FIG. 57. The signs ⊚1, ⊚2 and ⊚3 represent the three conditions to be satisfied in Epoch when two AVClips are played back seamlessly. The first condition is that the type of Display Set (DSm+1) positioned immediately after the AVClip boundary is “Epoch Continue”, as shown in the third row.

The second conditions is that Composition Number of PCS belonging to DSm+1 is the same as Composition Number (=A) of PCS belonging to DSm that is a Display Set immediately before DSm+1. This means that the contents of graphics display are the same before and after the AVClip boundary. Here, the Composition Number means a screen structure of a Display Set. Accordingly, when DSm and DSm+1 have the same Composition Number, the screen structures of DSm and DSm+1 provide the same graphics contents. FIG. 15 shows the screen structures of DSm and DSm+1, for comparison therebetween. As shown in the drawing, both DSm and DSm+1 has “Three years have passed” as the contents of the graphics. Accordingly, the two Display Sets have the same contents of the graphics, having the same value as Composition Number. Further, since the playback of the video stream has been set to the seamless connection, DSm+1 is handled as Acquisition Point.

The third condition is that the playback of the previous AVClip is seamlessly connected with the playback of the succeeding AVClip. The seamless connection can be achieved when the following conditions are satisfied.

(i) The same video stream display method (NTSC, PAL or the like) is indicated in the video attribute information of the two AVClips.

(ii) The same audio stream encoding method (AC-3, MPEG, LPCM or the like) is indicated in the audio attribute information of the two AVClips.

The reason why the seamless playback is not available when any of the above-indicated conditions (i) and (ii) is not satisfied is that the video decoder or the audio decoder stop operation to change the display method, encoding method, or bit rate of the video stream or audio stream when a different display method or encoding method is specified.

For example, when two audio streams respectively having been encoded by the AC-3 method and the MPEG standard are to be played back seamlessly, the audio decoder should change the stream attributes when the audio streams change from one to the other. This causes the audio decoder to stop the decoding. This also applies to the case where video stream attributes are changed.

Accordingly, the seamless connection can be performed only when both the above-indicated conditions (i) and (ii) are satisfied. The seamless connection is not available when any of the conditions (i) and (ii) is not satisfied.

DSm+1 of “Epoch Continue” type is handled as Acquisition Point when the above-described three conditions are satisfied. In this case, Display Sets 1 through m and Display Sets m+1 through n form one Epoch, and the buffer state in the graphics decoder is maintained even if the two AVClips are played back in sequence.

Even when DSm+1 is “Epoch Continue” type, if any of the remaining two conditions is not satisfied, the Epoch is divided into two in the vicinity of the AVClip boundary. Accordingly, as described above, a Display Set of “Epoch Continue” type is handled as Acquisition Point when all the above-described three conditions are satisfied; and it is handled as Epoch Start when any of the conditions is not satisfied.

According to the present embodiment with the above-described structure, it is possible to prevent the displayed subtitle from disappearing when a switch occurs between pieces of PlayItem information, by, in the second and succeeding pieces of PlayItem information in the PlayList information, setting the Composition Type to Epoch Continue and setting the Composition Number to the same value as the Composition Number of the first piece of PlayItem information in the PlayList information.

### <Supplementary Notes>

Up to now, the present invention has been described through several embodiments thereof. However, these embodiments are merely presented as system examples that are expected to produce best advantageous effects as of now. Namely, the present invention can be modified in various ways, with its essence retained. The following are representatives of such modifications.

### <Operation Wait Control Based on BD-J Application>

When the operation wait control in the moving image menu is performed based on the Movie Object, the control onto the menu is achieved by the ICSs having been described in the above. On the other hand, when the operation wait control is performed based on the BD-J application, the ICSs are not used for the control onto the menu. This is because, as described above, the BD-J application can realize a GUI framework that includes the HAVi framework. However, even in this case, AVClips are used as the background image in the moving image menu. Accordingly, even when the operation wait control is performed based on the BD-J application, it is possible to achieve an operation wait control having no interruption to the AV playback on the screen, by using the PlayList information having 999 pieces of PlayItem information.

### <Number of Pieces of PlayItem Information>

In Embodiment 1, the number of pieces of PlayItem Information is set to 999, based on the BD-ROM standard. This is because there is a limit to the number of digits to be assigned to the identification number, and because there is a demand that the PlayList information be used on-memory. However, the number of pieces of PlayItem Information can be increased or decreased depending on the case where: the moving image menu is generated in conformance to a standard that does not pose such limitations; the moving image menu is generated in conformance to a standard that allows a greater size of PlayList information; or, conversely, the moving image menu is generated in conformance to an application layer standard that strictly restricts the number of digits or the memory size.

### <Variations of Recording Medium>

In the above-described embodiments, the BD-ROM is used as the recording medium for recording AV contents or applications, or as the object of authoring. However, the physical property of the BD-ROM does not contribute much to the exhibition of the acts/effects of the present invention. Thus, any other recording medium may be used in place of BD-ROM, in so far as it has a capacity sufficient to record the AV contents, as the BD-ROM. For example, it may be an optical disc such as CD-ROM, CD-R, CD-RW, DVD-ROM, DVD-R, DVD-RW, DVD-RAM, DVD+R, or DVD+RW. Also, the recording medium for use may be: a magneto-optical disk such as PD or MO; a semiconductor memory card such as an SD memory card, CompactFlash™ card, SmartMedia, memory stick, multimedia card, or PCM-CIA card; a magnetic recording disk such as HDD, flexible disk, SuperBD-ROM, Zip, or Click!; or a removable hard disk drive such as ORB, Jaz, SparQ, SyJet, EZFley, or Microdrive. The local storage for use may be any of the above-mentioned recording mediums in so far as it can be loaded into the playback device and provides certain copyright protection.

### <Adaptation to Other Standards>

In the above-described embodiments, the BD-ROM is used as the video standard. However, any other video standard for AVClip playback at equivalent level is adaptable to the present invention.

### <Generating Moving Image Menu in Embodiment 2>

When the moving image menu is generated in Embodiment 2, the PlayList generating unit 14 generates the PlayList information where: pieces of PlayItem information at odd-numbered positions in the order in the PlayList information instruct the playback device to play back AVClip#1 so that it plays back AVClip#1 repeatedly; and pieces of PlayItem information at even-numbered positions instruct the playback device to play back AVClip#2 so that it plays back AVClip#2 repeatedly.

### <System LSI>

The internal structure of the playback device described in Embodiment 1 may be realized as one system LSI.

The system LSI is obtained by implementing a bear chip on a high-density substrate and packaging them. The system LSI is also obtained by implementing a plurality of bear chips on a high-density substrate and packaging them, so that the plurality of bear chips have an outer appearance of one LSI (such a system LSI is called a multi-chip module).

The system LSI has a QFP (Quad Flat Package) type and a PGA (Pin Grid Array) type. In the QFP-type system LSI, pins are attached to the four sides of the package. In the PGA-type system LSI, a lot of pins are attached to the entire bottom.

These pins function as an interface with other circuits. The system LSI, which is connected with other circuits through such pins as an interface, plays a role as the core of the playback device.

Such a system LSI can be embedded into various types of devices that can play back images, such as a television, game machine, personal computer, one-segment mobile phone, as well as into the playback device. The system LSI thus greatly broadens the use of the present invention.

The following describes a detailed production procedure. First, a circuit diagram of a part to be the system LSI is drawn, based on the drawings that show structures of the embodiments. And then the constituent elements of the target structure are realized using circuit elements, ICs, or LSIs.

As the constituent elements are realized, buses connecting between the circuit elements, ICs, or LSIs, peripheral circuits, interfaces with external entities and the like are defined. Further, the connection lines, power lines, ground lines, clock signals and the like are defined. For these definitions, the operation timings of the constituent elements are adjusted by taking into consideration the LSI specifications, and band widths necessary for the constituent elements are secured. With other necessary adjustments, the circuit diagram is completed.

It is desirable that the general-purpose parts in the internal structures of the embodiments are designed by combining Intellectual Properties that define existent circuit patterns. On the other hand, it is desirable that the characteristic parts in the internal structures are designed by a top-down design in which used is description at the operation level with high-level abstraction using HDL, or description at the register transfer level.

After the circuit diagram is completed, the implementation design is performed. The implementation design is a work for creating a board layout by determining how to arrange the parts (circuit elements, ICs, LSIs) of the circuit and the connection lines onto the board.

After the implementation design is performed and the board layout is created, the results of the implementation design are converted into CAM data, and the CAM data is output to equipment such as an NC (Numerical Control) machine tool. The NC machine tool performs the SoC implementation or the SiP implementation. The SoC (System on Chip) implementation is a technology for printing a plurality of circuits onto a chip. The SiP (System in Package) implementation is a technology for packaging a plurality of circuits by resin or the like. Through these processes, a system LSI of the present invention can be produced based on the internal structure of the playback device described in each embodiment above.

It should be noted here that the integrated circuit generated as described above may be called IC, LSI, ultra LSI, super LSI or the like, depending on the level of the integration.

It is also possible to achieve the system LSI by using the FPGA (Field Programmable Gate Array). In this case, a lot of logic elements are to be arranged lattice-like, and vertical and horizontal wires are connected based on the input/output combinations described in LUT (Look-Up Table), so that the hardware structure described in each embodiment can be realized. The LUT is stored in the SRAM. Since the contents of the SRAM are erased when the power is off, when the FPGA is used, it is necessary to define the Config information so as to write, onto the SRAM, the LUT for realizing the hardware structure described in each embodiment. Further, it is desirable that the image decoding circuit with a decoder embedded therein be realized by a DSP in which the product-sum operation function is embedded.

### <Architecture>

The system LSI of the present invention is aimed to achieve the functions of the playback device. For this purpose, it is desirable that the system LSI conforms to the Uniphier architecture.

A system LSI conforming to the Uniphier architecture includes the following circuit blocks.

### Data Parallel Processor (DPP)

The DPP is an SIMD-type processor where a plurality of elemental processors perform a same operation. The DPP achieves a parallel decoding of a plurality of pixels constituting a picture by causing operating units, respectively embedded in the elemental processors, to operate simultaneously by one instruction.

### Instruction Parallel Processor (IPP)

The IPP includes: a local memory controller that is composed of instruction RAM, instruction cache, data RAM, and data cache; processing unit that is composed of instruction fetch unit, decoder, execution unit, and register file; and virtual multi processing unit that causes the processing unit to execute a parallel execution of a plurality of applications.

### CPU Block

The CPU block is composed of: peripheral circuits such as ARM core, external bus interface (Bus Control Unit: BCU), DMA controller, timer, vector interrupt controller; and peripheral interfaces such as UART, GPIO (General Purpose Input Output), and sync serial interface. The aforesaid controller is implemented as this CPU block, into the system LSI.

### Stream I/O Block

The stream I/O block performs data input/output with the drive device, hard disk drive device, and SD memory card drive device which are connected onto the external busses via the USB interface and the ATA packet interface.

### AV I/O Block

The AV I/O block, which is composed of audio input/output, video input/output, and OSD controller, performs data input/output with the television and the AV amplifier.

### Memory Control Block

The memory control block performs reading and writing from/to the SD-RAM connected therewith via the external buses. The memory control block is composed of internal bus connection unit for controlling internal connection between blocks, access control unit for transferring data with the SD-RAM connected to outside of the system LSI, and access schedule unit for adjusting requests from the blocks to access the SD-RAM.

### <Production of Program of Present Invention>

The program of the present invention is an object program, a program in the execution format so as to be executed by the computer. The program of the present invention is composed of one or more program codes that cause the computer to execute each step in the flowchart or each procedure of the functional components described in the embodiments above. There are various types of program codes such as the native code of the processor, and Java™ byte code.

The program of the present invention can be produced as follows. First, the software developer writes, using a programming language, a source program that achieves each flowchart and functional component. In this writing, the software developer uses the class structure, variables, array variables, calls to external functions, and so on, which conform to the sentence structure of the programming language he/she uses.

The written source program is sent to the compiler as files. The compiler translates the source program and generates an object program.

After the object program is generated, the programmer activates a linker. The linker allocates the memory spaces to the object programs and the related library programs, and links them together to generate a load module. The generated load module is based on the presumption that it is read by the computer and causes the computer to execute the procedures indicated in the flowcharts and the procedures of the functional components. The program of the present invention can be produced in this way.

### INDUSTRIAL APPLICABILITY

The information recording medium of the present invention can prevent a playback of a moving image from stopping or a button from disappearing in the moving image menu. This enables a high-level piece of work on the BD-ROM to be supplied to the market as intended by the contents maker, and is expected to activate the movie market and the commercial equipment market. Thus there are possibilities that the recording medium and the playback device of the present invention become highly usable in the movie industry and the commercial equipment industry.

1. A recording medium for causing a playback device to display a menu while displaying a moving image as a background of the menu, the recording medium storing:
one or more AV streams constituting the moving image;
a program that causes the playback device to perform an operation wait control to wait for an operation to be conducted via the displayed menu; and
PlayList information, wherein
the PlayList information includes a PlayItem sequence composed of a plurality of pieces of PlayItem information each of which corresponds to one of the one or more AV streams and instructs the playback device to repeat a playback of the corresponding AV stream while performing the operation wait control.

2. The recording medium of claim 1, wherein
the program includes a playback command that instructs the playback device to repeat a playback of an AV stream via the PlayList information, and
the operation wait control is performed by causing the playback device to repeat a playback of the playback command.

3. The recording medium of claim 1, wherein
each piece of PlayItem information includes connection information that indicates that a playback of an AV stream by a first piece of PlayItem information and a playback of an AV stream by a second piece of PlayItem information that is immediately before the first piece of PlayItem information should be performed seamlessly.

4. The recording medium of claim 1, wherein
an amount of code to be assigned to a starting portion of the AV stream is determined not to exceed a capacity of a buffer provided in a decoder as of when an ending portion of the AV stream exists in the buffer.

5. The recording medium of claim 1, wherein
the AV stream includes a first AVClip and a second AVClip,
PlayItem information having odd numbers in an order of arrangement in the PlayItem sequence instruct the playback device to play back the first AVClip such that a playback of the first AVClip is repeated, and
PlayItem information having even numbers in an order of arrangement in the PlayItem sequence instruct the playback device to play back the second AVClip such that a playback of the second AVClip is repeated.

6. The recording medium of claim 1, wherein an amount of code based on a buffering delay is assigned to a video stream that is multiplexed in the AV stream, wherein
the buffering delay is a time period extending from (i) an input end time point at which inputting, into a buffer, of video frames and audio frames constituting an AV stream referred to by a first piece of PlayItem information is completed, to (ii) a decode end time point at which decoding of a starting video frame of an AV stream, which is referred to by a second piece of PlayItem information that is immediately after the first piece of PlayItem information, is completed.

7. A playback device for displaying a menu while displaying a moving image as a background of the menu, the playback device comprising:
a control unit operable to perform, in accordance with a program recorded on a recording medium, an operation wait control to wait for an operation to be conducted; and
a playback unit operable to play back an AV stream in accordance with PlayList information recorded on the recording medium, wherein
the PlayList information includes a PlayItem sequence composed of a plurality of pieces of PlayItem information, and
the control unit, while performing the operation wait control, continues a playback of a moving image as a background image, by repeatedly (a) reading an AV stream in correspondence with each of the plurality of pieces of PlayItem information and (b) sending the read AV stream to the playback unit.

8. The playback device of claim 7, wherein
the control unit executes one or more commands constituting the program,
the playback unit plays back the AV stream via the PlayList information in accordance with a result of an execution of a command by the control unit, and
the operation wait control is performed when the control unit repeats the execution of the one or more commands constituting the program.

9. The playback device of claim 7, wherein
the playback unit performs a playback operation in accordance with a standard clock provided in the playback device, and
when a piece of PlayItem information includes connection information that indicates a seamless connection, adds an offset to a count value of the standard clock so that continuous are (1) a count value indicated by the standard clock when an AV stream is read in correspondence with a first piece of PlayItem information and (2) a count value indicated by the standard clock when an AV stream is read in correspondence with a second piece of PlayItem information that is immediately before the first piece of PlayItem information.

10. The playback device of claim 7, wherein
the playback unit includes a decoder and a buffer that supplies data to the decoder, and
the buffer has a capacity that is sufficient to store both a starting portion and an ending portion of the AV stream at a same time.

11. The playback device of claim 7, wherein
the AV stream includes a first AVClip and a second AVClip, and
when a piece of PlayItem information having an odd number in an order of arrangement in the PlayItem sequence is selected as current PlayItem information, it indicates that the playback unit repeats a playback of the first AVClip, and
when a piece of PlayItem information having an even number in an order of arrangement in the PlayItem sequence is selected as the current PlayItem information, it indicates that the playback unit repeats a playback of the second AVClip.

12. A recording device comprising:
a receiving unit operable to receive a specification of a moving image for a background image from a user;
an encoder operable to encode a material of the specified moving image to obtain an AV stream for the specified moving image;
a first generating unit operable to generate PlayList information that includes a PlayItem sequence composed of a plurality of pieces of PlayItem information; and
a second generating unit operable to generate a program that causes a playback device to perform an operation wait control to wait for an operation to be conducted, wherein
the first generating unit obtains the PlayItem sequence by generating a plurality of pieces of PlayItem information in correspondence with the AV stream.

13. The recording device of claim 12, wherein
the program includes a playback command that instructs the playback device to perform a playback of an AV stream via the PlayList information, and
the second generating unit causes the playback device to perform the operation wait control by describing, in the program, a command for repeating an execution of the playback command.

14. The recording device of claim 12, wherein
each piece of PlayItem information includes connection information, and
the first generating unit generates the PlayItem sequence by setting the connection information to indicate that a playback of an AV stream by a first piece of PlayItem information and a playback of an AV stream by a second piece of PlayItem information that is immediately before the first piece of PlayItem information should be performed seamlessly.

15. The recording device of claim 12, wherein
the encoder obtains an input-limiting straight line in accordance with a buffer capacity as of when an ending portion of the AV stream exists in a buffer provided in a decoder, and determines an amount of code to be assigned to a starting portion of the AV stream.

16. The recording device of claim 12, wherein
the AV stream includes a first AVClip and a second AVClip, and
the first generating unit generates the PlayList information in which PlayItem information having odd numbers in an order of arrangement in the PlayItem sequence instruct the playback device to play back the first AVClip such that a playback of the first AVClip is repeated, and
PlayItem information having even numbers in an order of arrangement in the PlayItem sequence instruct the playback device to play back the second AVClip such that a playback of the second AVClip is repeated.

17. The recording device of claim 12, wherein
an amount of code based on a buffering delay is assigned to a video stream that is multiplexed in the AV stream, wherein
the buffering delay is a time period extending from (i) an input end time point at which inputting, into a buffer, of video frames and audio frames constituting an AV stream referred to by a first piece of PlayItem information is completed, to (ii) a decode end time point at which decoding of a starting video frame of an AV stream, which is referred to by a second piece of PlayItem information that is immediately after the first piece of PlayItem information, is completed.

18. A system LSI that is embedded in a playback device and causes the playback device to display a menu while displaying a moving image as a background of the menu, the system LSI comprising:
a control unit operable to perform, in accordance with a program recorded on a recording medium, an operation wait control to wait for an operation to be conducted; and
a playback unit operable to play back an AV stream in accordance with PlayList information recorded on the recording medium, wherein
the PlayList information includes a PlayItem sequence composed of a plurality of pieces of PlayItem information, and
the control unit, while performing the operation wait control, continues a playback of a moving image as a background image, by repeatedly (a) reading an AV stream in correspondence with each of the plurality of pieces of PlayItem information and (b) sending the read AV stream to the playback unit.

19. A playback method for displaying a menu while displaying a moving image as a background of the menu, the playback method comprising the steps of:
performing, in accordance with a program recorded on a recording medium, an operation wait control to wait for an operation to be conducted; and
playing back an AV stream in accordance with PlayList information recorded on the recording medium, wherein
the PlayList information includes a PlayItem sequence composed of a plurality of pieces of PlayItem information, and
the control step, while performing the operation wait control, continues a playback of a moving image as a background image, by repeatedly (a) reading an AV stream in correspondence with each of the plurality of pieces of PlayItem information and (b) sending the read AV stream to the playback step.

20. A program for causing a computer to display a menu while displaying a moving image as a background of the menu, the program causing the computer to perform the steps of:
performing, in accordance with a program recorded on a recording medium, an operation wait control to wait for an operation to be conducted; and
playing back an AV stream in accordance with PlayList information recorded on the recording medium, wherein
the PlayList information includes a PlayItem sequence composed of a plurality of pieces of PlayItem information, and
the control step causes the computer to continue, while performing the operation wait control, a playback of a moving image as a background image, by repeatedly (a) reading an AV stream in correspondence with each of the plurality of pieces of PlayItem information and (b) sending the read AV stream to the playback step.
